(19) United States
(12) Patent Application Publication
(10) Pub. No.: US 2002/0141586 A1
(43) Pub. Date: Oct. 3, 2002

(54) Authentication employing the bluetooth communication protocol

(75) Inventors: Yanki Margalit, Ramat Gan (IL); Dany Margalit, Ramat Gan (IL); Michael Zunke, Tel Aviv (IL)

Correspondence Address: Ladas & Parry, 26 West 61 Street, New York, NY, 10023, US

(73) Assignee: ALADDIN KNOWLEDGE SYSTEMS LTD.

(21) Appl. No.: 09/821,716

(22) Filed: Mar. 29, 2001

(51) Int. Cl. H04L 9/00

(52) U.S. Cl. 380/270

(57) ABSTRACT

A device and method capable of communicating with a communication network via a Bluetooth communication protocol, wherein the device includes at least one authentication functionality, at least part of at least one of which is operative to communicate authentication information via the Bluetooth communication protocol.

### FIELD OF THE INVENTION

The present invention relates to authentication in computer systems generally.

### BACKGROUND OF THE INVENTION

The following publications are believed to represent the state of the art relevant to the present invention:

“Bluetooth Security Architecture, Version 1.0” by Thomas Muller, Jul. 15, 1999;

“Bluetooth specifications core, Version 1.0b”, Dec. 1, 1999;

“Bluetooth specifications profile, Version 1.0b”, Dec. 1, 1999;

“First Access and Bluetooth Announce Technological Collaboration”, Feb. 21, 2000;

“CeBit bluetooth™ pavilion to showcase Ensure's patented XyLoc wireless pc security”, Feb. 24, 2000;

U.S. Pat. No. 6,070,240.

### SUMMARY OF THE INVENTION

There is thus provided in accordance with a preferred embodiment of the present invention a device capable of communicating with an authenticator at least partially using a Bluetooth communication protocol. The device includes at least one authentication functionality, at least part of at least one of which operates to communicate authentication information via the Bluetooth communication protocol.

There is provided in accordance with another preferred embodiment of the present invention a device capable of communicating with an authenticator. The device includes at least one authentication functionality at least part of at least one of which forms part of the Bluetooth communication protocol.

There is provided in accordance with a preferred embodiment of the present invention a device capable of communicating with an authenticator at least partially using a Bluetooth communication protocol. The device includes at least one authentication functionality at least part of at least one of which employs a Bluetooth communication protocol.

There is also provided in accordance with a preferred embodiment of the present invention a system including a communication network, at least one authenticator and at least one device capable of communicating with the authenticator through the communication network, via a Bluetooth communication protocol. The device includes at least one authentication functionality, at least part of at least one of which is operative to communicate authentication information via the Bluetooth communication protocol to the at least one authenticator.

There is also provided in accordance with yet another preferred embodiment of the present invention a system including a communication network, at least one authenticator and at least one device capable of communicating communicating with the authenticator through the communication network. The device includes at least one authentication functionality, at least part of at least one of which forms part of the Bluetooth communication protocol.

There is also provided in accordance with a preferred embodiment of the present invention a system including a communication network, at least one authenticator and at least one device capable of communicating with the authenticator through the communication network, via a Bluetooth communication protocol. The device includes at least one authentication functionality at least part of at least one of which employs a Bluetooth communication protocol.

There is provided in accordance with another preferred embodiment of the present invention a system including at least one authenticator and at least one device capable of communicating with the authenticator via a Bluetooth communication protocol. The device includes at least one authentication functionality, at least part of at least one of which is operative to communicate authentication information via the Bluetooth communication protocol to the authenticator.

There is further provided in accordance with yet another preferred embodiment of the present invention a system including at least one authenticator and at least one device capable of communicating with the authenticator. The device includes at least one authentication functionality, at least part of at least one of which forms part of the Bluetooth communication protocol.

There is further provided in accordance with another preferred embodiment of the present invention a system including at least one authenticator and at least one device capable of communicating with the authenticator via a Bluetooth communication protocol. The device includes at least one authentication functionality at least part of at least one of which employs a Bluetooth communication protocol.

There is provided in accordance with a preferred embodiment of the present invention a system including at least one device and at least one second device. Said system includes at least one multi-tier authentication functionality, at least part of at least one of which operates to communicate authentication information via the Bluetooth communication protocol to at least one authenticator.

There is provided in accordance with a preferred embodiment of the present invention a system including at least one device and at least one second device. Said system includes at least one multi-tier authentication functionality, at least part of at least one of which forms part of the Bluetooth communication protocol.

There is provided in accordance with a preferred embodiment of the present invention a system including at least one device and at least one second device. Said system includes at least one multi-tier authentication functionality at least part of at least one of which employs a Bluetooth communication protocol.

There is further provided in accordance with yet another preferred embodiment of the present invention a method for authenticating with an authenticator. The method includes at least one authentication functionality, at least part of at least one of which is operative to communicate authentication information via the Bluetooth communication protocol.

There is further provided in accordance with yet another preferred embodiment of the present invention a method for authenticating with an authenticator. The method includes at least one authentication functionality, at least part of at least one of which forms part of the Bluetooth communication protocol.

There is further provided in accordance with yet another preferred embodiment of the present invention a method for authenticating with an authenticator. The method includes at least one authentication functionality at least part of at least one of which employs a Bluetooth communication protocol.

Further in accordance with a preferred embodiment of the present invention the device is effective in identifying at least one of the device, another device, a user of the device and the user of the other device, to at least one authenticator coupled to the communication network.

Additionally in accordance with a preferred embodiment of the present invention the device is a dedicated authentication device.

Further in accordance with a preferred embodiment of the present invention the device includes substantial non-authentication functionality.

Preferably, the device includes a telephone, a PDA, a computer, an electronic wallet and a wireless smart card.

Further in accordance with a preferred embodiment of the present invention the authentication functionality is selected from the following authentication functionalities: a cryptographic authentication functionality, a password based authentication functionality, a smartcard based authentication functionality, a token based authentication functionality and a biometric based authentication functionality.

Additionaly in accordance with a preferred embodiment of the present invention the authentication functionality forms part of the Bluetooth communication protocol.

Additionaly in accordance with a preferred embodiment of the present invention the authentication functionality includes at least a plurality of the following authentication functionalities: a cryptographic authentication functionality, a password based authentication functionality, a smartcard based authentication functionality, a token based authentication functionality and a biometric based authentication functionality.

Additionaly in accordance with a preferred embodiment of the present invention, the authentication functionality includes plural authentication functionalities.

Preferably, the device includes substantial non-authentication functionality wherein the authentication functionality includes plural authentication functionalities.

Preferably, the device is a dedicated authentication device and the authentication functionality includes plural authentication functionalities.

### BRIEF DESCRIPTION OF THE DRAWINGS

The present invention will be understood and appreciated more fully from the following detailed description, taken in conjunction with the drawings in which:

FIG. 1 is a simplified pictorial illustration of a system and methodology for authentication and communication with a communication network employing a Bluetooth communication protocol in accordance with a preferred embodiment of the present invention;

FIG. 2 is a simplified pictorial illustration of a system and methodology for authentication communication with computer employing a Bluetooth communication protocol in accordance with another preferred embodiment of the present invention;

FIG. 3 is a simplified pictorial illustration of a system and methodology for multi-tier authentication and communication with a communication network employing a Bluetooth communication protocol in accordance with a preferred embodiment of the present invention;

FIG. 4 is a simplified pictorial illustration of a system and methodology for authentication and communication, using a Bluetooth communication protocol, with a communication network in accordance with yet another preferred embodiment of the present invention;

FIG. 5 is a simplified pictorial illustration of a system and methodology for authentication and communication, using a Bluetooth communication protocol, with a computer in accordance with yet another preferred embodiment of the present invention;

FIG. 6 is a simplified pictorial illustration of a system and methodology for multi-tier authentication and communication, using a Bluetooth communication protocol, with a communication network in accordance with yet another preferred embodiment of the present invention;

FIG. 7 is a simplified pictorial illustration of a system and methodology for authentication, using a Bluetooth communication protocol, and communication with a communication network in accordance with yet another preferred embodiment of the present invention;

FIG. 8 is a simplified pictorial illustration of a system and methodology for authentication, using a Bluetooth communication protocol, and communication with a computer in accordance with yet another preferred embodiment of the present invention;

FIG. 9 is a simplified pictorial illustration of a system and methodology for multi-tier authentication, using a Bluetooth communication protocol, and communication with a communication network in accordance with yet another preferred embodiment of the present invention;

FIGS. 10A, 10B, 10C, 10D and 10E are simplified pictorial illustrations of single authentication functionalities appropriate for five different types of authentication devices;

FIGS. 11A, 11B, 11C, 11D, 11E and 11F are simplified pictorial illustrations of combinations of authentication functionalities appropriate for six different combinations of different types of authentication devices;

FIGS. 12A, 12B and 12C are simplified pictorial illustrations of combinations of authentication functionalities appropriate for three different multi-tier combinations of different types of authentication devices;

FIGS. 13A, 13B, 13C, 13D and 13E are simplified flow charts of single authentication functionalities appropriate for five different types of authentication devices and correspond to FIGS. 10A-10E;

FIGS. 14A, 14B, 14C, 14D, 14E and 14F are simplified flow charts of combinations of authentication functionalities appropriate for six different combinations of different types of authentication devices and correspond to FIGS. 11A-11F;

FIGS. 15A, 15B, 15C, 15D and 15E are simplified flow charts of methods for obtaining authentication information for five different types of authentication devices;

FIGS. 16A, 16B and 16C are simplified flow charts of various multi-tier and non multi-tier authentication methods using different communication modes between an authenticating device and an authenticator; and

FIGS. 17A, 17B and 17C are simplified flow charts of various multi-tier and non multi-tier authentication methods employing different combinations of authentication devices.

### DETAILED DESCRIPTION OF PREFERRED EMBODIMENTS

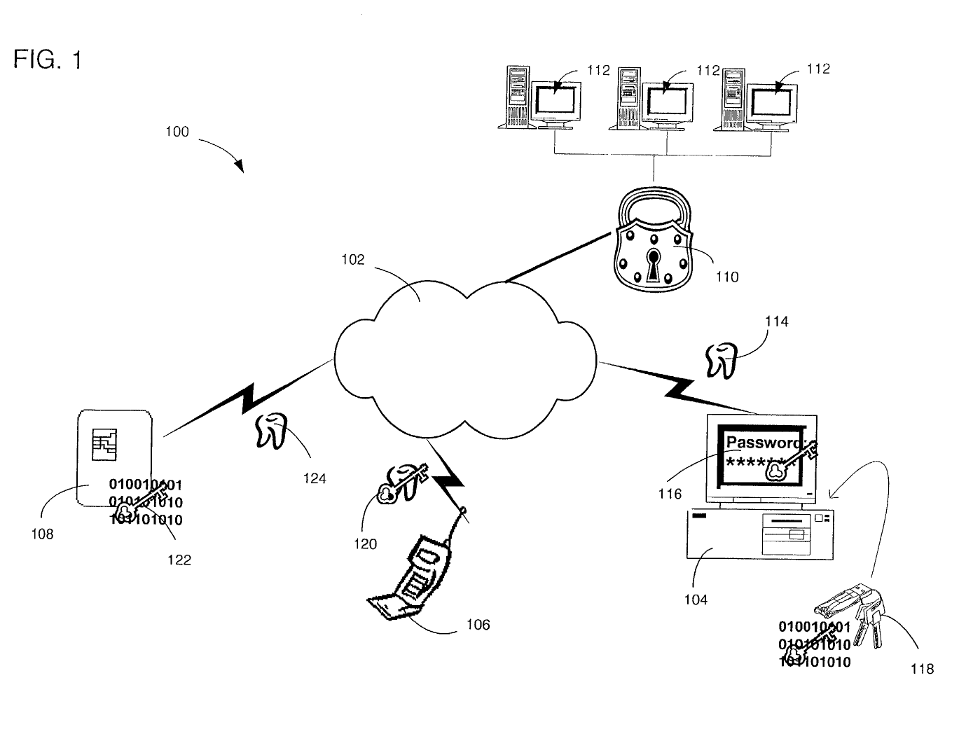

Reference is now made to FIG. 1, which is a simplified pictorial illustration of a system and methodology for communication with a communication network employing a Bluetooth communication protocol in accordance with a preferred embodiment of the present invention. As seen in FIG. 1, there is provided an authentication system 100 communicating with a communication network, such as the Internet, herein designated by reference numeral 102 or with an intranet.

For the purposes of the present application “authentication” is to be understood broadly as referring to any process or functionality for providing authorization, access control, permission or approval. The phase “authentication information” is to be understood as any information which is employed for the purpose of authentication.

In accordance with a preferred embodiment of the present invention, the authentication system is effective to identify at least one of at least one device, such as a PC 104, a telephone 106 and a wireless smart card 108, and at least one user thereof to at least one authenticator, represented by a lock symbol and designated by reference numeral 110, coupled to the communication network 102 and arranged to provide an indication of such authentication to other computers, such as those designated by reference numeral 112, such as web servers, database servers and application servers.

In accordance with one embodiment of the present invention, at least one device, such as PC 104, communicates with the communication network 102 using a Bluetooth communication protocol, symbolized by a tooth and specifically designated by reference numeral 114. PC 104 typically includes multiple authentication functionalities, symbolized by multiple keys. As seen in FIG. 1, one of the authentication functionalities is a password authentication functionality, designated by reference numeral 116. Additionally or alternatively a cryptographic authentication functionality may also be provided, such as by means of a USB token 118 which may be associated with the PC 104.

Additionally in accordance with an embodiment of the present invention, telephone 106 communicates with the communication network 102 in any suitable manner and may or may not employ a Bluetooth communication protocol for communication. In this example, authentication may employ functionality, at least part of which forms part of the Bluetooth communication protocol, as symbolized by a tooth overlaid with a key, collectively designated by reference numeral 120.

In a further example, a dedicated authentication device, such as the wireless smart card 108 providing access control, communicates with the communication network 102 for authenticating a user thereof and includes cryptographic authentication functionality, symbolized by a key and here specifically designated by reference numeral 122, which communicates with authenticator 110 using a Bluetooth communication protocol, symbolized by a tooth and specifically designated by reference numeral 124.

It is appreciated that authentication may be provided in the embodiment of FIG. 1 by any one or more of the authentication functionalities described hereinabove. Thus authentication may require both Bluetooth authentication functionality and password authentication functionality, provided by telephone 106 and computer 104 respectively.

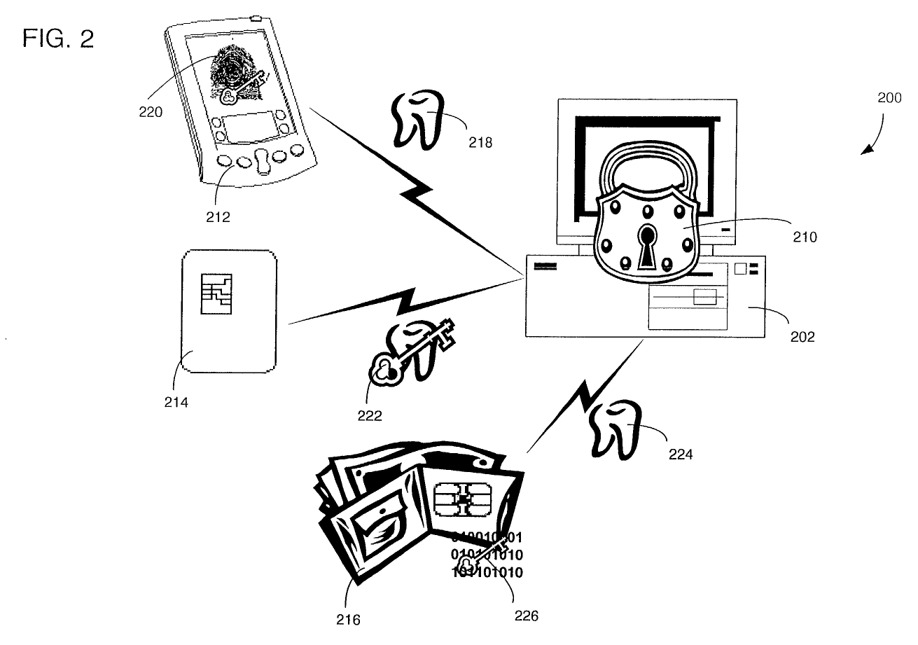

Reference is now made to FIG. 2, which is a simplified pictorial illustration of a system and methodology for authentication employing a Bluetooth communication protocol in accordance with a preferred embodiment of the present invention. As seen in FIG. 2, there is provided an authentication system 200 wherein one or more authentication devices communicate with a computer 202, which itself includes an authenticator 210.

In accordance with a preferred embodiment of the present invention, the authentication system 200 is effective to identify at least one of at least one authentication device and at least one user thereof to at least one authenticator.

The authentication devices typically include a personal digital assistant 212, a smart card 214 and an electronic wallet 216. Personal digital assistant 212 communicates with the computer 202 using a Bluetooth communication protocol, symbolized by a tooth and specifically designated by reference numeral 218 and typically employs a biometric authentication functionality, such as a touch screen fingerprint sensor based authentication functionality, indicated by reference numeral 220.

Smart card 214 may be a wireless smart card which may employ an authentication functionality at least part of which may form part of the Bluetooth communication protocol, as symbolized by a tooth overlaid with a key, collectively designated by reference numeral 222.

Electronic wallet 216 communicates with the computer 202 using a Bluetooth communication protocol, symbolized by a tooth and specifically designated by reference numeral 224. Electronic wallet 216 may employ cryptographic authentication functionality, symbolized by a key and here specifically designated by reference numeral 226.

It is appreciated that authentication may be provided in the embodiment of FIG. 2 by any one or more of the authentication devices described hereinabove. Thus a user may be required to provide both biometric inputs and cryptographic inputs, as by using the personal digital assistant 212 and the electronic wallet 216 respectively.

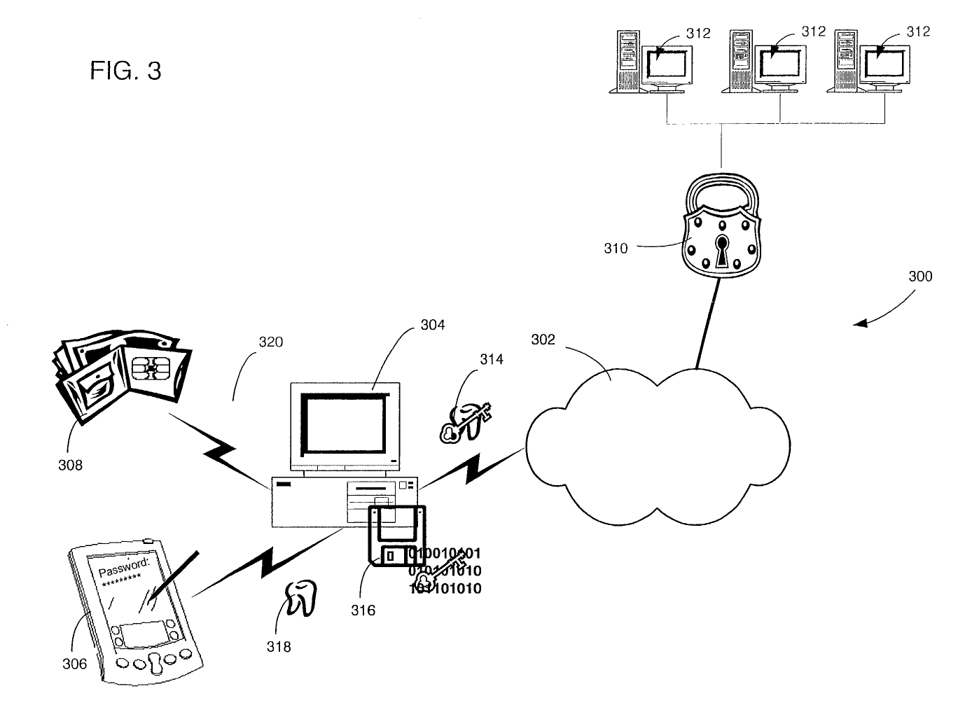

Reference is now made to FIG. 3, which is a simplified pictorial illustration of a system and methodology for multi-tier authentication and communication with a communication network employing a Bluetooth communication protocol in accordance with a preferred embodiment of the present invention.

As seen in FIG. 3, there is provided an authentication system 300 communicating with a communication network, such as the Internet, herein designated by reference numeral 302 or with an intranet. System 300 is effective to identify at least one of at least one device, such as a suitably equipped PC 304, a personal digital assistant 306 and an electronic wallet 308, and at least one user thereof to at least one authenticator, represented by a lock symbol and designated by reference numeral 310, coupled to the communication network 302 and arranged to provide an indication of such authentication to other computers, such as those designated by reference numeral 312, such as web servers, database servers and application servers.

In accordance with a preferred embodiment of the present invention, the authentication system provides multi-tier authentication in that one or more devices, such as personal digital assistant 306, electronic wallet 308 and PC 304, which communicate via Bluetooth, are employed in order to authenticate one or more devices or a user thereof to authenticator 310.

In accordance with one embodiment of the present invention, at least one device, such as PC 304, communicates with the communication network 302 using a Bluetooth communication protocol, symbolized by a tooth and specifically designated by reference numeral 314. The at least one device, such as PC 304 may authenticate itself and/or another device or a user to authenticator 310 by means of an authentication functionality at least part of which forms part of the Bluetooth communication protocol.

Additionally or alternatively, the at least one device, such as PC 304 may authenticate itself and/or another device or a user to authenticator 310 by means of a cryptographic authentication functionality, provided such as by means of a key diskette 316, which may be associated with the at least one device.

The personal digital assistant 306 may communicate with the PC 304 using a Bluetooth communication protocol, symbolized by a tooth and specifically designated by reference numeral 318. The personal digital assistant 306 may authenticate itself and/or another device or a user to authenticator 310 by means of a password authentication functionality.

The electronic wallet 308 may employ an authentication functionality at least part of which may form part of the Bluetooth communication protocol, as symbolized by a tooth overlaid with a key, collectively designated by reference numeral 320 and may or may not employ a Bluetooth communication protocol for communication.

The multiple-tier authentication functionality of FIG. 3 may operate in one or more of typically four modes:

The PC 304 may be used merely to communicate to network 302 authentication information sent by personal digital assistant 306.

The PC 304 may be used as an authentication proxy when suitably enabled by receipt of authentication information from the personal digital assistant 306.

The PC 304 may be used as an authentication proxy when suitably enabled by receipt of Bluetooth authentication from the electronic wallet 308.

The personal digital assistant 306 may be used to enable the PC 304 to authenticate itself or a user thereof to the authenticator 310.

The electronic wallet 308 may be used to enable the PC 304 to authenticate itself or a user thereof to the authenticator 310.

It is appreciated that authentication may be provided in the embodiment of FIG. 3 by any one or more of the authentication devices described hereinabove. Thus a user may be required to provide both password inputs and cryptographic inputs, as by using the personal digital assistant 306 and the key diskette 316 respectively.

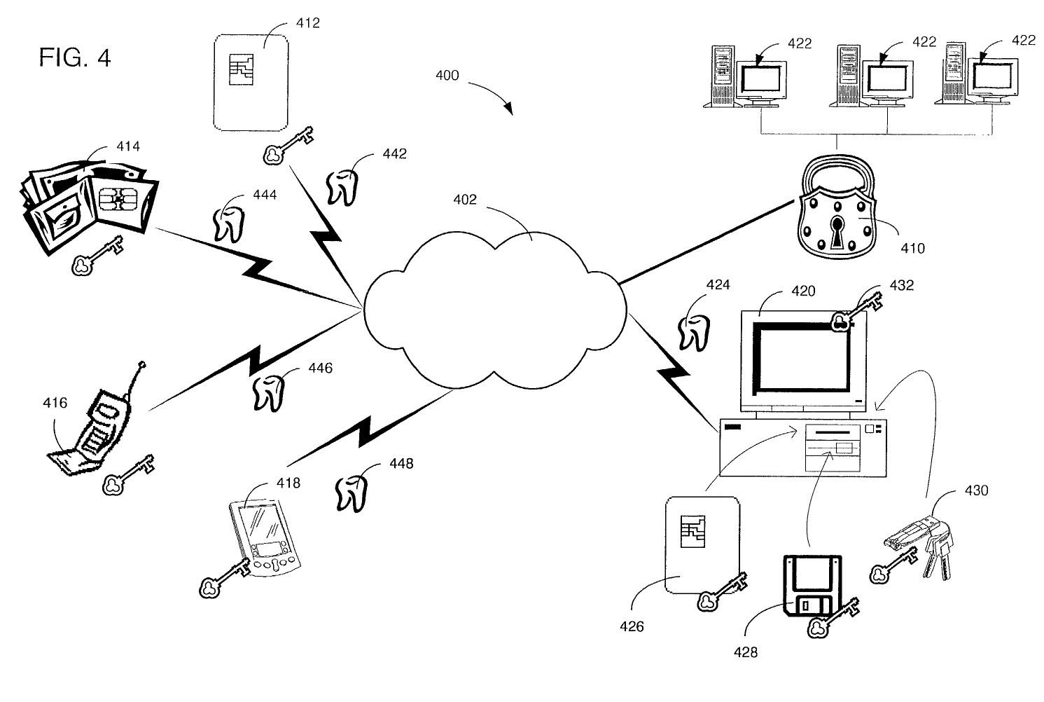

Reference is now made to FIG. 4, which is a simplified pictorial illustration of a system and methodology for communication, using a Bluetooth communication protocol, and authentication with a communication network in accordance with yet another preferred embodiment of the present invention. As seen in FIG. 4, there is provided an authentication system 400 communicating with a communication network, such as the Internet, herein designated by reference numeral 402 or with an intranet.

Five different types of devices are shown here in Bluetooth communication via computer network 402 with an authenticator 410: a wireless smart card 412, an electronic wallet 414, a telephone 416, a personal digital assistant 418 and a PC 420. It is appreciated that any suitable device may alternatively or additionally communicate via computer network 402 with authenticator 410.

In accordance with a preferred embodiment of the present invention, the authentication system is effective to identify at least one device or a user thereof to at least one authenticator 410, represented by a lock symbol, coupled to the communication network 402 and arranged to provide an indication of such authentication to other computers, such as those designated by reference numeral 422, such as web servers, database servers and application servers.

In accordance with one embodiment of the present invention, at least one device, such as PC 420, communicates with the communication network 402 using a Bluetooth communication protocol, symbolized by a tooth and specifically designated by reference numeral 424. PC 420 typically includes multiple authentication functionalities, symbolized by multiple keys associated respectively with a smart card 426, a key diskette 428 and a USB token 430. As symbolized by key 432, the PC 420 may also provide additional authentication functionalities.

Additional devices, such as wireless smart card 412, electronic wallet 414, telephone 416 and personal digital assistant 418 each also communicate with the communication network 402 using a Bluetooth communication protocol, as symbolized respectively by a tooth and designated by respective reference numerals 442, 444, 446 and 448. Each such additional device may include a single authentication functionality or multiple authentication functionalities.

It is appreciated that authentication may be provided in the embodiment of FIG. 4 by any one or more of the authentication devices and/or functionalities described hereinabove.

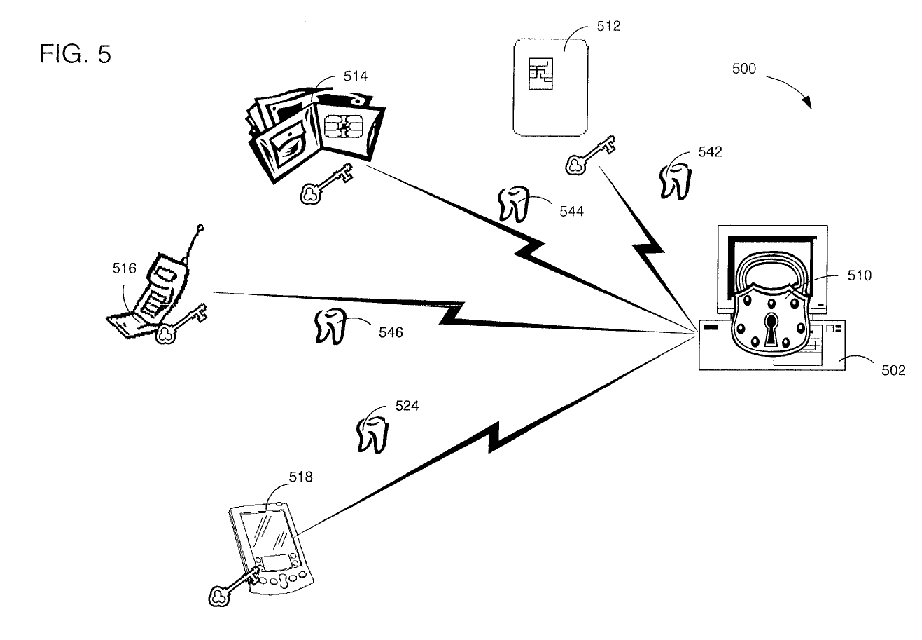

Reference is now made to FIG. 5, which is a simplified pictorial illustration of a system and methodology for communication, using a Bluetooth communication protocol, and authentication in accordance with yet another preferred embodiment of the present invention. As seen in FIG. 5, there is provided an authentication system 500 wherein one or more authentication devices communicate with a computer 502, which itself includes an authenticator 510.

Four different types of devices are shown here in Bluetooth communication with computer 502 which itself includes authenticator 510: a wireless smart card 512, an electronic wallet 514, a telephone 516 and a personal digital assistant 518. It is appreciated that any suitable device may alternatively or additionally communicate with computer 502, which itself includes an authenticator 510.

In accordance with a preferred embodiment of the present invention, the authentication system is effective to identify at least one device or a user thereof to at least one authenticator 510, represented by a lock symbol.

In accordance with one embodiment of the present invention, at least one device, such as personal digital assistant 518 communicates with the computer 502, which itself includes an authenticator 510, using a Bluetooth communication protocol, symbolized by a tooth and specifically designated by reference numeral 524. Personal digital assistant 518 may include a single authentication functionality or multiple authentication functionalities.

Additional devices, such as wireless smart card 512, electronic wallet 514 and telephone 516 each also communicate with the computer 502 using a Bluetooth communication protocol, as symbolized respectively by a tooth and designated by respective reference numerals 542, 544 and 546. Each such additional device may include a single authentication functionality or multiple authentication functionalities.

It is appreciated that authentication may be provided in the embodiment of FIG. 5 by any one or more of the authentication devices and/or functionalities described hereinabove.

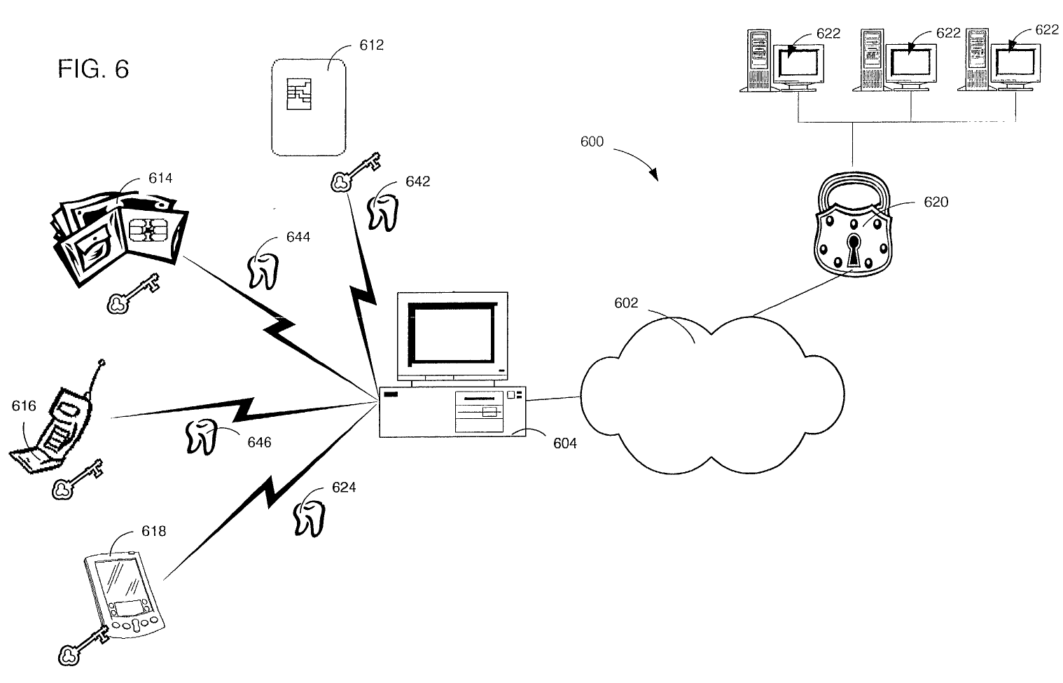

Reference is now made to FIG. 6, which is a simplified pictorial illustration of a system and methodology for communication, using a Bluetooth communication protocol, and authentication with a communication network in accordance with yet another preferred embodiment of the present invention. As seen in FIG. 6, there is provided an authentication system 600 communicating with a communication network, such as the Internet, herein designated by reference numeral 602 or with an intranet.

Four different types of authentication devices are shown here in Bluetooth communication with a computer 604: a wireless smart card 612, an electronic wallet 614, a telephone 616 and a personal digital assistant 618. It is appreciated that any suitable device may alternatively or additionally communicate with computer 604, which in turn communicates via network 602 with at least one authenticator 620, represented by a lock symbol, coupled to the communication network 602 and arranged to provide an indication of such authentication to other computers, such as those designated by reference numeral 622, such as web servers, database servers and application servers.

In accordance with a preferred embodiment of the present invention, the authentication system 600 is effective to identify at least one device or a user thereof to at least one authenticator 620.

In accordance with a preferred embodiment of the present invention, the authentication system provides multi-tier authentication.

In accordance with one embodiment of the present invention, at least one authentication device, such as personal digital assistant 618 communicates with the computer 604, using a Bluetooth communication protocol, symbolized by a tooth and specifically designated by reference numeral 624. Computer 604 in turn communicates with authenticator 620 via communication network 602. Personal digital assistant 618 may include a single authentication functionality or multiple authentication functionalities.

Additional authentication devices, such as wireless smart card 612, electronic wallet 614 and telephone 616 each also communicate with the computer 604 using a Bluetooth communication protocol, as symbolized respectively by a tooth and designated by respective reference numerals 642, 644 and 646. Each such additional device may include a single authentication functionality or multiple authentication functionalities.

The multiple-tier authentication functionality of FIG. 6 may operate in one or more of typically three modes:

The computer 604 may be used merely to communicate to network 602 authentication information sent by any of the above-described authentication devices.

The computer 604 may be used as an authentication proxy when suitably enabled by receipt of authentication information from the any of the above-described authentication devices.

Any of the above-described authentication devices may be used to enable the computer 604 to authenticate itself or a user thereof to the authenticator 620.

It is appreciated that authentication may be provided in the embodiment of FIG. 6 by any one or more of the authentication devices and/or functionalities described hereinabove.

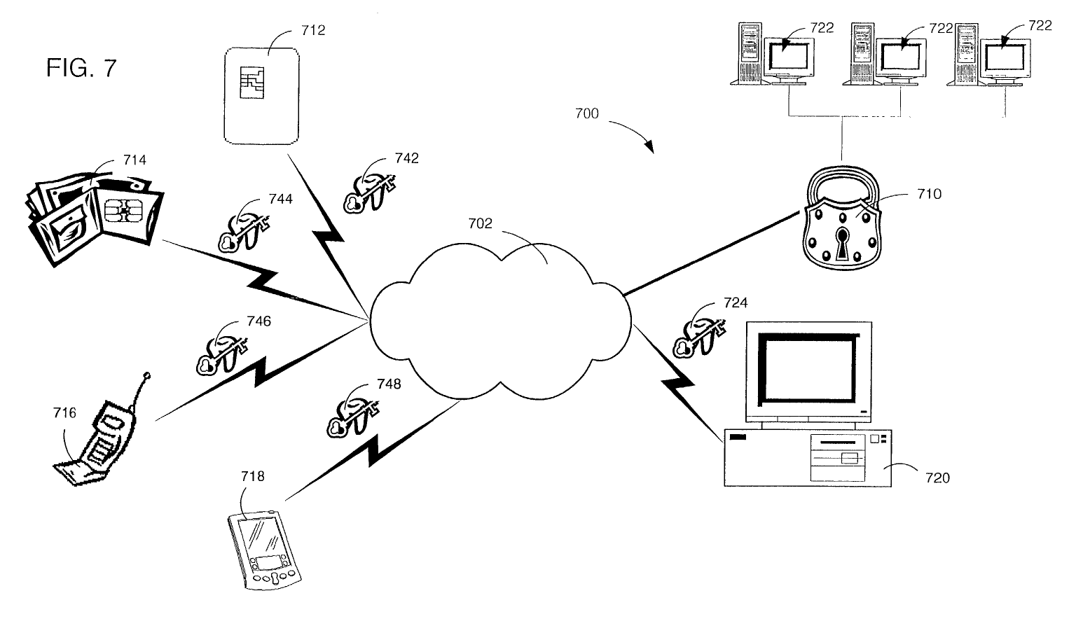

Reference is now made to FIG. 7, which is a simplified pictorial illustration of a system and methodology for authentication, using a Bluetooth communication protocol, and communication with a communication network in accordance with yet another preferred embodiment of the present invention. As seen in FIG. 7, there is provided an authentication system 700 communicating with a communication network, such as the Internet, herein designated by reference numeral 702 or with an intranet.

Five different types of devices are shown here in communication via computer network 702 with an authenticator 710: a wireless smart card 712, an electronic wallet 714, a telephone 716, a personal digital assistant 718 and a PC 720. It is appreciated that any suitable device may alternatively or additionally communicate via computer network 702 with authenticator 710.

In accordance with a preferred embodiment of the present invention, the authentication system is effective to identify at least one device or a user thereof to at least one authenticator 710, represented by a lock symbol, coupled to the communication network 702 and arranged to provide an indication of such authentication to other computers, such as those designated by reference numeral 722, such as web servers, database servers and application servers.

In accordance with one embodiment of the present invention, at least one device, such as PC 720, communicates with the communication network 702. PC 720 may include one or more authentication functionalities, at least part of at least one of them forming part of a Bluetooth communication protocol, as symbolized by a tooth overlaid by a key and designated by reference numeral 724.

Additional devices, such as wireless smart card 712, electronic wallet 714, telephone 716 and personal digital assistant 718 each also provide authentication via the communication network 702 using an authentication functionality, at least part of which forms part of a Bluetooth communication protocol, as symbolized respectively by a tooth overlaid by a key and designated by respective reference numerals 742, 744, 746 and 748.

It is appreciated that authentication may be provided in the embodiment of FIG. 7 by any one or more of the authentication devices and/or functionalities described hereinabove.

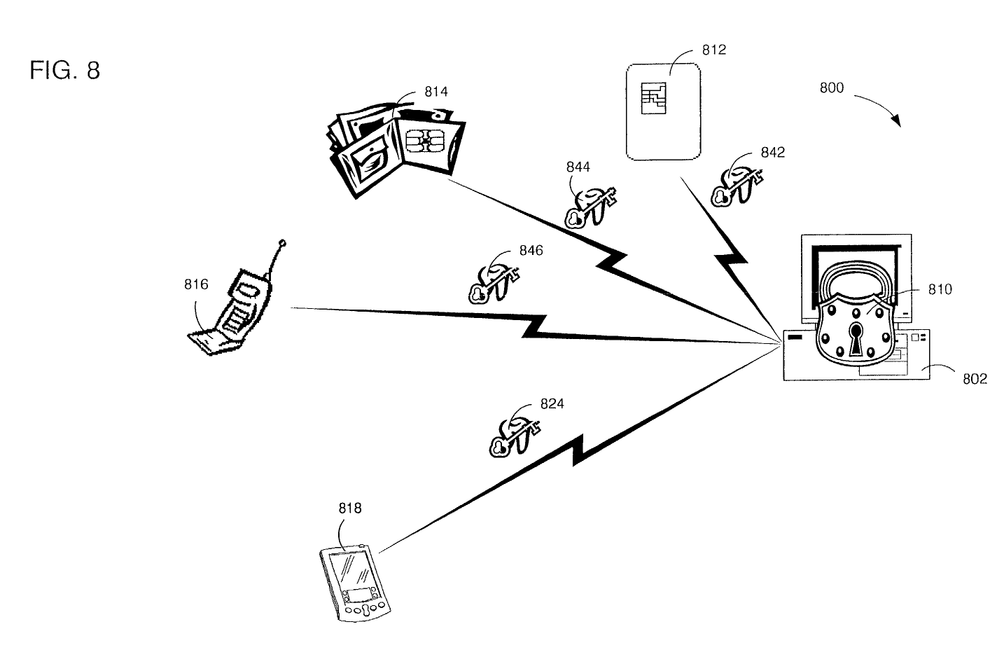

Reference is now made to FIG. 8, which is a simplified pictorial illustration of a system and methodology for authenticating using an authentication functionality, at least part of which forms at least part of a Bluetooth communication protocol in accordance with yet another preferred embodiment of the present invention. As seen in FIG. 8, there is provided an authentication system 800 wherein one or more authentication devices communicate with a computer 802, which itself includes an authenticator 810.

Four different types of devices are shown here in communication with computer 802 which itself includes authenticator 810: a wireless smart card 812, an electronic wallet 814, a telephone 816 and a personal digital assistant 818. It is appreciated that any suitable device may alternatively or additionally communicate with computer 802, which itself includes an authenticator 810.

In accordance with a preferred embodiment of the present invention, the authentication system is effective to identify at least one device or a user thereof to at least one authenticator 810, represented by a lock symbol.

In accordance with one embodiment of the present invention, at least one device, such as personal digital assistant 818 communicates with the computer 802, which itself includes an authenticator 810, and authenticates to the authenticator 810 employing an authentication functionality, at least part of which forms part of a Bluetooth communication protocol, symbolized by a tooth overlaid by a key and specifically designated by reference numeral 824.

Additional devices, such as wireless smart card 812, electronic wallet 814 and telephone 816 each may communicate with the computer 802 and may authenticate using an authentication functionality at least part of which forms part of a Bluetooth communication protocol, as symbolized respectively by a tooth overlaid with a key and designated by respective reference numerals 842, 844 and 846.

It is appreciated that authentication may be provided in the embodiment of FIG. 8 by any one or more of the authentication devices and/or functionalities described hereinabove.

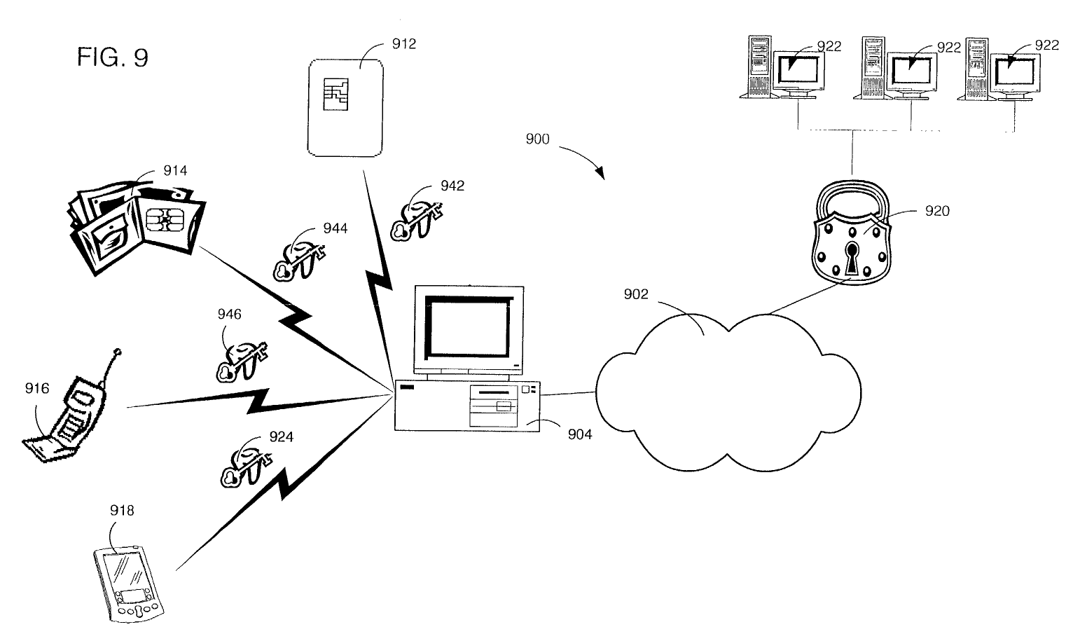

Reference is now made to FIG. 9, which is a simplified pictorial illustration of a system and methodology for authentication, using an authentication functionality, at least part of which forms at least part of a Bluetooth communication protocol, via a communication network in accordance with yet another preferred embodiment of the present invention. As seen in FIG. 9, there is provided an authentication system 900 communicating with a communication network, such as the Internet, herein designated by reference numeral 902 or with an intranet.

Four different types of authentication devices are shown here in communication with a computer 904: a wireless smart card 912, an electronic wallet 914, a telephone 916 and a personal digital assistant 918. It is appreciated that any suitable device may alternatively or additionally communicate with computer 904, which in turn communicates via network 902 with at least one authenticator 920, represented by a lock symbol, coupled to the communication network 902 and arranged to provide an indication of such authentication to other computers, such as those designated by reference numeral 922, such as web servers, database servers and application servers.

In accordance with a preferred embodiment of the present invention, the authentication system 900 is effective to identify at least one device or a user thereof to at least one authenticator 920.

In accordance with a preferred embodiment of the present invention, the authentication system provides multi-tier authentication.

In accordance with one embodiment of the present invention, at least one authentication device, such as personal digital assistant 918, communicates with the computer 904 and provides authentication using an authentication functionality, at least part of which forms at least part of a Bluetooth communication protocol, symbolized by a tooth overlaid with a key and specifically designated by reference numeral 924. Computer 904 in turn communicates with authenticator 920 via communication network 902.

Additional authentication devices, such as wireless smart card 912, electronic wallet 914 and telephone 916 each may provide authentication using an authentication functionality, at least part of which forms at least part of a Bluetooth communication protocol, as symbolized respectively by a tooth overlaid by a key and designated by respective reference numerals 942, 944 and 946.

The multiple-tier authentication functionality of FIG. 9 may operate in one or more of typically three modes:

The computer 904 may be used merely to communicate to network 902 authentication information sent by any of the above-described authentication devices.

The computer 904 may be used as an authentication proxy when suitably enabled by receipt of authentication information from the any of the above-described authentication devices.

Any of the above-described authentication devices may be used to enable the computer 904 to authenticate itself or a user thereof to the authenticator 920.

It is appreciated that authentication may be provided in the embodiment of FIG. 9 by any one or more of the authentication devices and/or functionalities described hereinabove.

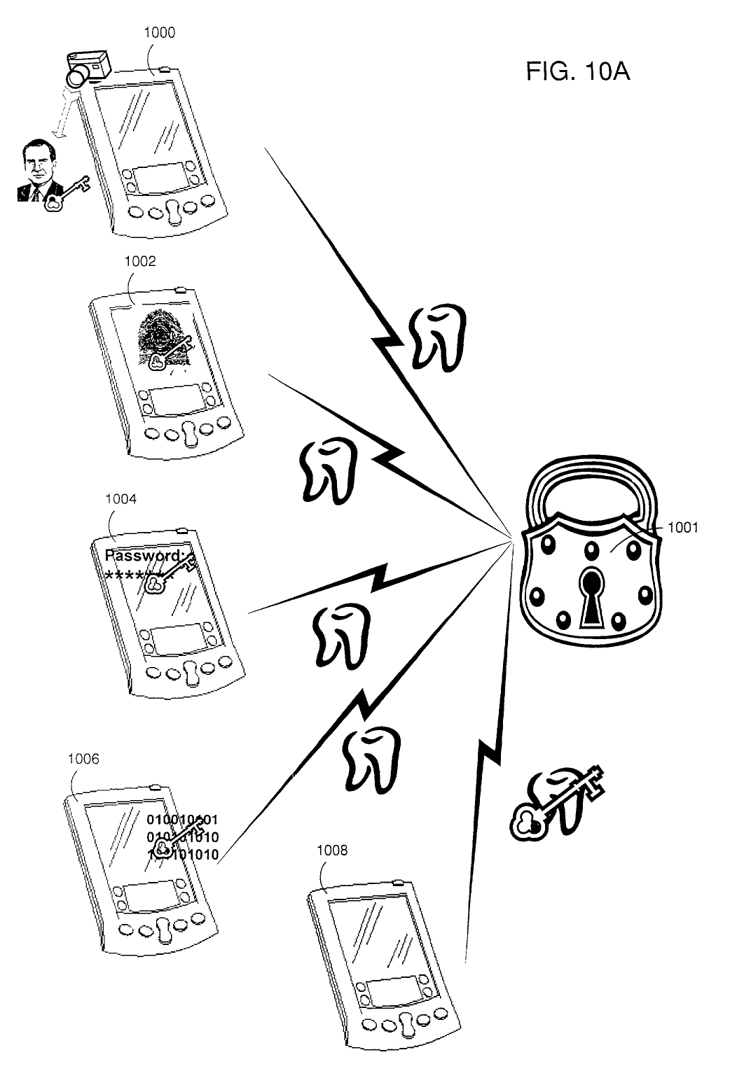

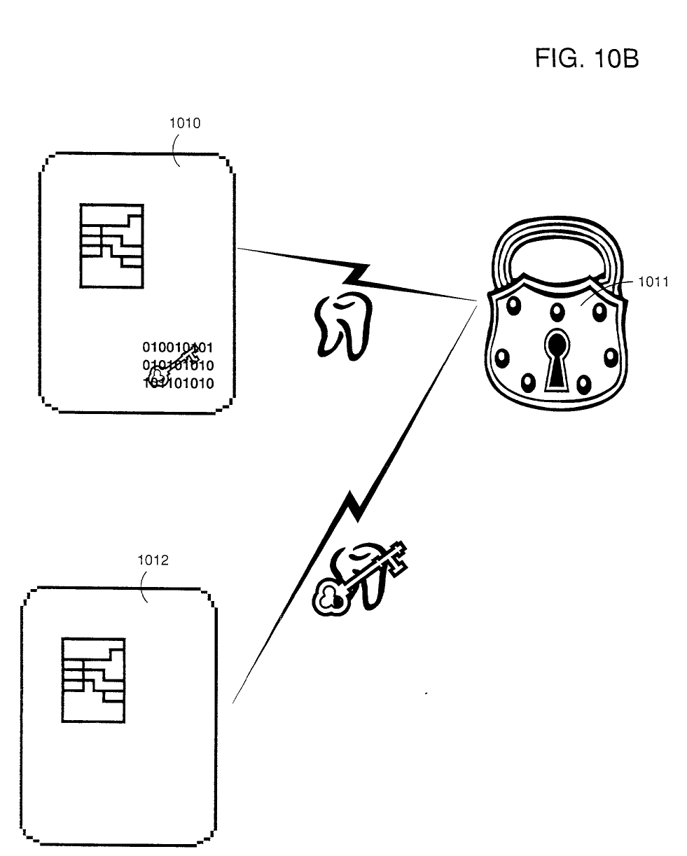

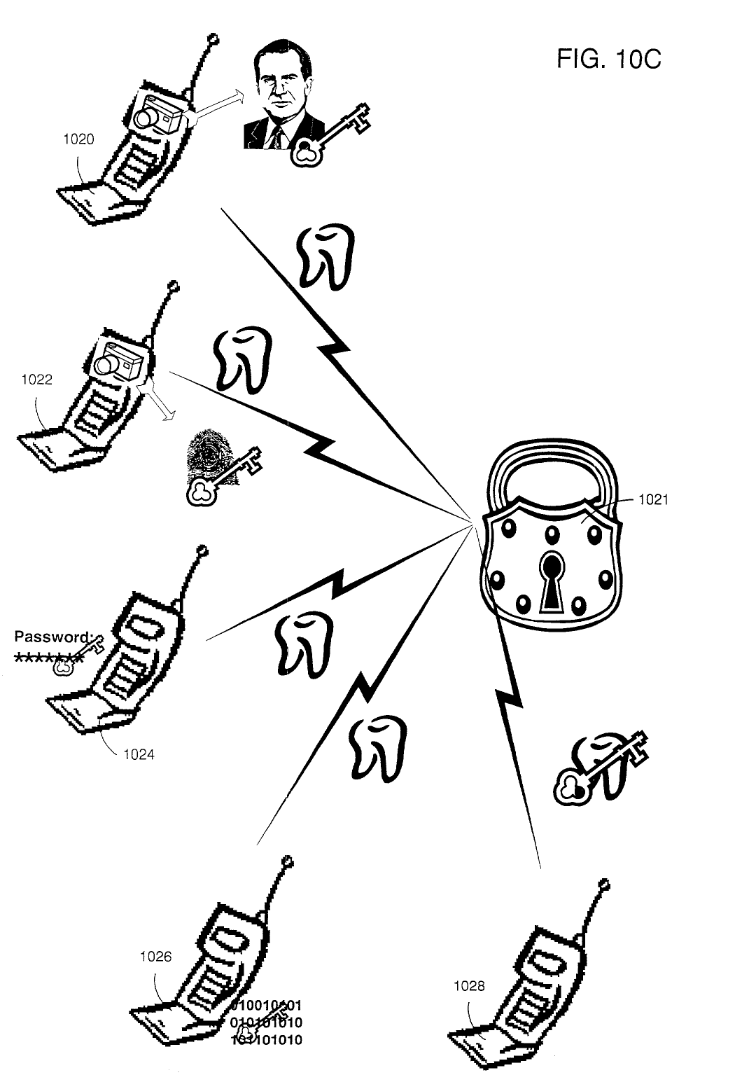

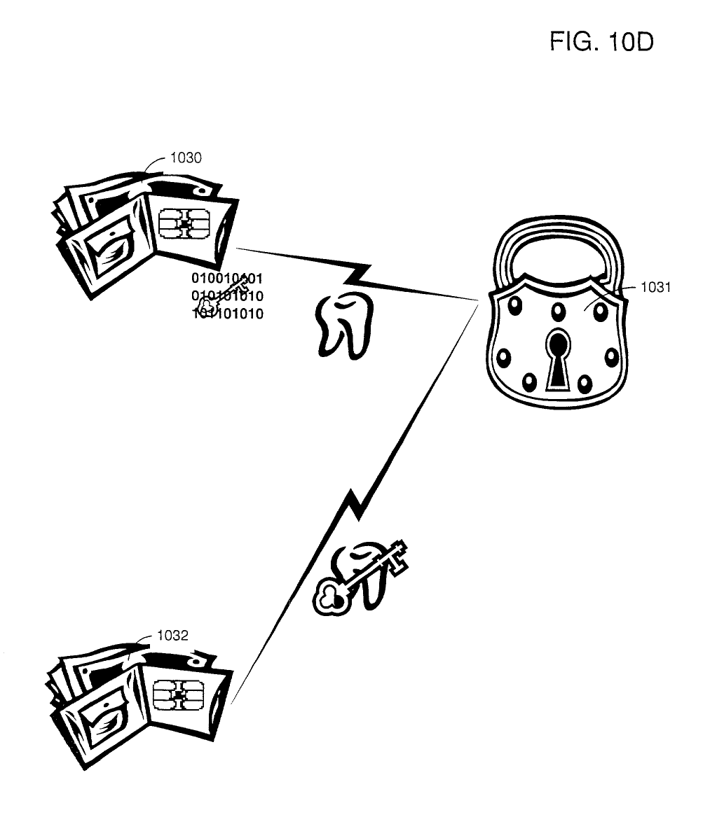

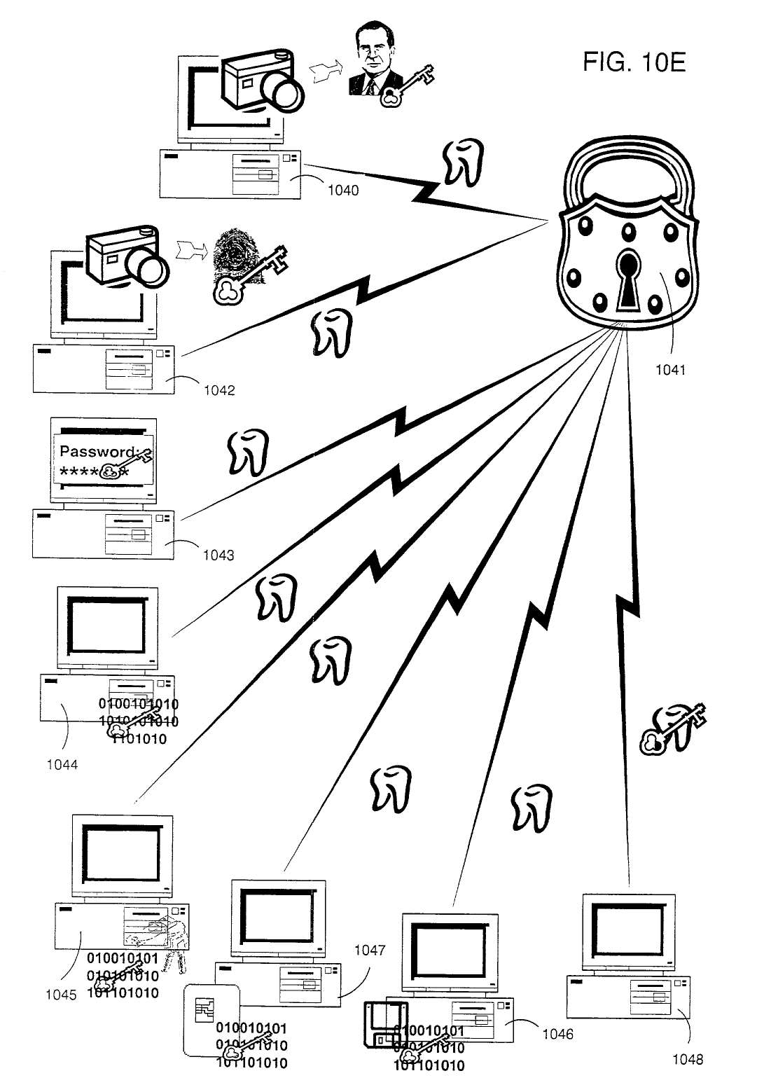

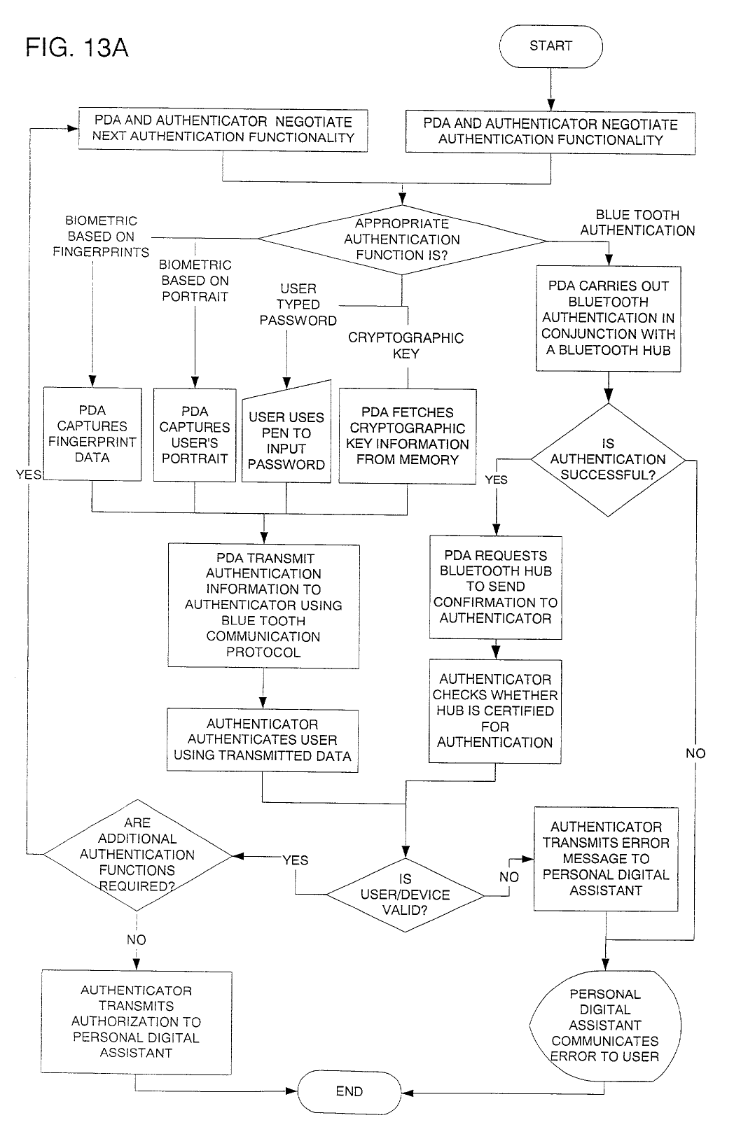

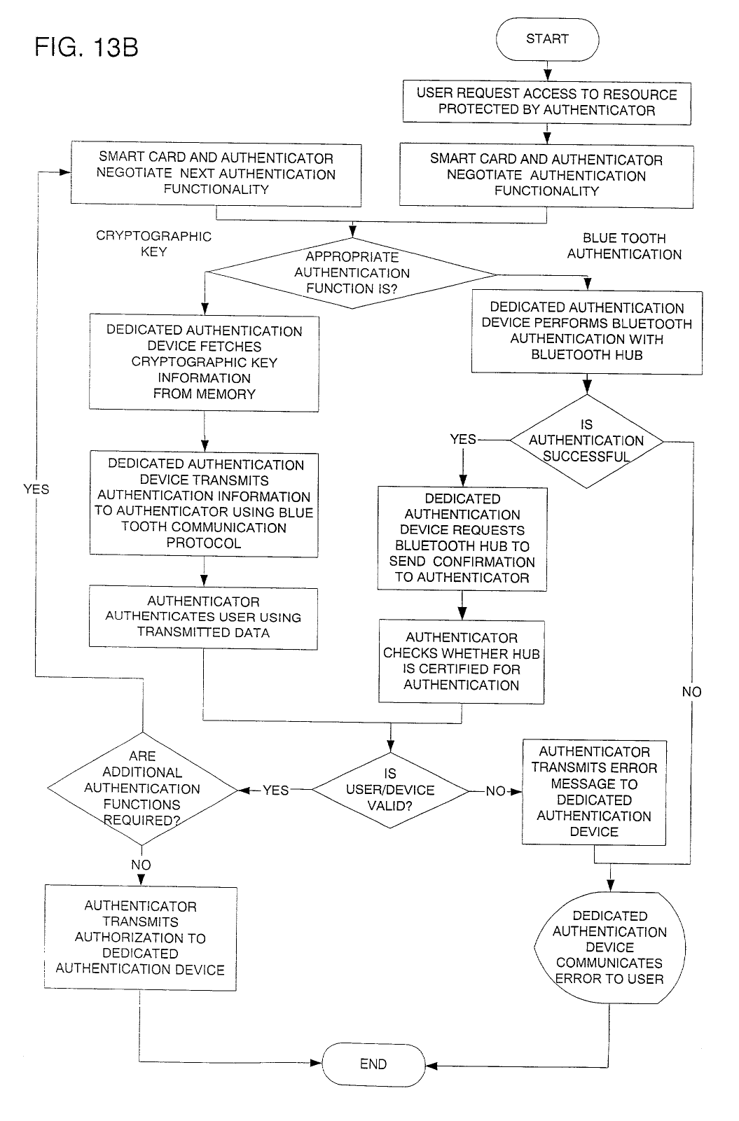

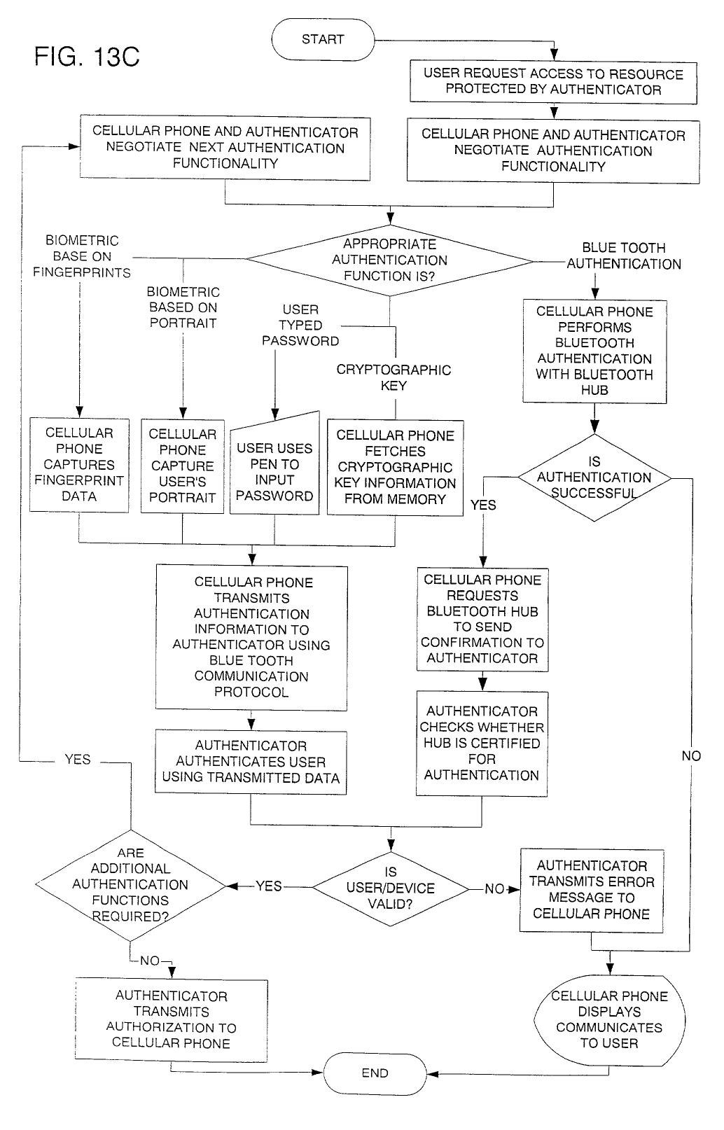

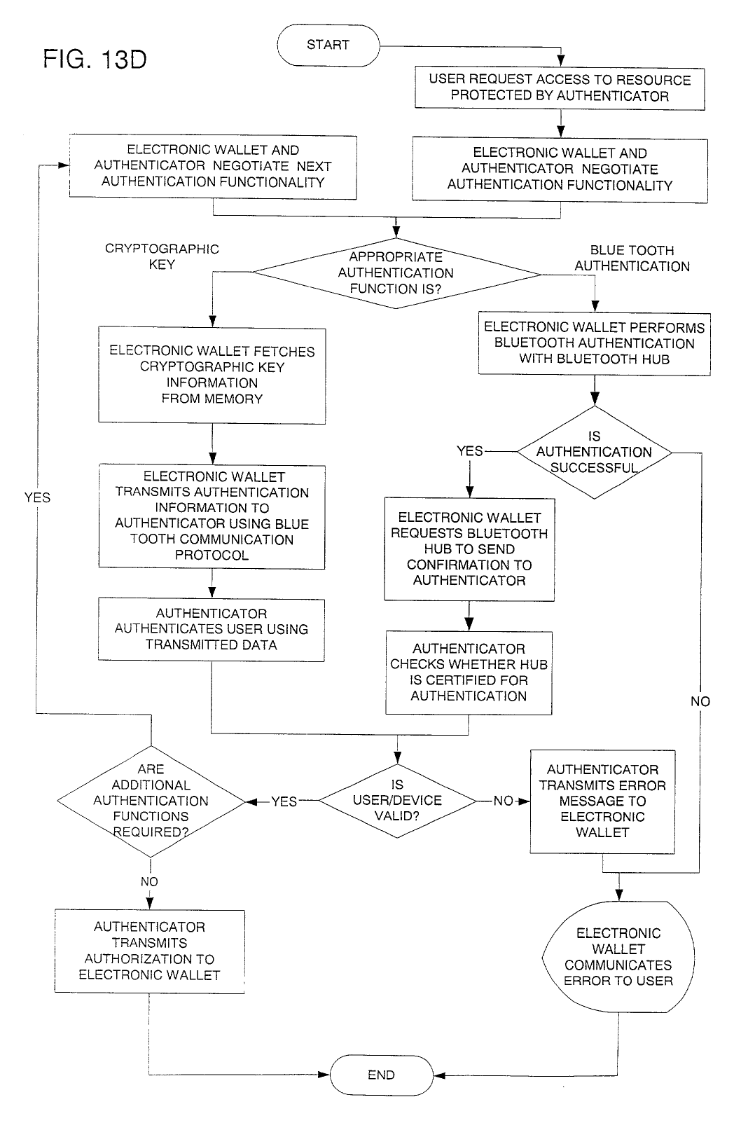

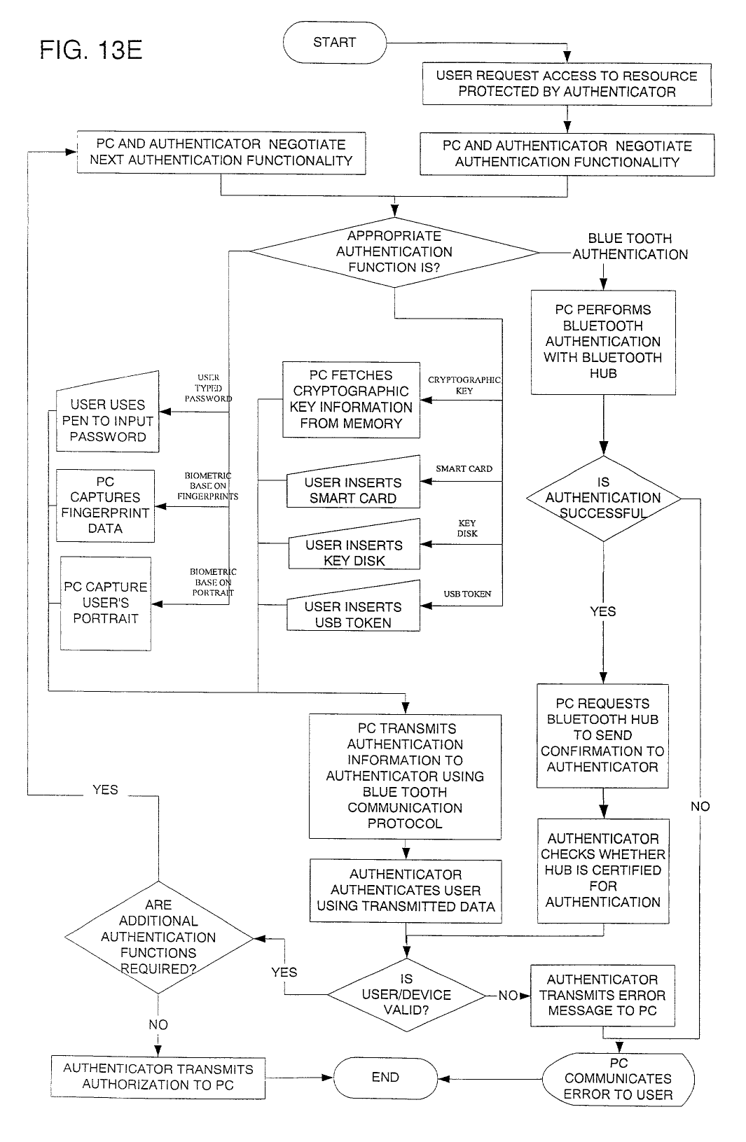

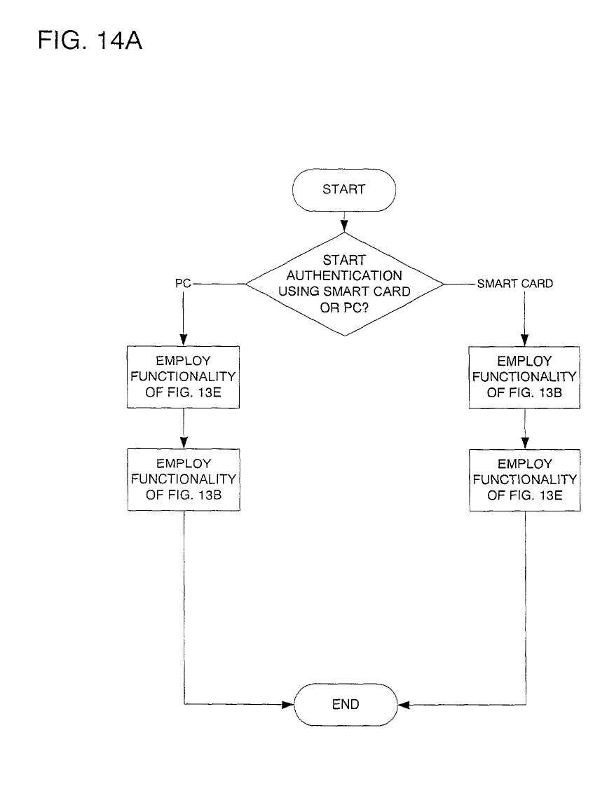

Reference is now made to FIGS. 10A, 10B, 10C, 10D and 10E which are simplified pictorial illustrations of single authentication functionalities appropriate for five different types of authentication devices and to FIGS. 13A, 13B, 13C, 13D and 13E, which are simplified flow charts of single authentication functionalities appropriate for five different types of authentication devices and correspond to FIGS. 10A-10E.

FIG. 10A illustrates five different authentication functionalities for a personal digital assistant. As seen in FIG. 10A, a personal digital assistant with associated camera, here designated by reference numeral 1000, provides authentication using facial recognition and communicates with an authenticator 1001, designated by a lock symbol, typically at least partially using a Bluetooth communication protocol.

Additionally or alternatively, a personal digital assistant having suitable touch screen functionality and/or an associated camera or scanner here designated by reference numeral 1002, provides authentication using fingerprint recognition and communicates with authenticator 1001, typically at least partially using a Bluetooth communication protocol.

Additionally or alternatively, a personal digital assistant, which may be of conventional design and construction, here designated by reference numeral 1004, provides password based authentication and communicates with authenticator 1001, typically at least partially using a Bluetooth communication protocol.

Additionally or alternatively, a personal digital assistant, which may be of conventional design and construction, here designated by reference numeral 1006, provides cryptographic authentication and communicates with authenticator 1001, typically at least partially using a Bluetooth communication protocol.

Additionally or alternatively, a personal digital assistant, which may be of conventional design and construction, here designated by reference numeral 1008, provides authentication employing authentication functionality, which forms part of a Bluetooth communication protocol.

It is appreciated that authentication may be provided in the embodiment of FIG. 10A by any one or more of the authentication devices and/or functionalities described hereinabove.

Reference is now made to FIG. 13A, which illustrates the authentication functionalities shown in FIG. 10A. As seen in FIG. 13A, a user who requests access to a resource protected by an authenticator may employ a personal digital assistant (PDA) to negotiate an authentication functionality. Depending on the facilities available in or in association with the personal digital assistant, one of the following authentication functionalities may be selected:

biometric utilizing fingerprint recognition;

biometric utilizing facial recognition;

password based;

cryptographic key based; and

Bluetooth based.

If the biometric authentication functionality utilizing fingerprint recognition is selected, the personal digital assistant captures the user's fingerprint data.

If the biometric authentication functionality utilizing facial recognition is selected, the personal digital assistant captures the user's facial features.

If the password based authentication functionality is selected, the personal digital assistant captures the user password input.

If the cryptographic key based authentication functionality selected, the personal digital assistant employs a cryptographic key typically stored in its memory.

In all of the foregoing cases, the personal digital assistant communicates authentication information to the authenticator using the Bluetooth communication protocol. In response to receipt of such information, the authenticator may authenticate the user.

If the Bluetooth authentication functionality is selected, the personal digital assistant carries out Bluetooth authentication in conjunction with a Bluetooth hub. If the authentication is successful, the personal digital assistant requests that the Bluetooth hub send an authentication confirmation to the authenticator. In response to receipt of the confirmation, the authenticator determines whether the hub, which sent the confirmation, is certified to do so.

If authentication of the user and/or device is successful, indicating that the user and/or device is authorized, a determination is made as to whether additional authentication functions are required. If so, the personal digital assistant and the authenticator negotiate the next authentication functionality and proceed as described hereinabove. If no additional authentication functions are required, the authenticator transmits an authentication confirmation to the personal digital assistant.

If authentication of the user and/or device is not successful at any stage, indicating that the user and/or device is not authorized, the authenticator transmits a non-authentication message to the personal digital assistant, which displays a suitable message to the user.

FIG. 10B illustrates two different authentication functionalities for a wireless smart card. As seen in FIG. 10B, a wireless smart card, here designated by reference numeral 1010, provides cryptographic authentication and communicates with an authenticator 1011, typically at least partially using a Bluetooth communication protocol.

Additionally or alternatively, a wireless smart card, which may be of conventional design and construction, here designated by reference numeral 1012, provides authentication employing authentication functionality, which forms part of a Bluetooth communication protocol.

It is appreciated that authentication may be provided in the embodiment of FIG. 10B by any one or more of the authentication devices and/or functionalities described hereinabove.

Reference is now made to FIG. 13B, which illustrates the authentication functionalities shown in FIG. 10B. As seen in FIG. 13B, a user who requests access to a resource protected by an authenticator may employ a wireless smart card to negotiate an authentication functionality. Depending on the facilities available in or in association with the wireless smart card, one of the following authentication functionalities may be selected:

cryptographic key based; and

Bluetooth based.

If the cryptographic key based authentication functionality selected, the wireless smart card employs a cryptographic key typically stored in its memory.

In this case, the wireless smart card communicates authentication information to the authenticator using the Bluetooth communication protocol. In response to receipt of such information, the authenticator may authenticate the user.

If the Bluetooth authentication functionality is selected, the wireless smart card carries out Bluetooth authentication in conjunction with a Bluetooth hub. If the authentication is successful, the wireless smart card requests that the Bluetooth hub send an authentication confirmation to the authenticator. In response to receipt of the confirmation, the authenticator determines whether the hub, which sent the confirmation, is certified to do so.

If authentication of the user and/or device is successful, indicating that the user and/or device is authorized, a determination is made as to whether additional authentication functions are required. If so, the wireless smart card and the authenticator negotiate the next authentication functionality and proceed as described hereinabove. If no additional authentication functions are required, the authenticator transmits an authentication confirmation to the wireless smart card.

If authentication of the user and/or device is not successful at any stage, indicating that the user and/or device is not authorized, the authenticator transmits a non-authentication message to the wireless smart card, which communicates a suitable message to the user.

FIG. 10C illustrates five different authentication functionalities for a cellular phone. As seen in FIG. 10C, a cellular phone with associated camera, here designated by reference numeral 1020, provides authentication using facial recognition and communicates with an authenticator 1021, designated by a lock symbol, typically at least partially using a Bluetooth communication protocol.

Additionally or alternatively, a cellular phone having suitable touch screen functionality and/or an associated camera or scanner here designated by reference numeral 1022, provides authentication using fingerprint recognition and/or facial recognition and communicates with authenticator 1021, typically at least partially using a Bluetooth communication protocol.

Additionally or alternatively, a cellular phone, which may be of conventional design and construction, here designated by reference numeral 1024, provides password based authentication and communicates with authenticator 1021, typically at least partially using a Bluetooth communication protocol.

Additionally or alternatively, a cellular phone, which may be of conventional design and construction, here designated by reference numeral 1026, provides cryptographic authentication and communicates with authenticator 1021, typically at least partially using a Bluetooth communication protocol.

Additionally or alternatively, a cellular phone, which may be of conventional design and construction, here designated by reference numeral 1028, provides authentication employing authentication functionality, which forms part of a Bluetooth communication protocol.

It is appreciated that authentication may be provided in the embodiment of FIG. 10C by any one or more of the authentication devices and/or functionalities described hereinabove.

Reference is now made to FIG. 13C, which illustrates the authentication functionalities shown in FIG. 10C. As seen in FIG. 13C, a user who requests access to a resource protected by an authenticator may employ a cellular phone to negotiate an authentication functionality. Depending on the facilities available in or in association with the cellular phone, one of the following authentication functionalities may be selected:

biometric utilizing fingerprint recognition;

biometric utilizing facial recognition;

password based;

cryptographic key based; and

Bluetooth based.

If the biometric authentication functionality utilizing fingerprint recognition is selected, the cellular phone captures the user's fingerprint data.

If the biometric authentication functionality utilizing facial recognition is selected, the cellular phone captures the user's facial features.

If the password based authentication functionality is selected, the cellular phone captures the user password input.

If the cryptographic key based authentication functionality selected, the cellular phone employs a cryptographic key typically stored in its memory.

In all of the foregoing cases, the cellular phone communicates authentication information to the authenticator using the Bluetooth communication protocol. In response to receipt of such information, the authenticator may authenticate the user.

If the Bluetooth authentication functionality is selected, the cellular phone carries out Bluetooth authentication in conjunction with a Bluetooth hub. If the authentication is successful, the cellular phone requests that the Bluetooth hub send an authentication confirmation to the authenticator. In response to receipt of the confirmation, the authenticator determines whether the hub, which sent the confirmation, is certified to do so.

If authentication of the user and/or device is successful, indicating that the user and/or device is authorized, a determination is made as to whether additional authentication functions are required. If so, the cellular phone and the authenticator negotiate the next authentication functionality and proceed as described hereinabove. If no additional authentication functions are required, the authenticator transmits an authentication confirmation to the cellular phone.

If authentication of the user and/or device is not successful at any stage, indicating that the user and/or device is not authorized, the authenticator transmits a non-authentication message to the cellular phone, which displays a suitable message to the user.

FIG. 10D illustrates two different authentication functionalities for an electronic wallet. As seen in FIG. 10D, an electronic wallet, here designated by reference numeral 1030, provides cryptographic authentication and communicates with an authenticator 1031, typically at least partially using a Bluetooth communication protocol.

Additionally or alternatively, an electronic wallet, which may be of conventional design and construction, here designated by reference numeral 1032, provides authentication employing authentication functionality, which forms part of a Bluetooth communication protocol.

It is appreciated that authentication may be provided in the embodiment of FIG. 10D by any one or more of the authentication devices and/or functionalities described hereinabove.

Reference is now made to FIG. 13D, which illustrates the authentication functionalities shown in FIG. 10D. As seen in FIG. 13D, a user who requests access to a resource protected by an authenticator may employ an electronic wallet to negotiate an authentication functionality. Depending on the facilities available in or in association with the electronic wallet, one of the following authentication functionalities may be selected:

cryptographic key based; and

Bluetooth based.

If the cryptographic key based authentication functionality selected, the electronic wallet employs a cryptographic key typically stored in its memory.

In this case, the electronic wallet communicates authentication information to the authenticator using the Bluetooth communication protocol. In response to receipt of such information, the authenticator may authenticate the user.

If the Bluetooth authentication functionality is selected, the electronic wallet carries out Bluetooth authentication in conjunction with a Bluetooth hub. If the authentication is successful, the electronic wallet requests that the Bluetooth hub send an authentication confirmation to the authenticator. In response to receipt of the confirmation, the authenticator determines whether the hub, which sent the confirmation, is certified to do so.

If authentication of the user and/or device is successful, indicating that the user and/or device is authorized, a determination is made as to whether additional authentication functions are required. If so, the electronic wallet and the authenticator negotiate the next authentication functionality and proceed as described hereinabove. If no additional authentication functions are required, the authenticator transmits an authentication confirmation to the electronic wallet.

If authentication of the user and/or device is not successful at any stage, indicating that the user and/or device is not authorized, the authenticator transmits a non-authentication message to the electronic wallet, which communicates a suitable message to the user.

FIG. 10E illustrates eight different authentication functionalities for a PC. As seen in FIG. 10E, a PC with associated camera, here designated by reference numeral 1040, provides authentication using facial recognition and communicates with an authenticator 1041, designated by a lock symbol, typically at least partially using a Bluetooth communication protocol.

Additionally or alternatively, a PC having suitable touch screen functionality and/or an associated camera or scanner here designated by reference numeral 1042, provides authentication using fingerprint recognition and communicates with authenticator 1041, typically at least partially using a Bluetooth communication protocol.

Additionally or alternatively, a PC, which may be of conventional design and construction, here designated by reference numeral 1043, provides password based authentication and communicates with authenticator 1041, typically at least partially using a Bluetooth communication protocol.

Additionally or alternatively, a PC which may be of conventional design and construction, here designated by reference numeral 1044, provides cryptographic authentication and communicates with authenticator 104-1, typically employing a memory based key, typically at least partially using a Bluetooth communication protocol.

Additionally or alternatively, a PC with an associated suitable USB token, here designated by reference numeral 1045, provides cryptographic authentication and communicates with authenticator 1041, typically at least partially using a Bluetooth communication protocol.

Additionally or alternatively, a PC with associated smart card, here designated by reference numeral 1047, provides cryptographic authentication and communicates with authenticator 1041, typically at least partially using a Bluetooth communication protocol.

Additionally or alternatively, a PC with an associated suitable key diskette, here designated by reference numeral 1046, provides cryptographic authentication and communicates with authenticator 1041, typically at least partially using a Bluetooth communication protocol.

Additionally or alternatively, a PC, which may be of conventional design and construction, here designated by reference numeral 1048, provides authentication employing authentication functionality, which forms part of a Bluetooth communication protocol.

It is appreciated that authentication may be provided in the embodiment of FIG. 10E by any one or more of the authentication devices and/or functionalities described hereinabove.

Reference is now made to FIG. 13E, which illustrates the authentication functionalities shown in FIG. 10E. As seen in FIG. 13E, a user who requests access to a resource protected by an authenticator may employ a PC to negotiate an authentication functionality. Depending on the facilities available in or in association with the PC, one of the following authentication functionalities may be selected:

biometric utilizing fingerprint recognition;

biometric utilizing facial recognition;

password based;

cryptographic utilizing a memory based key;

cryptographic utilizing a USB token based key;

cryptographic utilizing a smart card based key;

cryptographic utilizing a diskette based key; and

Bluetooth based.

If the biometric authentication functionality utilizing fingerprint recognition is selected, the PC captures the user's fingerprint data.

If the biometric authentication functionality utilizing facial recognition is selected, the PC captures the user's facial features.

If the password based authentication functionality is selected, the PC captures the user password input.

If the cryptographic memory based key authentication functionality is selected, the PC employs a cryptographic key typically stored in its memory.

If the cryptographic USB token based key authentication functionality is selected, the PC employs a cryptographic key typically stored in the associated USB key.

If the cryptographic smart card based key authentication functionality is selected, the PC employs a cryptographic key typically stored in the associated smart card.

If the cryptographic diskette based key authentication functionality is selected, the PC employs a cryptographic key typically stored in the associated key diskette.

In all of the foregoing cases, the PC communicates authentication information to the authenticator using the Bluetooth communication protocol. In response to receipt of such information, the authenticator may authenticate the user.

If the Bluetooth authentication functionality is selected, the PC carries out Bluetooth authentication in conjunction with a Bluetooth hub. If the authentication is successful, the PC requests that the Bluetooth hub send an authentication confirmation to the authenticator. In response to receipt of the confirmation, the authenticator determines whether the hub, which sent the confirmation, is certified to do so.

If authentication of the user and/or device is successful, indicating that the user and/or device is authorized, a determination is made as to whether additional authentication functions are required. If so, the PC and the authenticator negotiate the next authentication functionality and proceed as described hereinabove. If no additional authentication functions are required, the authenticator transmits an authentication confirmation to the PC.

If authentication of the user and/or device is not successful at any stage, indicating that the user and/or device is not authorized, the authenticator transmits a non-authentication message to the PC, which displays a suitable message to the user.

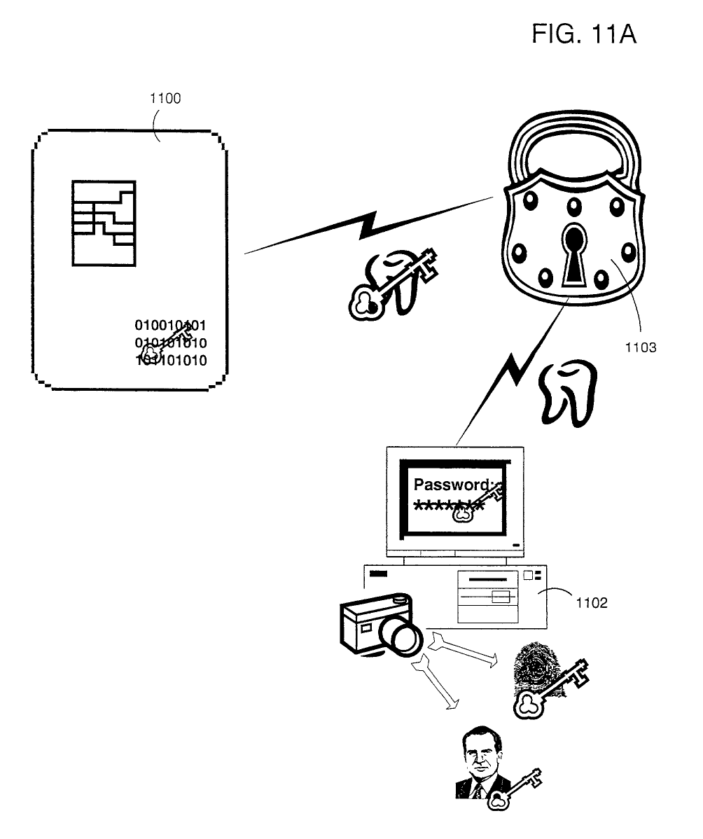

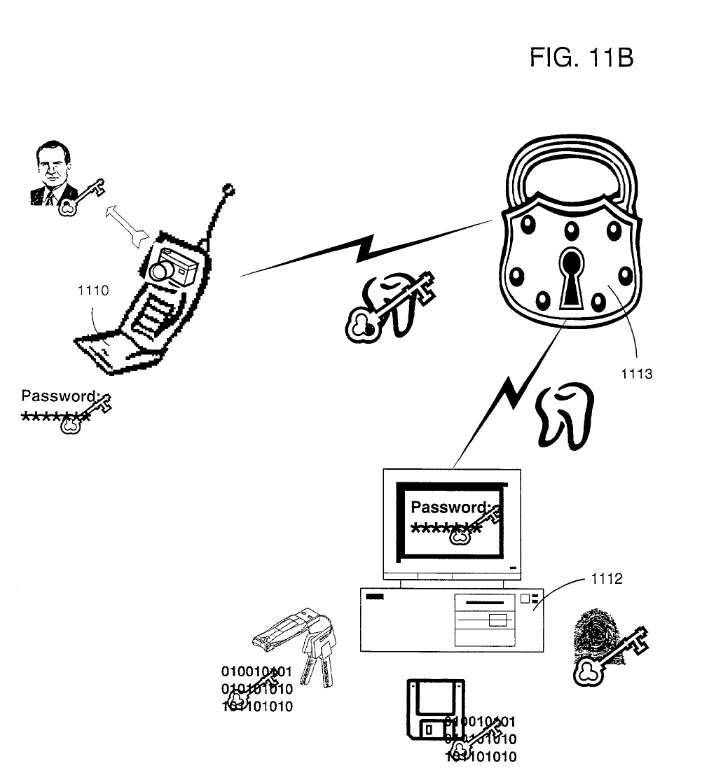

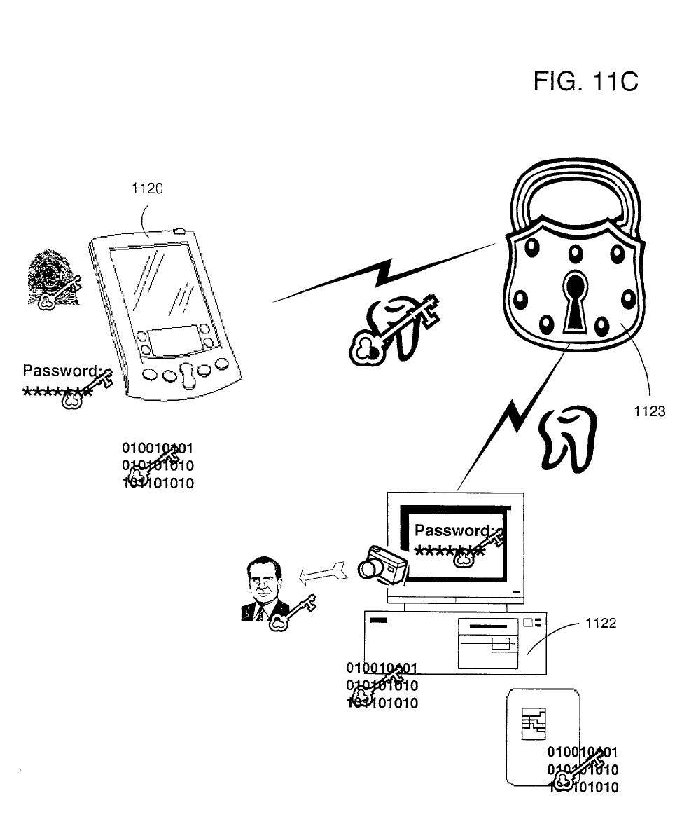

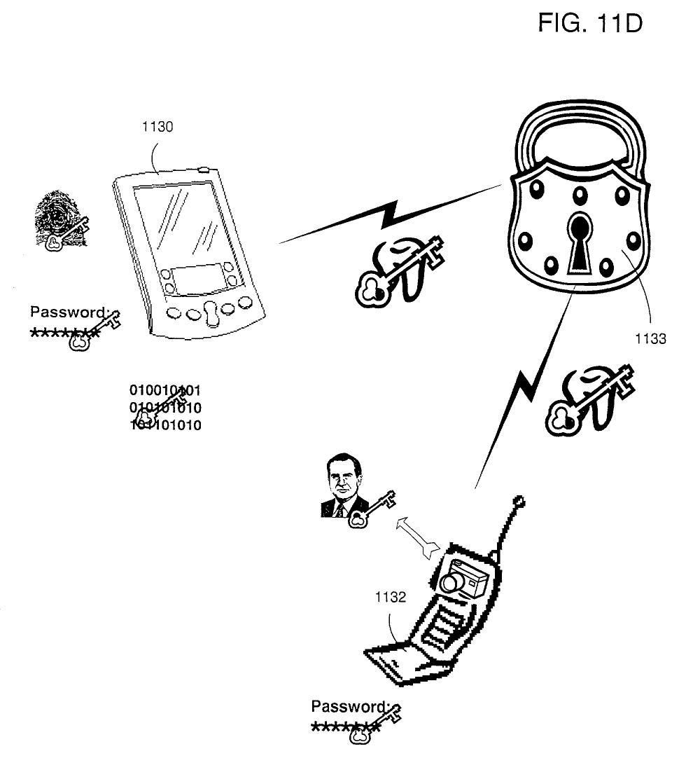

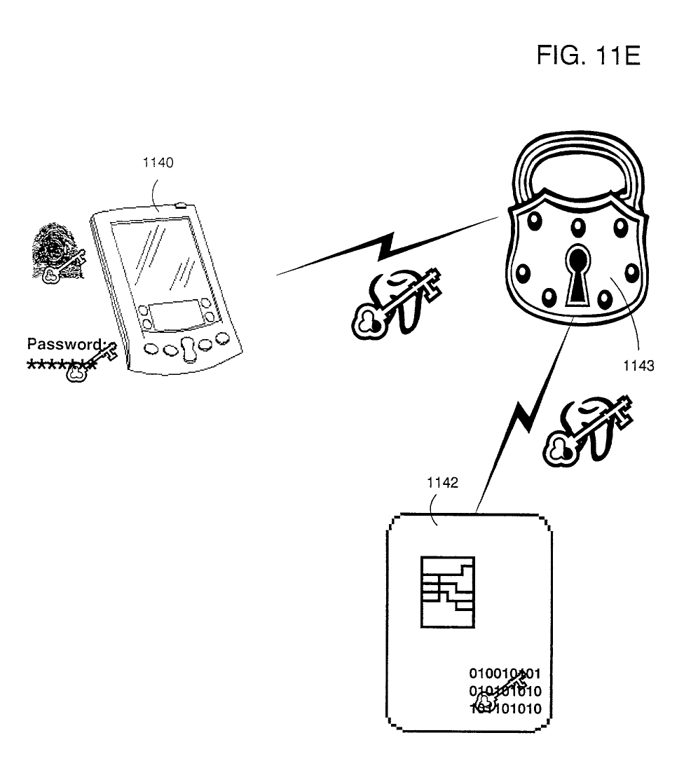

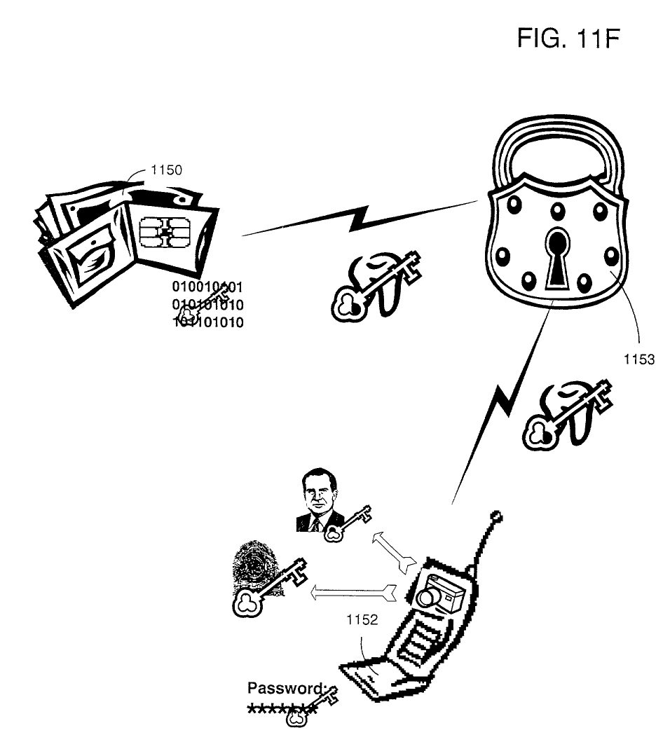

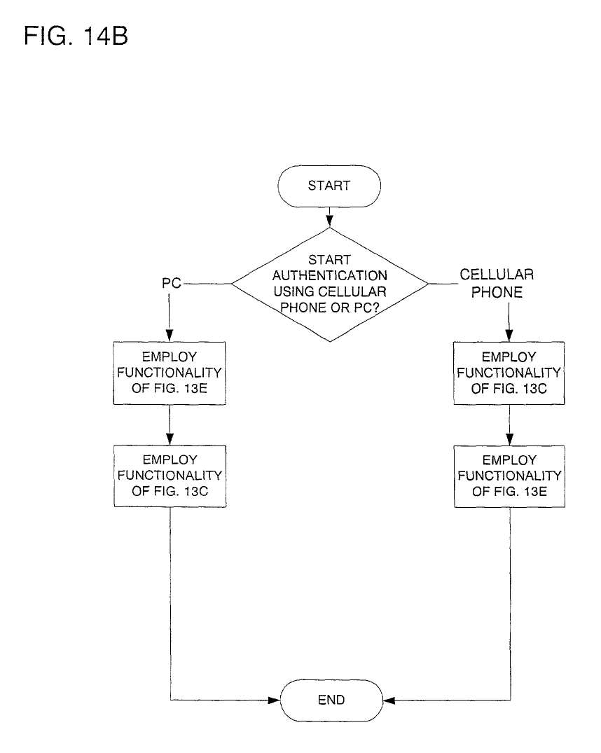

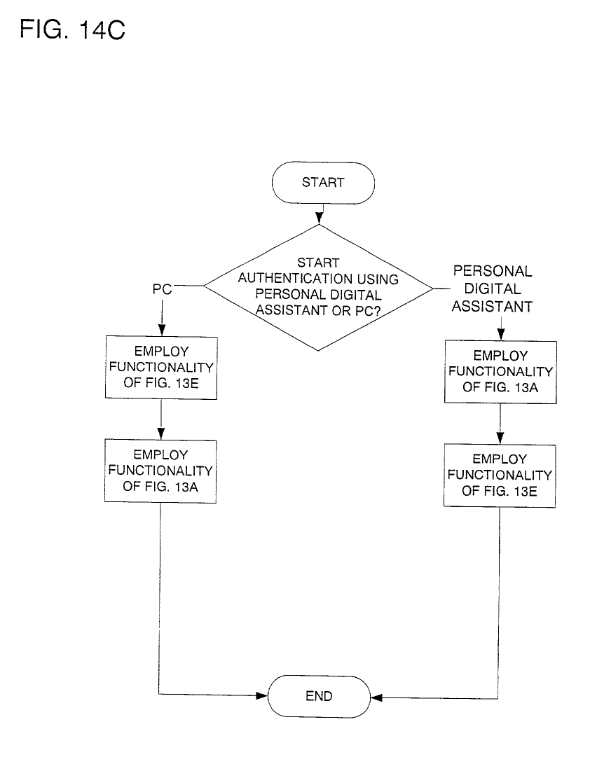

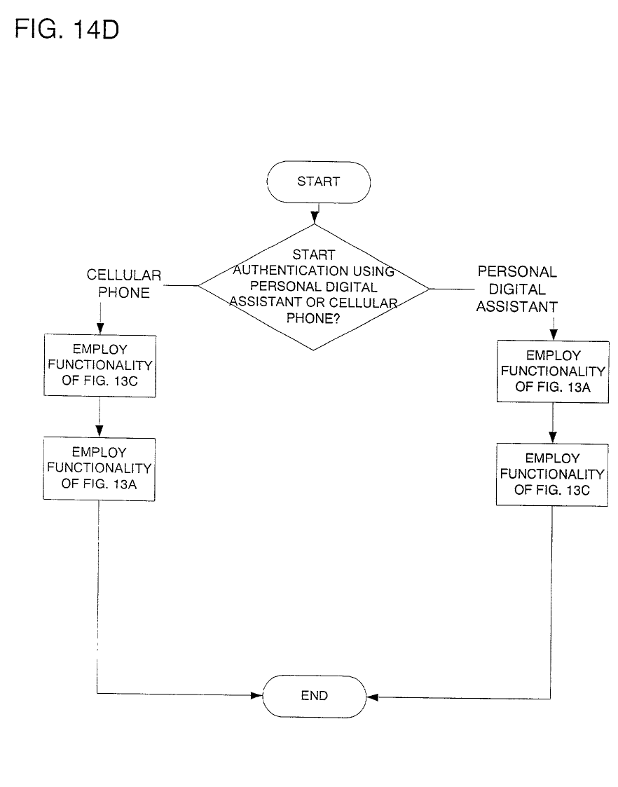

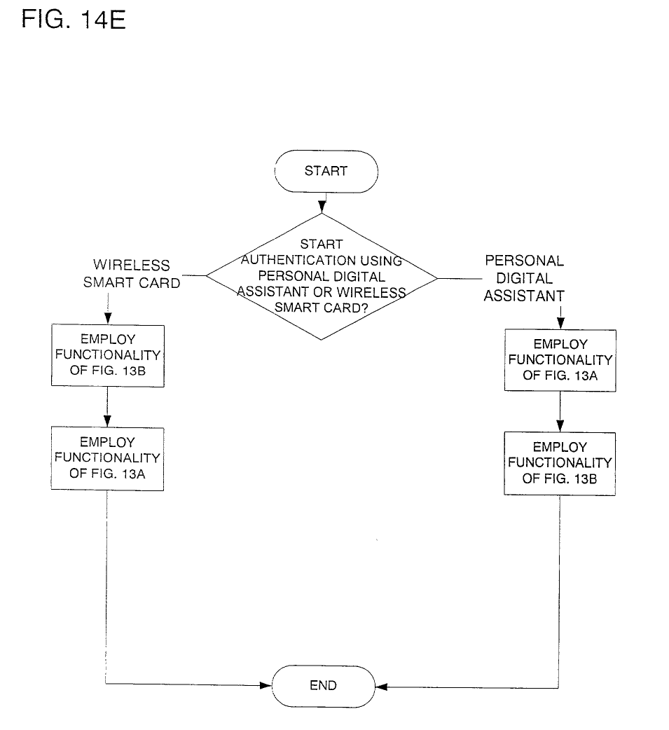

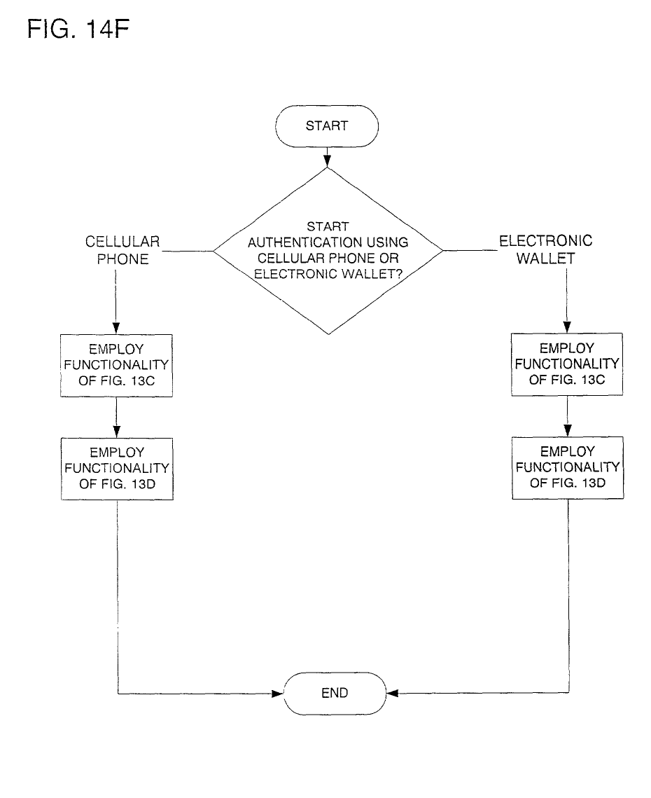

Reference is now made to FIGS. 11A, 11B, 11C, 11D, 11E and 11F which are simplified pictorial illustrations of combinations of authentication functionalities appropriate for six different combinations of different types of authentication devices and to FIGS. 14A, 14B, 14C, 14D, 14E and 14F, which are simplified flow charts of combinations of authentication functionalities appropriate for six different types of authentication devices and correspond to FIGS. 11A-11F.

FIG. 11A illustrates two different authentication functionalities for a wireless smart card, here designated by reference numeral 1100 and three different authentication functionalities for a PC with associated camera or scanner, here designated by reference numeral 1102. The five different functionalities may be combined in any combination of two or more functionalities to provide authentication in conjunction with an authenticator 1103, designated by a lock symbol, typically at least partially using a Bluetooth communication protocol.

As seen in FIG. 11A, wireless smart card 1100 provides cryptographic authentication functionality and communicates with authenticator 1103, typically at least partially using a Bluetooth communication protocol.

Additionally or alternatively, wireless smart card 1100 provides authentication employing authentication functionality, which forms part of a Bluetooth communication protocol.

Additionally or alternatively, the PC having an associated camera or scanner 1102, provides biometric authentication functionality using typically one or both of facial recognition and fingerprint recognition and communicates with authenticator 1103, typically at least partially using a Bluetooth communication protocol.

Additionally or alternatively, the PC 1102 provides password based authentication functionality and communicates with authenticator 1103, typically at least partially using a Bluetooth communication protocol.

It is appreciated that authentication may be provided in the embodiment of FIG. 11A by any one or more of the authentication devices and/or functionalities described hereinabove.

Reference is now made to FIG. 14A, which illustrates the authentication functionalities shown in FIG. 11A. As seen in FIG. 14A, a user employs the functionalities of FIGS. 13B and 13E typically in series in order to provide authentication. The user preferably negotiates with an authenticator to determine whether the functionality of FIG. 13B is employed prior to that of FIG. 13E or vice versa.

FIG. 11B illustrates three different authentication functionalities for a cellular phone with associated camera, here designated by reference numeral 1110 and four different authentication functionalities for a PC with associated camera or scanner, here designated by reference numeral 1112. The seven different functionalities may be combined in any combination of two or more functionalities to provide authentication in conjunction with an authenticator 1113, designated by a lock symbol, typically at least partially using a Bluetooth communication protocol.

As seen in FIG. 11B, cellular phone with associated camera 1110 provides biometric authentication functionality utilizing facial recognition and communicates with authenticator 1113, typically at least partially using a Bluetooth communication protocol.

Additionally or alternatively cellular phone 1110, which may be of conventional design and construction, provides password based authentication functionality and communicates with authenticator 1113, typically at least partially using a Bluetooth communication protocol.

Additionally or alternatively cellular phone 1110, which may be of conventional design and construction, provides authentication employing authentication functionality, which forms part of a Bluetooth communication protocol.

Additionally or alternatively, the PC having an associated camera or scanner 1112 provides biometric authentication functionality utilizing fingerprint recognition and communicates with authenticator 1113, typically at least partially using a Bluetooth communication protocol.

Additionally or alternatively, the PC 1112 provides password based authentication functionality and communicates with authenticator 1113, typically at least partially using a Bluetooth communication protocol.

Additionally or alternatively, the PC 1112 provides cryptographic authentication functionality utilizing a diskette based key and communicates with authenticator 1113, typically at least partially using a Bluetooth communication protocol.

Additionally or alternatively, the PC 1112 provides cryptographic authentication functionality utilizing USB token based key and communicates with authenticator 1113, typically at least partially using a Bluetooth communication protocol.

It is appreciated that authentication may be provided in the embodiment of FIG. 11B by any one or more of the authentication devices and/or functionalities described hereinabove.

Reference is now made to FIG. 14B, which illustrates the authentication functionalities shown in FIG. 11B. As seen in FIG. 14B, a user employs the functionalities of FIGS. 13C and 13E typically in series in order to provide authentication. The user preferably negotiates with an authenticator to determine whether the functionality of FIG. 13C is employed prior to that of FIG. 13E or vice versa.

FIG. 11C illustrates four different authentication functionalities for a personal digital assistant having suitable touch screen functionality and/or an associated camera or scanner, here designated by reference numeral 1120 and four different authentication functionalities for a PC with associated camera or scanner, here designated by reference numeral 1122. The eight different functionalities may be combined in any combination of two or more functionalities to provide authentication in conjunction with an authenticator 1123, designated by a lock symbol, typically at least partially using a Bluetooth communication protocol. [0110]

As seen in FIG. 11C, personal digital assistant having suitable touch screen functionality and/or an associated camera or scanner 1120 provides biometric authentication functionality utilizing fingerprint recognition and communicates with authenticator 1123, typically at least partially using a Bluetooth communication protocol.

Additionally or alternatively personal digital assistant 1120, which may be of conventional design and construction, provides password based authentication functionality and communicates with authenticator 1123, typically at least partially using a Bluetooth communication protocol.

Additionally or alternatively personal digital assistant 1120, which may be of conventional design and construction, provides cryptographic authentication functionality and communicates with authenticator 1123, typically at least partially using a Bluetooth communication protocol.

Additionally or alternatively personal digital assistant 1120, which may be of conventional design and construction, provides authentication employing authentication functionality, which forms part of a Bluetooth communication protocol.

Additionally or alternatively, a PC having an associated camera or scanner 1122, provides biometric authentication functionality using typically fingerprint recognition and communicates with authenticator 1123, typically at least partially using a Bluetooth communication protocol.

Additionally or alternatively, the PC 1122, which may be of conventional design and manufacturing, provides password based authentication functionality and communicates with authenticator 1123, typically at least partially using a Bluetooth communication protocol.

Additionally or alternatively, the PC 1122 with associated smart card provides cryptographic authentication functionality utilizing smart card based key and communicates with authenticator 1123, typically at least partially using a Bluetooth communication protocol.

Additionally or alternatively, the PC 1122, which may be of conventional design and manufacturing, provides cryptographic authentication functionality utilizing memory based key authentication and communicates with authenticator 1123, typically at least partially using a Bluetooth communication protocol.

It is appreciated that authentication may be provided in the embodiment of FIG. 11C by any one or more of the authentication devices and/or functionalities described hereinabove.

Reference is now made to FIG. 14C, which illustrates the authentication functionalities shown in FIG. 11C. As seen in FIG. 14C, a user employs the functionalities of FIGS. 13A and 13E typically in series in order to provide authentication. The user preferably negotiates with an authenticator to determine whether the functionality of FIG. 13A is employed prior to that of FIG. 13E or vice versa.

FIG. 11D illustrates four different authentication functionalities for a personal digital assistant having suitable touch screen functionality and/or an associated camera or scanner, here designated by reference numeral 1130 and three different authentication functionalities for a cellular phone with associated camera or scanner, here designated by reference numeral 1132. The seven different functionalities may be combined in any combination of two or more functionalities to provide authentication in conjunction with an authenticator 1133, designated by a lock symbol, typically at least partially using a Bluetooth communication protocol.

As seen in FIG. 11D, personal digital assistant having suitable touch screen functionality and/or an associated camera or scanner 1130 provides biometric authentication functionality utilizing fingerprint recognition and communicates with authenticator 1133, typically at least partially using a Bluetooth communication protocol.

Additionally or alternatively personal digital assistant 1130, which may be of conventional design and construction, provides password based authentication functionality and communicates with authenticator 1133, typically at least partially using a Bluetooth communication protocol.

Additionally or alternatively personal digital assistant 1130, which may be of conventional design and construction, provides cryptographic authentication functionality and communicates with authenticator 1133, typically at least partially using a Bluetooth communication protocol.

Additionally or alternatively personal digital assistant 1130, which may be of conventional design and construction, provides authentication employing authentication functionality, which forms part of a Bluetooth communication protocol.

Additionally or alternatively, a cellular phone having an associated camera or scanner 1132 provides biometric authentication functionality using typically facial recognition and communicates with authenticator 1133, typically at least partially using a Bluetooth communication protocol.

Additionally or alternatively, the cellular phone 1132, which may be of conventional design and manufacturing, provides password based authentication functionality and communicates with authenticator 1133, typically at least partially using a Bluetooth communication protocol.

Additionally or alternatively cellular phone 1132, which may be of conventional design and construction, provides authentication employing authentication functionality, which forms part of a Bluetooth communication protocol.

It is appreciated that authentication may be provided in the embodiment of FIG. 11D by any one or more of the authentication devices and/or functionalities described hereinabove.

Reference is now made to FIG. 14D, which illustrates the authentication functionalities shown in FIG. 11D. As seen in FIG. 14D, a user employs the functionalities of FIGS. 13A and 13C typically in series in order to provide authentication. The user preferably negotiates with an authenticator to determine whether the functionality of FIG. 13A is employed prior to that of FIG. 13C or vice versa.

FIG. 11E illustrates three different authentication functionalities for a personal digital assistant having suitable touch screen functionality and/or an associated camera or scanner, here designated by reference numeral 1140 and two different authentication functionalities for a wireless smart card, here designated by reference numeral 1142. The five different functionalities may be combined in any combination of two or more functionalities to provide authentication in conjunction with an authenticator 1143, designated by a lock symbol, typically at least partially using a Bluetooth communication protocol.

As seen in FIG. 11E, personal digital assistant having suitable touch screen functionality and/or an associated camera or scanner 1140 provides biometric authentication functionality utilizing fingerprint recognition and communicates with authenticator 1143, typically at least partially using a Bluetooth communication protocol.

Additionally or alternatively personal digital assistant 1140, which may be of conventional design and construction, provides password based authentication functionality and communicates with authenticator 1143, typically at least partially using a Bluetooth communication protocol.

Additionally or alternatively personal digital assistant 1140, which may be of conventional design and construction, provides authentication employing authentication functionality, which forms part of a Bluetooth communication protocol.

Additionally or alternatively wireless smart card 1142 provides cryptographic authentication functionality and communicates with authenticator 1143, typically at least partially using a Bluetooth communication protocol.

Additionally or alternatively wireless smart card 1142, which may be of conventional design and construction, provides authentication employing authentication functionality, which forms part of a Bluetooth communication protocol.

It is appreciated that authentication may be provided in the embodiment of FIG. 11E by any one or more of the authentication devices and/or functionalities described hereinabove.

Reference is now made to FIG. 14E, which illustrates the authentication functionalities shown in FIG. 11E. As seen in FIG. 14E, a user employs the functionalities of FIGS. 13A and 13B typically in series in order to provide authentication. The user preferably negotiates with an authenticator to determine whether the functionality of FIG. 13A is employed prior to that of FIG. 13B or vice versa.

FIG. 11F illustrates two different authentication functionalities for an electronic wallet, here designated by reference numeral 1150 and four different authentication functionalities for a cellular phone having an associated camera or scanner, here designated by reference numeral 1152. The five different functionalities may be combined in any combination of two or more functionalities to provide authentication in conjunction with an authenticator 1153, designated by a lock symbol, typically at least partially using a Bluetooth communication protocol.

As seen in FIG. 11F, wireless smart card 1152 provides cryptographic authentication functionality and communicates with authenticator 1153, typically at least partially using a Bluetooth communication protocol.

Additionally or alternatively wireless smart card 1152, which may be of conventional design and construction, provides authentication employing authentication functionality, which forms part of a Bluetooth communication protocol.

Additionally or alternatively cellular phone having an associated camera or scanner 1152 provides biometric authentication functionality employing typically facial and/or fingerprint recognition and communicates with authenticator 1153, typically at least partially using a Bluetooth communication protocol.

Additionally or alternatively cellular phone 1152, which may be of conventional design and manufacturing, provides password based authentication functionality and communicates with authenticator 1153, typically at least partially using a Bluetooth communication protocol.

Additionally or alternatively cellular phone 1152, which may be of conventional design and construction, provides authentication employing authentication functionality, which forms part of a Bluetooth communication protocol.

It is appreciated that authentication may be provided in the embodiment of FIG. 11F by any one or more of the authentication devices and/or functionalities described hereinabove.

Reference is now made to FIG. 14F, which illustrates the authentication functionalities shown in FIG. 11F. As seen in FIG. 14F, a user employs the functionalities of FIGS. 13C and 13D typically in series in order to provide authentication. The user preferably negotiates with an authenticator to determine whether the functionality of FIG. 13C is employed prior to that of FIG. 13D or vice versa.

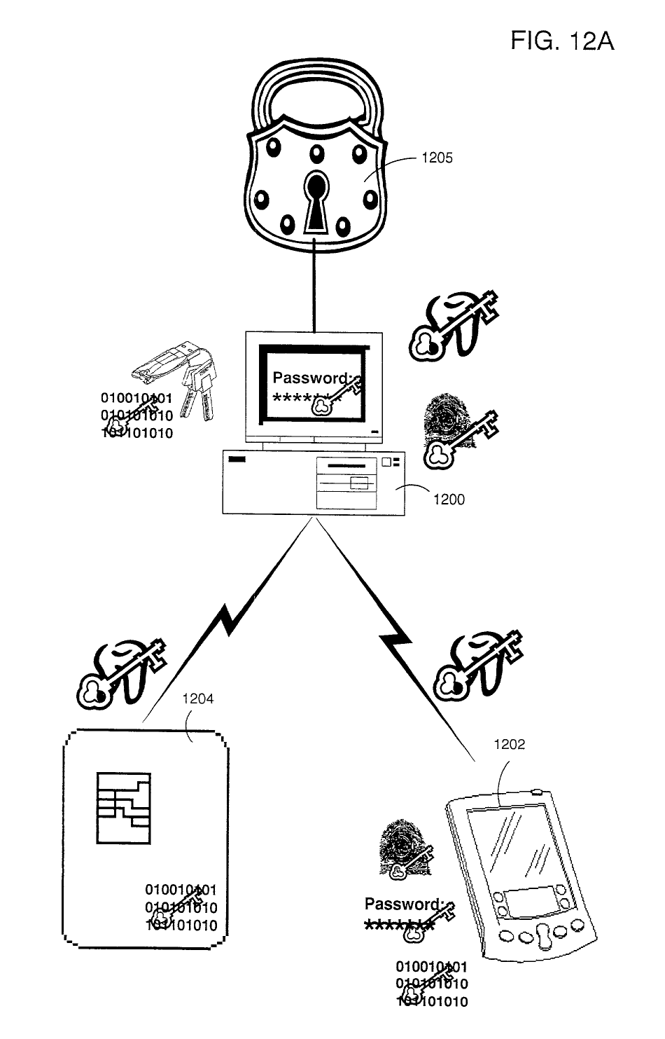

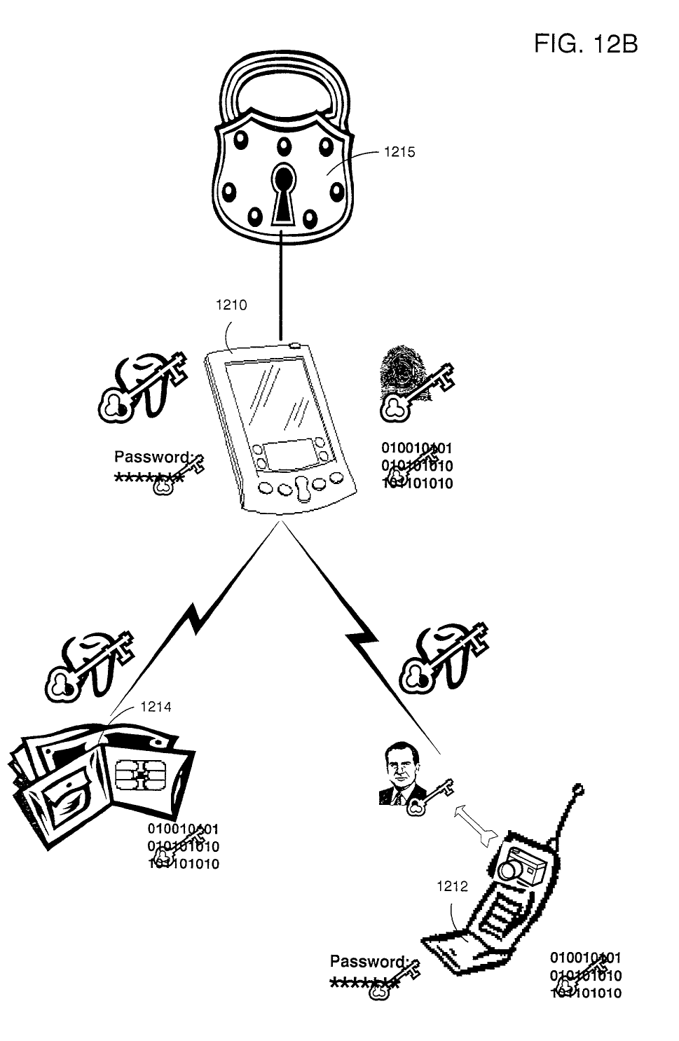

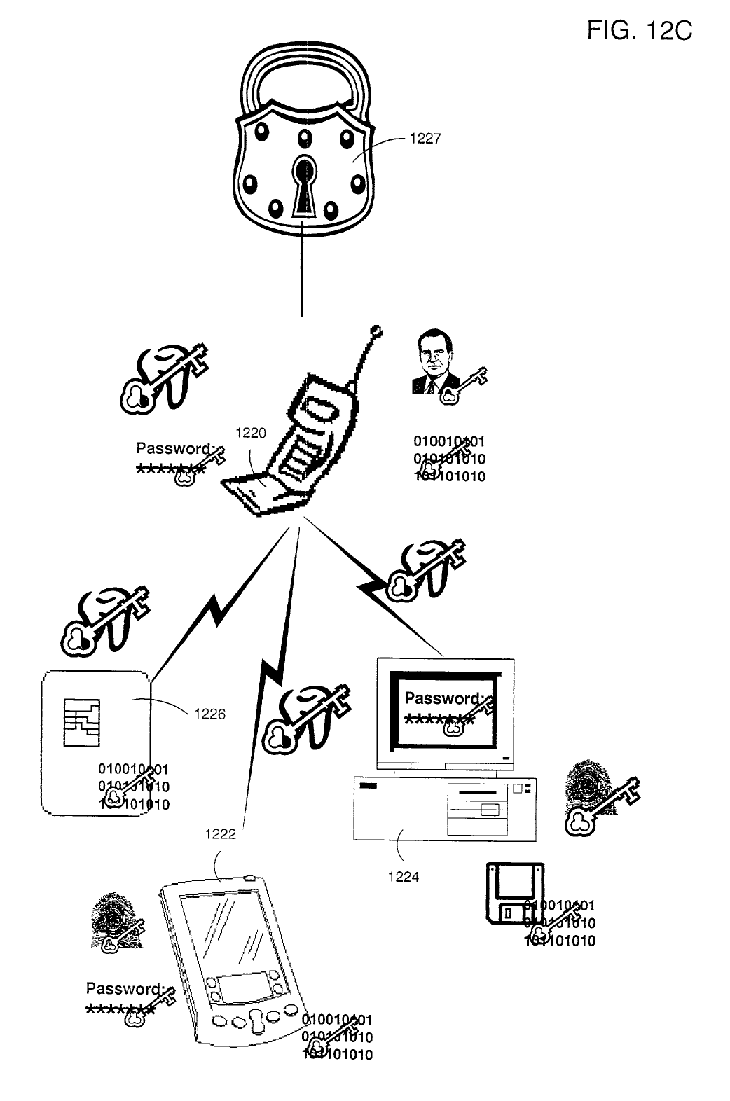

Reference is now made to FIGS. 12A, 12B and 12C, which are simplified pictorial illustrations of combinations of authentication functionalities appropriate for three different types of multi-tier authentication systems.

FIG. 12A illustrates four different authentication functionalities for a PC with associated camera or scanner, here designated by reference numeral 1200, four different authentication functionalities for a personal digital assistant with suitable touch screen functionality and/or an associated camera or scanner, here designated by reference numeral 1202 and two different authentication functionalities for a wireless smart card, here designated by reference numeral 1204. The ten different functionalities may be combined in any combination of two or more functionalities to provide multi-tier authentication in conjunction with an authenticator 1205, designated by a lock symbol, typically at least partially using a Bluetooth communication protocol.

As seen in FIG. 12A a PC having an associated camera or scanner 1200, provides biometric authentication functionality using typically fingerprint recognition and communicates with authenticator 1205, typically at least partially using a Bluetooth communication protocol.

Additionally or alternatively, the PC 1200, which may be of conventional design and manufacturing, provides password based authentication functionality and communicates with authenticator 1205, typically at least partially using a Bluetooth communication protocol.

Additionally or alternatively, the PC 1200 with associated USB token provides cryptographic authentication functionality utilizing USB token based key and communicates with authenticator 1205, typically at least partially using a Bluetooth communication protocol.

Additionally or alternatively, the PC 1200, which may be of conventional design and manufacturing, provides cryptographic authentication functionality utilizing memory based key authentication and communicates with authenticator 1205, typically at least partially using a Bluetooth communication protocol.

Additionally or alternatively, personal digital assistant having suitable touch screen functionality and/or an associated camera or scanner 1202 provides biometric authentication functionality utilizing fingerprint recognition and communicates with authenticator 1205, typically at least partially using a Bluetooth communication protocol.

Additionally or alternatively personal digital assistant 1202, which may be of conventional design and construction, provides password based authentication functionality and communicates with authenticator 1205, typically at least partially using a Bluetooth communication protocol.

Additionally or alternatively personal digital assistant 1202, which may be of conventional design and construction, provides cryptographic authentication functionality and communicates with authenticator 1205, typically at least partially using a Bluetooth communication protocol.

Additionally or alternatively personal digital assistant 1202, which may be of conventional design and construction, provides authentication employing authentication functionality, which forms part of a Bluetooth communication protocol.

Additionally or alternatively wireless smart card 1204 provides cryptographic authentication functionality and communicates with authenticator 1205, typically at least partially using a Bluetooth communication protocol.

Additionally or alternatively, wireless smart card 1204 provides authentication employing authentication functionality, which forms part of a Bluetooth communication protocol.

It is appreciated that multi-tier authentication may be provided in the embodiment of FIG. 12A by any one or more combinations of the authentication devices and/or functionalities described hereinabove.

FIG. 12B illustrates four different authentication functionalities for a personal digital assistant with suitable touch screen functionality and/or associated camera or scanner, here designated by reference numeral 1210, four different authentication functionalities for a cellular phone with an associated camera or scanner, here designated by reference numeral 1212 and two different authentication functionalities for an electronic wallet, here designated by reference numeral 1214. The ten different functionalities may be combined in any combination of two or more functionalities to provide multi-tier authentication in conjunction with an authenticator 1215, designated by a lock symbol, typically at least partially using a Bluetooth communication protocol.

As seen in FIG. 12B personal digital assistant having suitable touch screen functionality and/or an associated camera or scanner 1210 provides biometric authentication functionality utilizing fingerprint recognition and communicates with authenticator 1215, typically at least partially using a Bluetooth communication protocol.

Additionally or alternatively personal digital assistant 1210, which may be of conventional design and construction, provides password based authentication functionality and communicates with authenticator 1215, typically at least partially using a Bluetooth communication protocol.

Additionally or alternatively personal digital assistant 1210, which may be of conventional design and construction, provides cryptographic authentication functionality and communicates with authenticator 1215, typically at least partially using a Bluetooth communication protocol.

Additionally or alternatively personal digital assistant 1210, which may be of conventional design and construction, provides authentication employing authentication functionality, which forms part of a Bluetooth communication protocol.

Additionally or alternatively cellular phone with associated camera, here designated by reference numeral 1212, provides authentication using facial recognition and communicates with an authenticator 1215, designated by a lock symbol, typically at least partially using a Bluetooth communication protocol.

Additionally or alternatively, a cellular phone, which may be of conventional design and construction, here designated by reference numeral 1212, provides password based authentication and communicates with authenticator 1215, typically at least partially using a Bluetooth communication protocol.

Additionally or alternatively, cellular phone, which may be of conventional design and construction, here designated by reference numeral 1212, provides cryptographic authentication and communicates with authenticator 1215, typically at least partially using a Bluetooth communication protocol.

Additionally or alternatively, cellular phone, which may be of conventional design and construction, here designated by reference numeral 1212, provides authentication employing authentication functionality, which forms part of a Bluetooth communication protocol.

Additionally or alternatively, electronic wallet, here designated by reference numeral 1214, provides cryptographic authentication and communicates with an authenticator 1215, typically at least partially using a Bluetooth communication protocol.

Additionally or alternatively, electronic wallet, which may be of conventional design and construction, here designated by reference numeral 1214, provides authentication employing authentication functionality, which forms part of a Bluetooth communication protocol.

It is appreciated that multi-tier authentication may be provided in the embodiment of FIG. 12B by any one or more combinations of the authentication devices and/or functionalities described hereinabove.

FIG. 12C illustrates four different authentication functionalities for a cellular phone with suitable touch screen functionality and/or associated camera or scanner, here designated by reference numeral 1220, four different authentication functionalities for a personal digital assistant with a suitable touch screen and/or an associated camera or scanner, here designated by reference numeral 1222, four different authentication functionalities for a PC with a suitable touch screen and an associated camera or scanner, here designated by reference numeral 1224, and two different authentication functionalities for a wireless smart card, here designated by reference numeral 1226. The fourteen different functionalities may be combined in any combination of two or more functionalities to provide multi-tier authentication in conjunction with an authenticator 1227, designated by a lock symbol, typically at least partially using a Bluetooth communication protocol.

As seen in FIG. 12C cellular phone with associated camera, here designated by reference numeral 1220, provides authentication using facial recognition and communicates with an authenticator 1227, designated by a lock symbol, typically at least partially using a Bluetooth communication protocol.

Additionally or alternatively, a cellular phone, which may be of conventional design and construction, here designated by reference numeral 1220, provides password based authentication and communicates with authenticator 1227, typically at least partially using a Bluetooth communication protocol.

Additionally or alternatively, cellular phone, which may be of conventional design and construction, here designated by reference numeral 1220, provides cryptographic authentication and communicates with authenticator 1227, typically at least partially using a Bluetooth communication protocol.

Additionally or alternatively, cellular phone, which may be of conventional design and construction, here designated by reference numeral 1220, provides authentication employing authentication functionality, which forms part of a Bluetooth communication protocol.

Additionally or alternatively, personal digital assistant having suitable touch screen functionality and/or an associated camera or scanner 1222 provides biometric authentication functionality utilizing fingerprint recognition and communicates with authenticator 1227, typically at least partially using a Bluetooth communication protocol.

Additionally or alternatively personal digital assistant 1222, which may be of conventional design and construction, provides password based authentication functionality and communicates with authenticator 1227, typically at least partially using a Bluetooth communication protocol.

Additionally or alternatively personal digital assistant 1222, which may be of conventional design and construction, provides cryptographic authentication functionality and communicates with authenticator 1227, typically at least partially using a Bluetooth communication protocol.

Additionally or alternatively personal digital assistant 1222, which may be of conventional design and construction, provides authentication employing authentication functionality, which forms part of a Bluetooth communication protocol.

Additionally or alternatively the PC having an associated camera or scanner 1224, provides biometric authentication functionality using typically fingerprint recognition and communicates with authenticator 1227, typically at least partially using a Bluetooth communication protocol.

Additionally or alternatively, PC 1224, which may be of conventional design and manufacturing, provides password based authentication functionality and communicates with authenticator 1227, typically at least partially using a Bluetooth communication protocol.

Additionally or alternatively, PC 1224, which may be of conventional design and manufacturing, provides cryptographic authentication functionality utilizing suitable key diskette authentication and communicates with authenticator 1227, typically at least partially using a Bluetooth communication protocol.

Additionally or alternatively, PC 1224, which may be of conventional design and manufacturing, provides authentication employing authentication functionality, which forms part of a Bluetooth communication protocol.

Additionally or alternatively wireless smart card 1226 provides cryptographic authentication functionality and communicates with authenticator 1227, typically at least partially using a Bluetooth communication protocol.

Additionally or alternatively, wireless smart card 1226 provides authentication employing authentication functionality, which forms part of a Bluetooth communication protocol.

It is appreciated that multi-tier authentication may be provided in the embodiment of FIG. 12C by any one or more combinations of the authentication devices and/or functionalities described hereinabove.

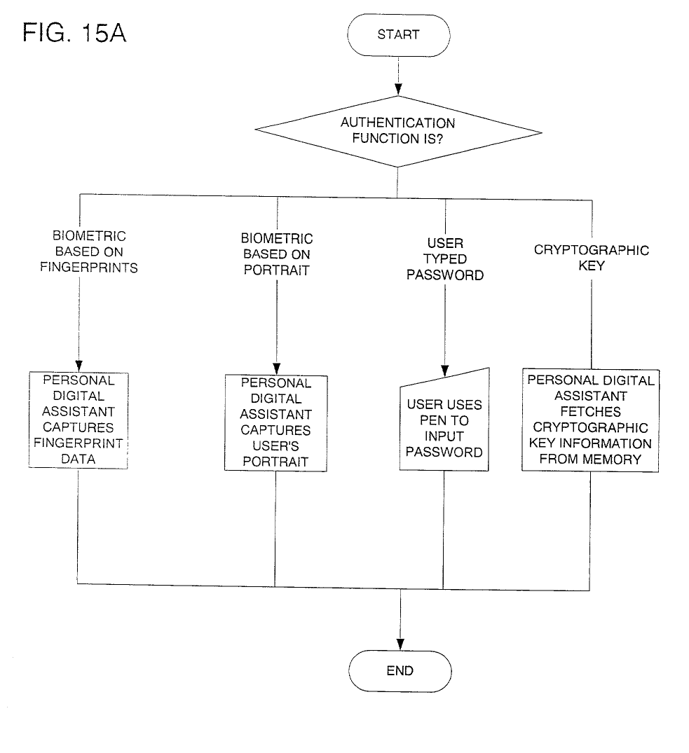

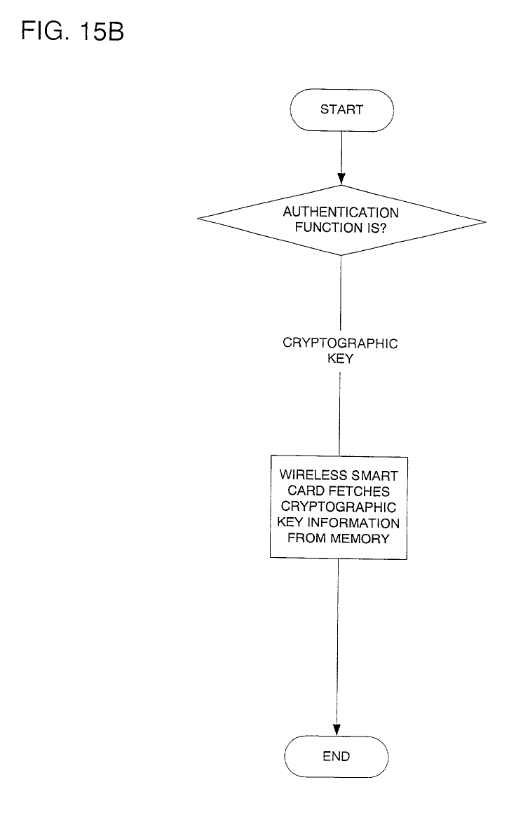

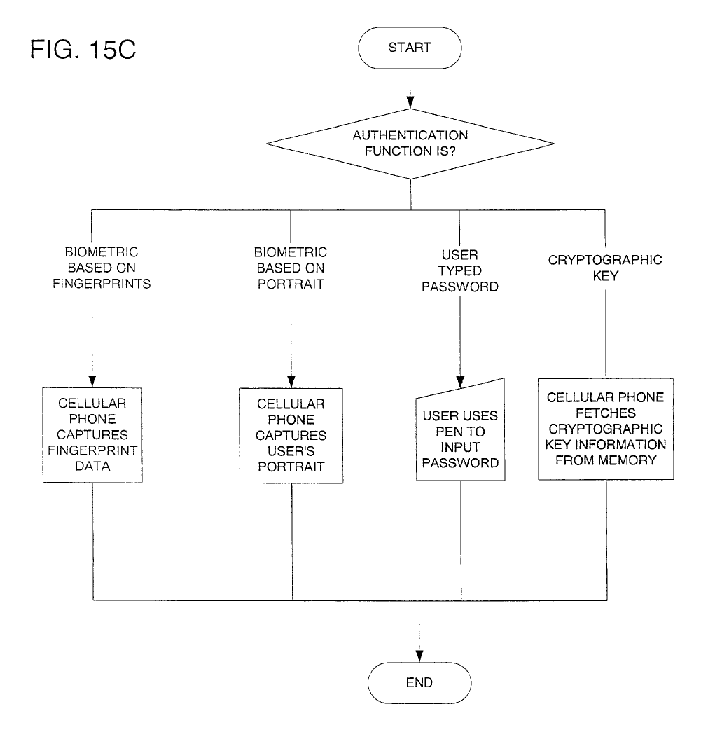

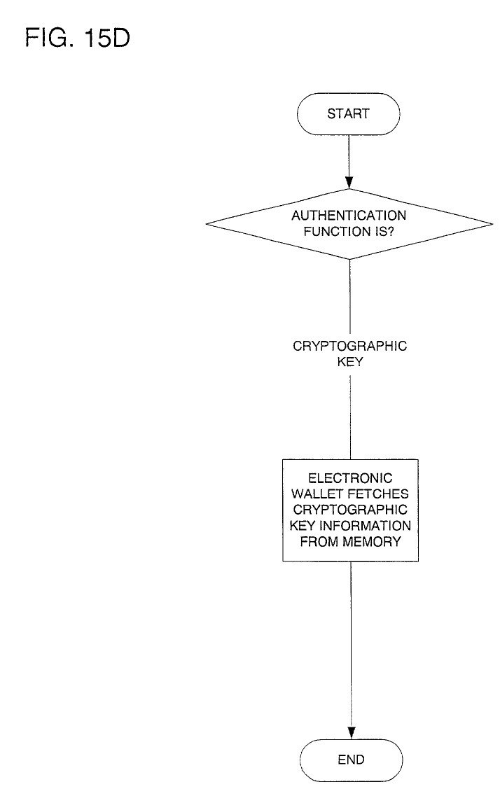

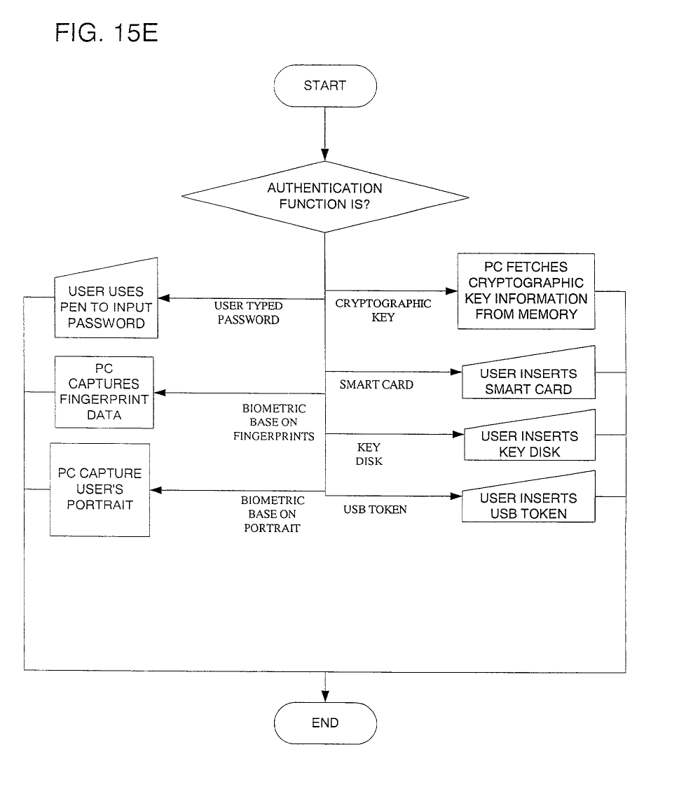

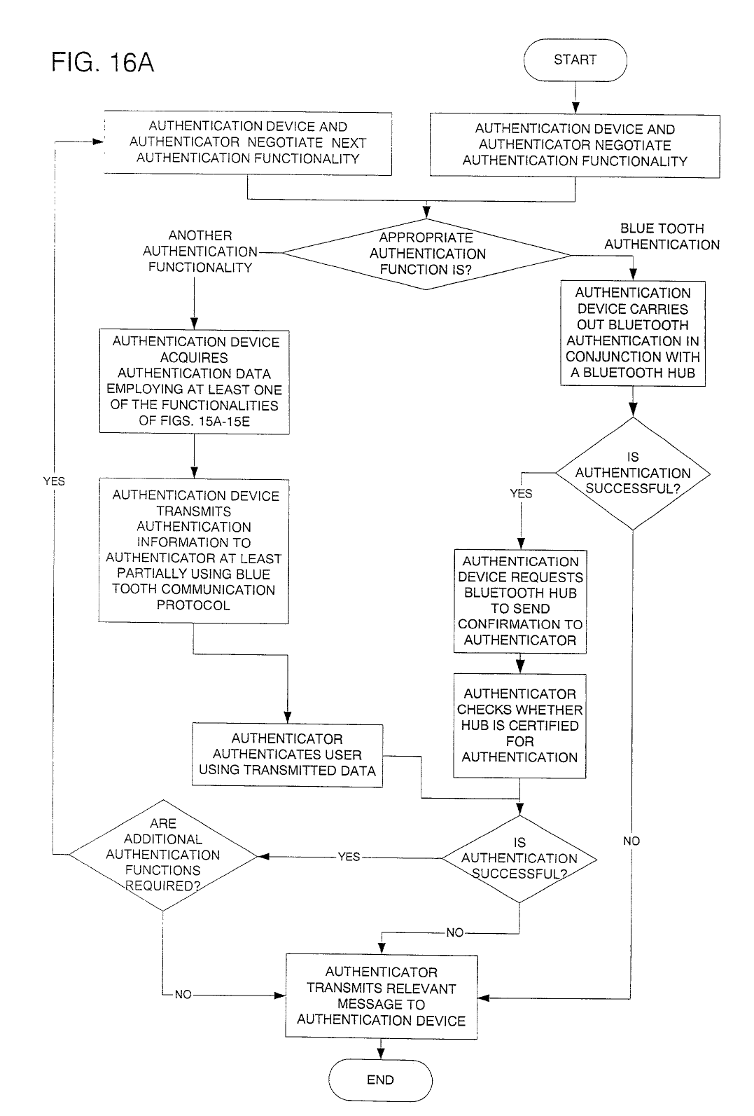

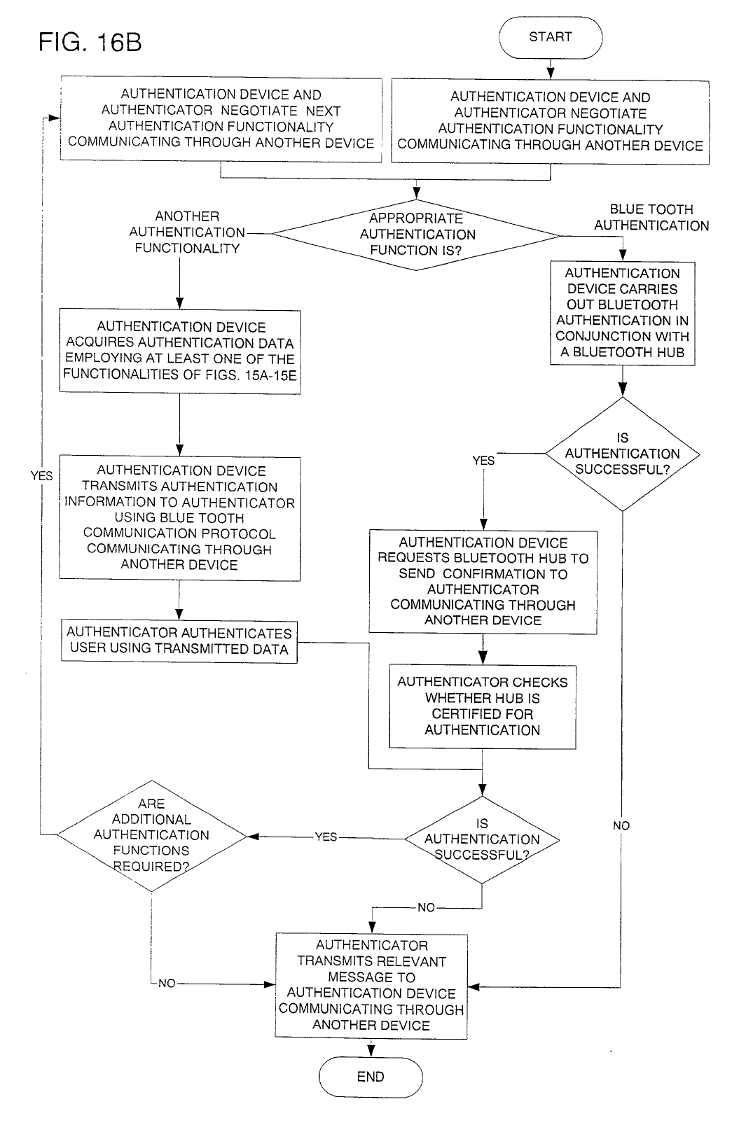

Reference is now made to FIGS. 15A, 15B, 15C, 15D and 15E, which are simplified flow charts of methods for obtaining authentication information for five different types of authentication devices.

FIG. 15A illustrates methods for obtaining authentication information suitable for a personal digital assistant. As seen in FIG. 15A depending on the facilities available in or in association with the personal digital assistant, one of the following authentication functionalities which require obtaining authentication information may be selected:

biometric utilizing fingerprint recognition;

biometric utilizing facial recognition;

password based; and

cryptographic key based.

If the biometric authentication functionality utilizing fingerprint recognition is selected, the personal digital assistant captures the user's fingerprint data.

If the biometric authentication functionality utilizing facial recognition is selected, the personal digital assistant captures the user's facial features.

If the password based authentication functionality is selected, the personal digital assistant captures the user password input.

If the cryptographic key based authentication functionality selected, the personal digital assistant employs a cryptographic key typically stored in its memory.

FIG. 15B illustrates methods for obtaining authentication information suitable for a wireless smart card. As seen in FIG. 15B depending on the facilities available in or in association with the wireless smart card, one of the following authentication functionalities which require obtaining authentication information may be selected:

cryptographic key based.

If the cryptographic key based authentication functionality selected, the wireless smart card employs a cryptographic key typically stored in its memory.

FIG. 15C illustrates methods for obtaining authentication information suitable for a cellular phone. As seen in FIG. 15C depending on the facilities available in or in association with the cellular phone, one of the following authentication functionalities which require obtaining authentication information may be selected:

biometric utilizing fingerprint recognition;

biometric utilizing facial recognition;

password based; and

cryptographic key based.

If the biometric authentication functionality utilizing fingerprint recognition is selected, the cellular phone captures the user's fingerprint data.

If the biometric authentication functionality utilizing facial recognition is selected, the cellular phone captures the user's facial features.

If the password based authentication functionality is selected, the cellular phone captures the user password input.

If the cryptographic key based authentication functionality selected, the cellular phone employs a cryptographic key typically stored in its memory.

FIG. 15D illustrates methods for obtaining authentication information suitable for an electronic wallet. As seen in FIG. 15D depending on the facilities available in or in association with the electronic wallet, one of the following authentication functionalities which require obtaining authentication information may be selected:

cryptographic key based.

If the cryptographic key based authentication functionality selected, the electronic wallet employs a cryptographic key typically stored in its memory.

FIG. 15E illustrates methods for obtaining authentication information suitable for a PC. As seen in FIG. 15E depending on the facilities available in or in association with the PC, one of the following authentication functionalities which require obtaining authentication information may be selected:

biometric utilizing fingerprint recognition;

biometric utilizing facial recognition;

password based;

cryptographic utilizing a memory based key;

cryptographic utilizing a USB toke n based key;

cryptographic utilizing a smart card based key; and

cryptographic utilizing a diskette based key.

If the biometric authentication functionality utilizing fingerprint recognition is selected, the PC captures the user's fingerprint data.

If the biometric authentication functionality utilizing facial recognition is selected, the PC captures the user's facial features.

If the password based authentication functionality is selected, the PC captures the user password input.

If the cryptographic memory based key authentication functionality is selected, the PC employs a cryptographic key typically stored in its memory.

If the cryptographic USB token based key authentication functionality is selected, the PC employs a cryptographic key typically stored in the associated USB key.

If the cryptographic smart card based key authentication functionality is selected, the PC employs a cryptographic key typically stored in the associated smart card.

If the cryptographic diskette based key authentication functionality is selected, the PC employs a cryptographic key typically stored in the associated key diskette.

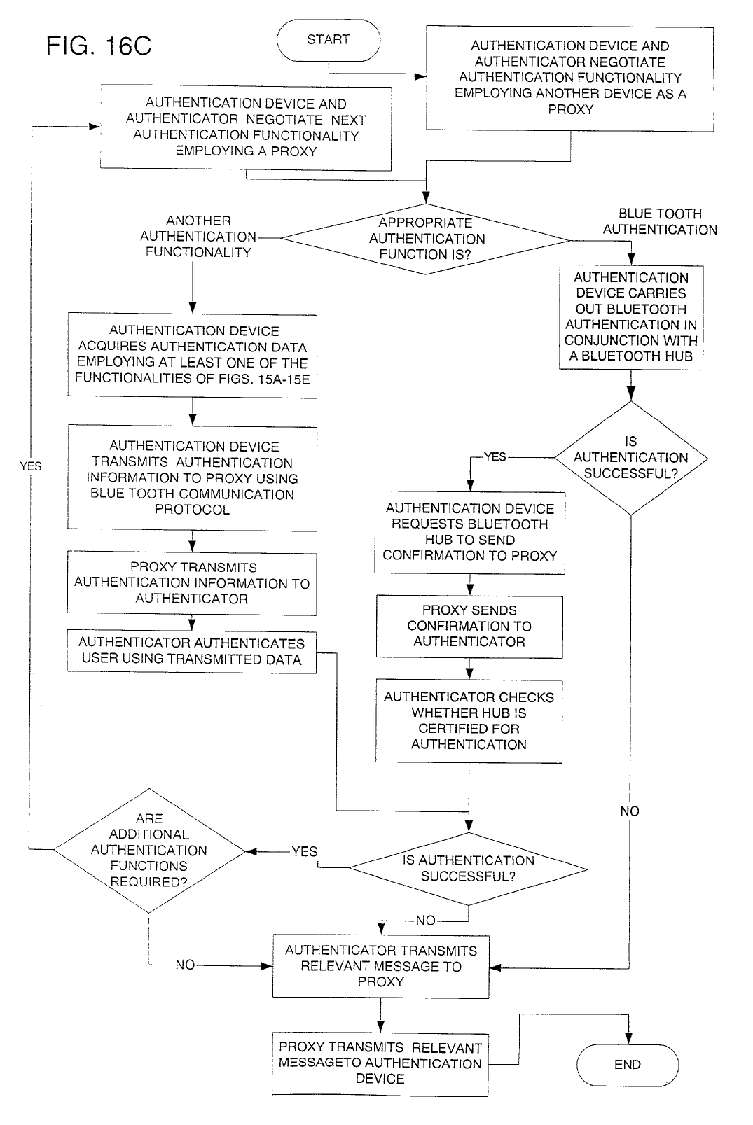

Reference is now made to FIGS. 16A, 16B and 16C, which are simplified flow charts of different multi-tier and non multi-tier authentication using different communication modes between an authenticating device and an authenticator.

FIG. 16A illustrates a non multi-tier authentication using a direct communication mode between an authenticating device and an authenticator. As seen in FIG. 16A, an authentication device such as a personal digital assistant, a wireless smart card, a cellular phone, an electronic wallet or a PC negotiates with an authenticator an authentication functionality. Depending on the facilities available in or in association with the authentication device, either a Bluetooth based authentication functionality or non-Bluetooth based authentication functionality may be used.

If a non-Bluetooth authentication is selected, the authentication device obtains authentication information employing at least one of the functionalities of FIGS. 15A-15E. The authentication device than communicates authentication information to the authenticator using at least partially the Bluetooth communication protocol. In response to receipt of such information, the authenticator may authenticate the user.

If the Bluetooth authentication functionality is selected, the authentication device carries out Bluetooth authentication in conjunction with a Bluetooth hub. If the authentication is successful, the authentication device requests that the Bluetooth hub send an authentication confirmation to the authenticator. In response to receipt of the confirmation, the authenticator determines whether the hub, which sent the confirmation, is certified to do so.

If authentication of the user and/or device is successful, indicating that the user and/or device is authorized, a determination is made as to whether additional authentication functions are required. If so, the authentication device and the authenticator negotiate the next authentication functionality and proceed as described hereinabove. If no additional authentication functions are required, the authenticator transmits an authentication confirmation to the authentication device.

If authentication of the user and/or device is not successful at any stage, indicating that the user and/or device is not authorized, the authenticator transmits a non-authentication message to the authentication device.

FIG. 16B illustrates a multi-tier authentication in which an authentication device and an authenticator employ a second device for communication. As seen in FIG. 16B an authentication device such as a personal digital assistant, a wireless smart card, a cellular phone, an electronic wallet or a PC negotiates with an authenticator an authentication functionality communicating through said second device, which may be a personal digital assistant, a cellular phone or a PC. Depending on the facilities available in or in association with the authentication device, either a Bluetooth based authentication functionality or non-Bluetooth based authentication functionality may be used.

If a non-Bluetooth authentication is selected, the authentication device obtains authentication information employing at least one of the functionalities of FIGS. 15A-15E. The authentication device than communicates authentication information to the authenticator using at least partially the Bluetooth communication protocol and communicating through said second device. In response to receipt of such information, the authenticator may authenticate the user.

If the Bluetooth authentication functionality is selected, the authentication device carries out Bluetooth authentication in conjunction with a Bluetooth hub. If the authentication is successful, the authentication device requests that the Bluetooth hub send an authentication confirmation to the authenticator communicating through said second device. In response to receipt of the confirmation, the authenticator determines whether the hub, which sent the confirmation, is certified to do so.

If authentication of the user and/or device is successful, indicating that the user and/or device is authorized, a determination is made as to whether additional authentication functions are required. If so, the authentication device and the authenticator negotiate the next authentication functionality communicating through said second device and proceed as described hereinabove. If no additional authentication functions are required, the authenticator transmits an authentication confirmation to the authentication device communicating through said second device.

If authentication of the user and/or device is not successful at any stage, indicating that the user and/or device is not authorized, the authenticator transmits a non-authentication message to the authentication device communicating through said second device.

FIG. 16C illustrates a multi-tier authentication in which an authentication device employ a proxy to communicate with an authenticator. As seen in FIG. 16C an authentication device such as a personal digital assistant, a wireless smart card, a cellular phone, an electronic wallet or a PC negotiates with an authenticator an authentication functionality, said negotiation employing a proxy, which may be a personal digital assistant, a cellular phone or a PC, to communicate with the authenticator. Depending on the facilities available in or in association with the authentication device, either a Bluetooth based authentication functionality or non-Bluetooth based authentication functionality may be used.

If a non-Bluetooth authentication is selected, the authentication device obtains authentication information employing at least one of the functionalities of FIGS. 15A-15E. The authentication device transmits authentication information to the proxy. The proxy then transmits the data to the authenticator. One or more of the transmissions use at least partially the Bluetooth communication protocol. In response to receipt of such information, the authenticator may authenticate the user.

If the Bluetooth authentication functionality is selected, the authentication device carries out Bluetooth authentication in conjunction with a Bluetooth hub. If the authentication is successful, the authentication device requests that the Bluetooth hub send an authentication confirmation to the proxy. The proxy then sends the confirmation to the authenticator. In response to receipt of the confirmation, the authenticator determines whether the hub, which sent the confirmation, is certified to do so.

If authentication of the user and/or device is successful, indicating that the user and/or device is authorized, a determination is made as to whether additional authentication functions are required. If so, the authentication device and the authenticator negotiate the next authentication functionality, said negotiation employing a proxy, and proceed as described hereinabove. If no additional authentication functions are required, the authenticator transmits an authentication confirmation to the proxy. The proxy then transmits the confirmation to the authentication device.

If authentication of the user and/or device is not successful at any stage, indicating that the user and/or device is not authorized, the authenticator transmits a non-authentication message to the proxy. The proxy then transmits the non-authentication message to the authentication device.

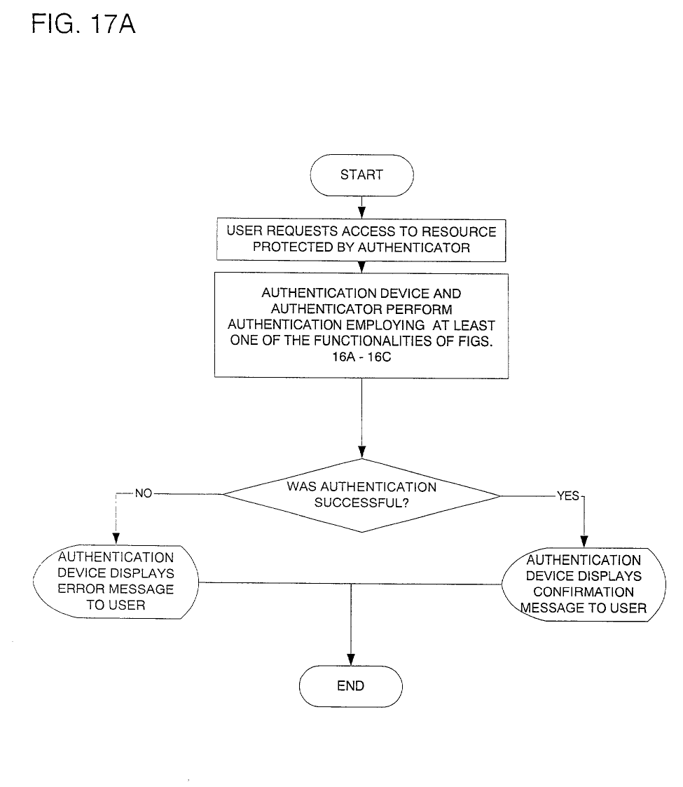

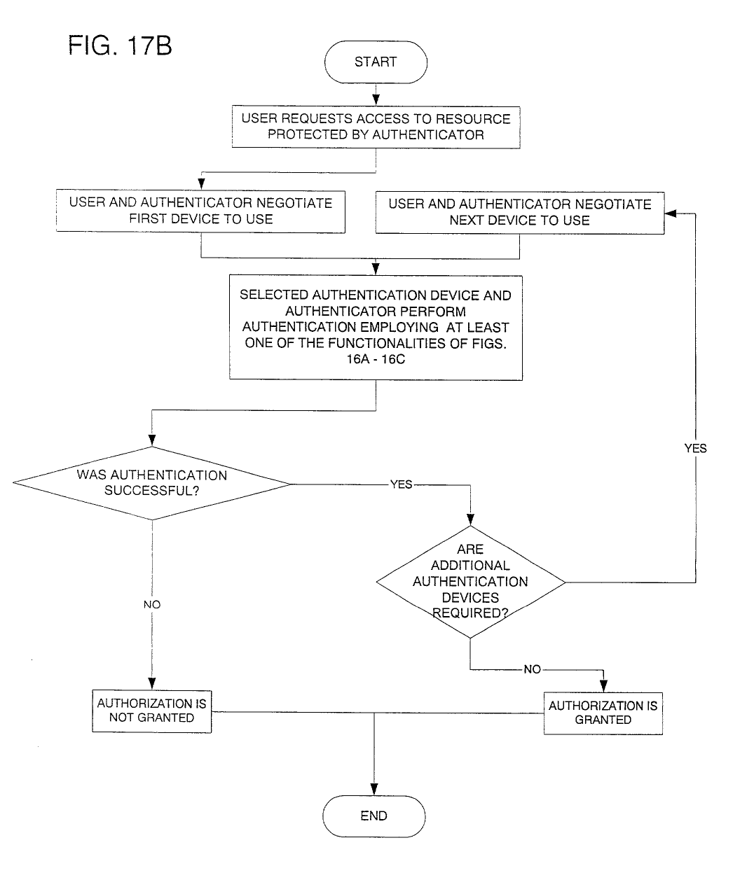

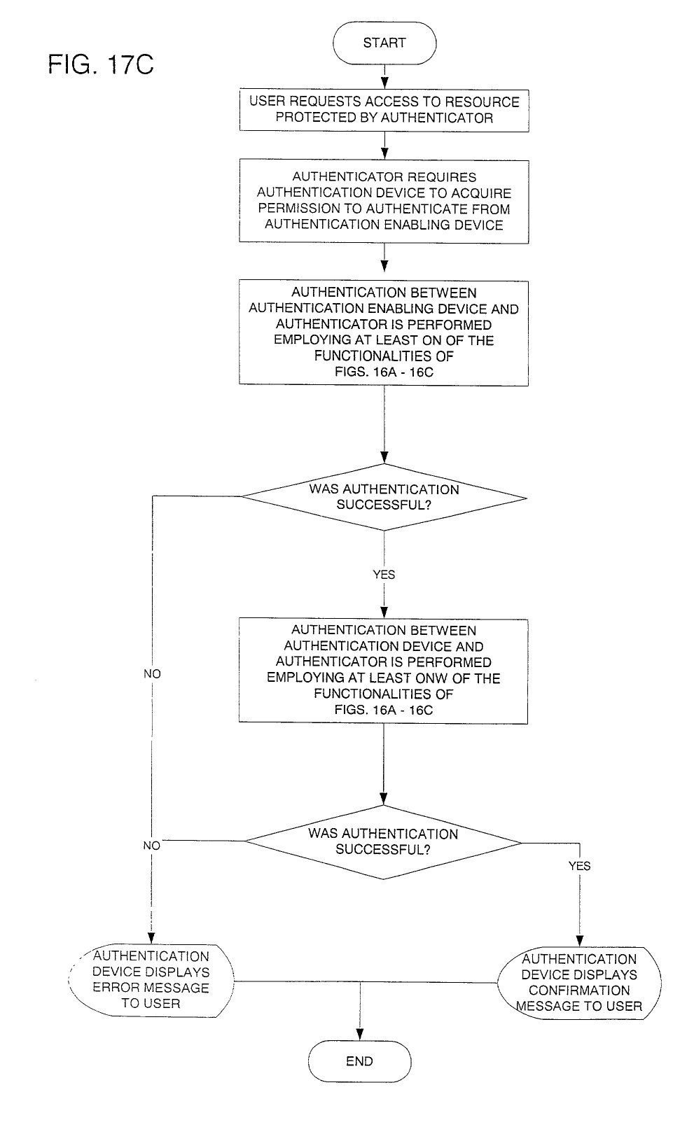

Reference is now made to FIGS. 17A, 17B and 17C, which are simplified flow charts of different multi-tier and non multi-tier authentication employing different combinations of authentication devices.

FIG. 17A illustrates a non multi-tier authentication employing a single authentication device. As seen in FIG. 17A, a user who requests access to a resource protected by an authenticator may employ an authentication device. The authentication device may employ any one of the functionalities of FIGS. 16A-16C to perform authentication with the authenticator. When the authentication device receives a confirmation message or a non-authentication message, the authentication device displays a suitable message to the user.

FIG. 17B illustrates a non multi-tier authentication employing multiple authentication devices. As seen in FIG. 17B, a user who requests access to a resource protected by an authenticator negotiates with said authenticator an authentication device. The authentication device may employ any one of the functionalities of FIGS. 16A-16C to perform authentication with the authenticator.

If authentication of the user and/or device is successful, indicating that the user and/or device is authorized, a determination is made as to whether additional authentication devices are required. If so, the user and the authenticator negotiate the next authentication device and proceed as described hereinabove. If no additional authentication devices are required, an authentication is granted.

If authentication of the user and/or device is not successful at any stage, authentication is not granted.

FIG. 17C illustrates a multi-tier authentication employing an enabling device. As seen in FIG. 17C, a user who requests access to a resource protected by an authenticator may employ an authentication device. The authenticator may require the authentication device to be enabled for authentication by an enabling device. The enabling device may employ any one of the functionalities of FIGS. 16A-16C to perform authentication with the authenticator.

If the enabling device is successfully authenticated, the authentication device may employ any one of the functionalities of FIGS. 16A-16C to perform authentication with the authenticator. When the authentication device receives a confirmation message or a non-authentication message, the authentication device displays a suitable message to the user.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A device capable of communicating with a communication network via a Bluetooth communication protocol, said device including at least one authentication functionality, at least part of at least one of which is operative to communicate authentication information via said Bluetooth communication protocol.

2. A device according to claim 1 and wherein said device is effective to identify at least one of said device, another device and a user of said device or of said another device to at least one authenticator coupled to said communication network.

3. A device according to claim 1 and wherein said device is effective to identify said device to an authenticator coupled to said communication network.

4. A device according to claim 1 and wherein said device is effective to identify another device to an authenticator coupled to said communication network.

5. A device according to claim 1 and wherein said device is effective to identify a user to an authenticator coupled to said communication network.

6. A device according to claim 1 and wherein said device is a dedicated authentication device.

7. A device according to claim 6 and wherein said device is effective to identify at least one of said device, another device and a user of said device or of said another device to at least one authenticator coupled to said communication network.

8. A device according to claim 1 and wherein said device includes substantial non-authentication functionality.

9. A device according to claim 8 and wherein said device is effective to identify at least one of said device, another device and a user of said device or of said another device to at least one authenticator coupled to said communication network.

10. A device according to claim 8 and wherein said device comprises a telephone.

11. A device according to claim 8 and wherein said device comprises a PDA.

12. A device according to claim 8 and wherein said device comprises a computer.

13. A device according to claim 8 and wherein said device comprises an electronic wallet.

14. A device according to claim 1 and wherein said at least one authentication functionality comprises plural authentication functionalities.

15. A device according to claim 14 and wherein said device is effective to identify at least one of said device, another device and a user of said device or of said another device to at least one authenticator coupled to said communication network.

16. A device according to claim 14 and wherein said device is a dedicated authentication device.

17. A device according to claim 14 and wherein said device includes substantial non-authentication functionality.

18. A device according to claim 1 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

19. A device according to claim 1 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

20. A device according to claim 1 and wherein at least part of said at least one authentication functionality forms part of said Bluetooth communication protocol.

21. A device according to claim 20 and wherein said device is effective to identify at least one of said device, another device and a user of said device or of said another device to at least one authenticator coupled to said communication network.

22. A device according to claim 20 and wherein said device is a dedicated authentication device.

23. A device according to claim 20 and wherein said device includes substantial non-authentication functionality.

24. A device according to claim 20 and wherein said at least one authentication functionality comprises plural authentication functionalities.

25. A device according to claim 24 and wherein said device is effective to identify at least one of said device, another device and a user of said device or of said another device to at least one authenticator coupled to said communication network.

26. A device according to claim 24 and wherein said device is a dedicated authentication device.

27. A device according to claim 24 and wherein said device includes substantial non-authentication functionality.

28. A device according to claim 1 and wherein at least part of said at least one functionality employs a Bluetooth communication protocol.

29. A device according to claim 28 and wherein said device is effective to identify at least one of said device, another device and a user of said device or of said another device to at least one authenticator coupled to said communication network.

30. A device according to claim 28 and wherein said device is a dedicated authentication device.

31. A device according to claim 28 and wherein said device includes substantial non-authentication functionality.

32. A device according to claim 28 and wherein said at least one authentication functionality comprises plural authentication functionalities.

33. A device according to claim 32 and wherein said device is effective to identify at least one of said device, another device and a user of said device or of said another device to at least one authenticator coupled to said communication network.

34. A device according to claim 32 and wherein said device is a dedicated authentication device.

35. A device according to claim 32 and wherein said device includes substantial non-authentication functionality.

36. A device according to claim 28 and wherein at least part of said at least one authentication functionality forms part of said Bluetooth communication protocol.

37. A device according to claim 36 and wherein said device is effective to identify at least one of said device, another device and a user of said device or of said another device to at least one authenticator coupled to said communication network.

38. A device according to claim 36 and wherein said device is a dedicated authentication device.

39. A device according to claim 36 and wherein said device includes substantial non-authentication functionality.

40. A device according to claim 36 and wherein said at least one authentication functionality comprises plural authentication functionalities.

41. A device according to claim 40 and wherein said device is effective to identify at least one of said device, another device and a user of said device or of said another device to at least one authenticator coupled to said communication network.

42. A device according to claim 40 and wherein said device is a dedicated authentication device.

43. A device according to claim 40 and wherein said device includes substantial non-authentication functionality.

44. A device capable of communicating with a communication network via a Bluetooth communication protocol, said device including at least one authentication functionality at least part of at least one of which forms part of said Bluetooth communication protocol.

45. A device according to claim 44 and wherein said device is effective to identify at least one of said device, another device and a user of said device or of said another device to at least one authenticator coupled to said communication network.

46. A device according to claim 44 and wherein said device is effective to identify said device to an authenticator coupled to said communication network.

47. A device according to claim 44 and wherein said device is effective to identify another device to an authenticator coupled to said communication network.

48. A device according to claim 44 and wherein said device is effective to identify a user to an authenticator coupled to said communication network.

49. A device according to claim 44 and wherein said device is a dedicated authentication device.

50. A device according to claim 49 and wherein said device is effective to identify at least one of said device, another device and a user of said device or of said another device to at least one authenticator coupled to said communication network.

51. A device according to claim 44 and wherein said device includes substantial non-authentication functionality.

52. A device according to claim 51 and wherein said device is effective to identify at least one of said device, another device and a user of said device or of said another device to at least one authenticator coupled to said communication network.

53. A device according to claim 51 and wherein said device comprises a telephone.

54. A device according to claim 51 and wherein said device comprises a PDA.

55. A device according to claim 51 and wherein said device comprises a computer.

56. A device according to claim 51 and wherein said device comprises an electronic wallet.

57. A device according to claim 44 and wherein said at least one authentication functionality comprises plural authentication functionalities.

58. A device according to claim 57 and wherein said device is effective to identify at least one of said device, another device and a user of said device or of said another device to at least one authenticator coupled to said communication network.

59. A device according to claim 57 and wherein said device is a dedicated authentication device.

60. A device according to claim 57 and wherein said device includes substantial non-authentication functionality.

61. A device according to claim 44 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

62. A device according to claim 44 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

63. A device according to claim 44 and wherein at least part of said at least one functionality employs a Bluetooth communication protocol.

64. A device according to claim 63 and wherein said device is effective to identify at least one of said device, another device and a user of said device or of said another device to at least one authenticator coupled to said communication network.

65. A device according to claim 63 and wherein said device is a dedicated authentication device.

66. A device according to claim 63 and wherein said device includes substantial non-authentication functionality.

67. A device according to claim 63 and wherein said at least one authentication functionality comprises plural authentication functionalities.

68. A device according to claim 67 and wherein said device is effective to identify at least one of said device, another device and a user of said device or of said another device to at least one authenticator coupled to said communication network.

69. A device according to claim 67 and wherein said device is a dedicated authentication device.

70. A device according to claim 67 and wherein said device includes substantial non-authentication functionality.

71. A device capable of communicating with a communication network, said device comprising at least one authentication functionality at least part of at least one of which employs a Bluetooth communication protocol.

72. A device according to claim 71 and wherein said device is effective to identify at least one of said device, another device and a user of said device or of said another device to at least one authenticator coupled to said communication network.

73. A device according to claim 71 and wherein said device is effective to identify said device to an authenticator coupled to said communication network.

74. A device according to claim 71 and wherein said device is effective to identify another device to an authenticator coupled to said communication network.

75. A device according to claim 71 and wherein said device is effective to identify a user to an authenticator coupled to said communication network.

76. A device according to claim 71 and wherein said device is a dedicated authentication device.

77. A device according to claim 76 and wherein said device is effective to identify at least one of said device, another device and a user of said device or of said another device to at least one authenticator coupled to said communication network.

78. A device according to claim 71 and wherein said device includes substantial non-authentication functionality.

79. A device according to claim 78 and wherein said device is effective to identify at least one of said device, another device and a user of said device or of said another device to at least one authenticator coupled to said communication network.

80. A device according to claim 78 and wherein said device comprises a telephone.

81. A device according to claim 78 and wherein said device comprises a PDA.

82. A device according to claim 78 and wherein said device comprises a computer.

83. A device according to claim 78 and wherein said device comprises an electronic wallet.

84. A device according to claim 71 and wherein said at least one authentication functionality comprises plural authentication functionalities.

85. A device according to claim 84 and wherein said device is effective to identify at least one of said device, another device and a user of said device or of said another device to at least one authenticator coupled to said communication network.

86. A device according to claim 84 and wherein said device is a dedicated authentication device.

87. A device according to claim 84 and wherein said device includes substantial non-authentication functionality.

88. A device according to claim 71 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

89. A device according to claim 71 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

90. A device according to claim 71 and wherein at least part of said at least one authentication functionality forms part of said Bluetooth communication protocol.

91. A device according to claim 90 and wherein said device is effective to identify at least one of said device, another device and a user of said device or of said another device to at least one authenticator coupled to said communication network.

92. A device according to claim 90 and wherein said device is a dedicated authentication device.

93. A device according to claim 90 and wherein said device includes substantial non-authentication functionality.

94. A device according to claim 90 and wherein said at least one authentication functionality comprises plural authentication functionalities.

95. A device according to claim 94 and wherein said device is effective to identify at least one of said device, another device and a user of said device or of said another device to at least one authenticator coupled to said communication network.

96. A device according to claim 94 and wherein said device is a dedicated authentication device.

97. A device according to claim 94 and wherein said device includes substantial non-authentication functionality.

98. A method for communicating with a communication network via a Bluetooth communication protocol, said method comprising:
at least one authentication functionality, at least part of at least one of which is operative to communicate authentication information via said Bluetooth communication protocol.

99. A method according to claim 98 and wherein said method is effective to identify at least one of a device and a user to at least one authenticator coupled to said communication network.

100. A method according to claim 98 and wherein said method is effective to identify a device to an authenticator coupled to said communication network.

101. A method according to claim 98 and wherein said method is effective to identify a user to an authenticator coupled to said communication network.

102. A method according to claim 98 and wherein said at least one authentication functionality comprises plural authentication functionalities.

103. A method according to claim 102 and wherein said method is effective to identify at least one of a device, and a user to at least one authenticator coupled to said communication network.

104. A method according to claim 98 and wherein said at least one authentication functionality is selected from the following authentication functionalities:
a cryptographic based authentication functionality;
a password based authentication functionality;
a smartcard based authentication functionality;
a token based authentication functionality; and
a biometric based authentication functionality.

105. A method according to claim 98 and wherein said at least one authentication functionality includes at least a plurality of the following authentication functionalities:
a cryptographic based authentication functionality;
a password based authentication functionality;
a smartcard based authentication functionality;
a token based authentication functionality; and
a biometric based authentication functionality.

106. A method according to claim 98 and wherein at least part of said at least one authentication functionality forms part of said Bluetooth communication protocol.

107. A method according to claim 106 and wherein said method is effective to identify at least one of a device and a user to at least one authenticator coupled to said communication network.

108. A method according to claim 106 and wherein said at least one authentication functionality comprises plural authentication functionalities.

109. A method according to claim 108 and wherein said method is effective to identify at least one of a device, and a user to at least one authenticator coupled to said communication network.

110. A method according to claim 98 and wherein at least part of said at least one functionality employs a Bluetooth communication protocol.

111. A method according to claim 110 and wherein said method is effective to identify at least one of a device and a user to at least one authenticator coupled to said communication network.

112. A method according to claim 110 and wherein said at least one authentication functionality comprises plural authentication functionalities.

113. A method according to claim 112 and wherein said method is effective to identify at least one of a device, and a user to at least one authenticator coupled to said communication network.

114. A method according to claim 110 and wherein at least part of said at least one authentication functionality forms part of said Bluetooth communication protocol.

115. A method according to claim 114 and wherein said method is effective to identify at least one of a device and a user to at least one authenticator coupled to said communication network.

116. A method according to claim 114 and wherein said at least one authentication functionality comprises plural authentication functionalities.

117. A method according to claim 116 and wherein said method is effective to identify at least one of a device, and a user to at least one authenticator coupled to said communication network.

118. A method for communicating with a communication network via a Bluetooth communication protocol, said method comprising:
at least one authentication functionality at least part of at least one of which forms part of said Bluetooth communication protocol.

119. A method according to claim 118 and wherein said method is effective to identify at least one of a device and a user to at least one authenticator coupled to said communication network.

120. A method according to claim 118 and wherein said method is effective to identify a device to an authenticator coupled to said communication network.

121. A method according to claim 118 and wherein said method is effective to identify a user to an authenticator coupled to said communication network.

122. A method according to claim 118 and wherein said at least one authentication functionality comprises plural authentication functionalities.

123. A method according to claim 122 and wherein said method is effective to identify at least one of a device, and a user to at least one authenticator coupled to said communication network.

124. A method according to claim 118 and wherein said at least one authentication functionality is selected from the following authentication functionalities:
a cryptographic based authentication functionality;
a password based authentication functionality;
a smartcard based authentication functionality;
a token based authentication functionality; and
a biometric based authentication functionality.

125. A method according to claim 118 and wherein said at least one authentication functionality includes at least a plurality of the following authentication functionalities:
a cryptographic based authentication functionality;
a password based authentication functionality;
a smartcard based authentication functionality;
a token based authentication functionality; and
a biometric based authentication functionality.

126. A method according to claim 118 and wherein at least part of said at least one functionality employs a Bluetooth communication protocol.

127. A method according to claim 126 and wherein said method is effective to identify at least one of a device and a user to at least one authenticator coupled to said communication network.

128. A method according to claim 126 and wherein said at least one authentication functionality comprises plural authentication functionalities.

129. A method according to claim 128 and wherein said method is effective to identify at least one of a device, and a user to at least one authenticator coupled to said communication network.

130. A method for communicating with a communication network via a Bluetooth communication protocol, said method comprising:
at least one authentication functionality at least part of at least one of which employs a Bluetooth communication protocol.

131. A method according to claim 130 and wherein said method is effective to identify at least one of a device and a user to at least one authenticator coupled to said communication network.

132. A method according to claim 130 and wherein said method is effective to identify a device to an authenticator coupled to said communication network.

133. A method according to claim 130 and wherein said method is effective to identify a user to an authenticator coupled to said communication network.

134. A method according to claim 130 and wherein said at least one authentication functionality comprises plural authentication functionalities.

135. A method according to claim 134 and wherein said method is effective to identify at least one of a device, and a user to at least one authenticator coupled to said communication network.

136. A method according to claim 130 and wherein said at least one authentication functionality is selected from the following authentication functionalities:
a cryptographic based authentication functionality;
a password based authentication functionality;
a smartcard based authentication functionality;
a token based authentication functionality; and
a biometric based authentication functionality.

137. A method according to claim 130 and wherein said at least one authentication functionality includes at least a plurality of the following authentication functionalities:
a cryptographic based authentication functionality;
a password based authentication functionality;
a smartcard based authentication functionality;
a token based authentication functionality; and
a biometric based authentication functionality.

137. A method according to claim 130 and wherein at least part of said at least one authentication functionality forms part of said Bluetooth communication protocol.

138. A method according to claim 137 and wherein said method is effective to identify at least one of a device and a user to at least one authenticator coupled to said communication network.

139. A method according to claim 137 and wherein said at least one authentication functionality comprises plural authentication functionalities.

140. A method according to claim 139 and wherein said method is effective to identify at least one of a device, and a user to at least one authenticator coupled to said communication network.

141. A system comprising:
a communication network;
at least one authenticator; and
at least one device capable of communicating with said at least one authenticator through said communication network via a Bluetooth communication protocol, said at least one device including at least one authentication functionality, at least part of at least one of which is operative to communicate authentication information via said Bluetooth communication protocol to said at least one authenticator.

142. A system according to claim 141 and wherein said at least one device is effective to identify at least one of said device, another device and a user of said device or of said another device to at least one authenticator coupled to said communication network.

143. A system according to claim 141 and wherein said at least one device is effective to identify said device to an authenticator coupled to said communication network.

144. A system according to claim 141 and wherein said at least one device is effective to identify another device to an authenticator coupled to said communication network.

145. A system according to claim 141 and wherein said at least one device is effective to identify a user to an authenticator coupled to said communication network.

146. A system according to claim 141 and wherein said at least one device is a dedicated authentication device.

147. A system according to claim 146 and wherein said at least one device is effective to identify at least one of said device, another device and a user of said device or of said another device to at least one authenticator coupled to said communication network.

148. A system according to claim 141 and wherein said at least one device includes substantial non-authentication functionality.

149. A system according to claim 148 and wherein said at least one device is effective to identify at least one of said device, another device and a user of said device or of said another device to at least one authenticator coupled to said communication network.

150. A system according to claim 148 and wherein said at least one device comprises a telephone.

151. A system according to claim 148 and wherein said at least one device comprises a PDA.

152. A system according to claim 148 and wherein said at least one device comprises a computer.

153. A system according to claim 148 and wherein said at least one device comprises an electronic wallet.

154. A system according to claim 141 and wherein said at least one authentication functionality comprises plural authentication functionalities.

155. A system according to claim 154 and wherein said at least one device is effective to identify at least one of said device, another device and a user of said device or of said another device to at least one authenticator coupled to said communication network.

156. A system according to claim 154 and wherein said at least one device is a dedicated authentication device.

157. A system according to claim 154 and wherein said at least one device includes substantial non-authentication functionality.

158. A system according to claim 141 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

159. A system according to claim 141 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

160. A system according to claim 141 and wherein at least part of said at least one authentication functionality forms part of said Bluetooth communication protocol.

161. A system according to claim 160 and wherein said at least one device is effective to identify at least one of said device, another device and a user of said device or of said another device to at least one authenticator coupled to said communication network.

162. A system according to claim 160 and wherein said at least one device is a dedicated authentication device.

163. A system according to claim 160 and wherein said at least one device includes substantial non-authentication functionality.

164. A system according to claim 160 and wherein said at least one authentication functionality comprises plural authentication functionalities.

165. A system according to claim 164 and wherein said at least one device is effective to identify at least one of said device, another device and a user of said device or of said another device to at least one authenticator coupled to said communication network.

166. A system according to claim 164 and wherein said at least one device is a dedicated authentication device.

167. A system according to claim 164 and wherein said at least one device includes substantial non-authentication functionality.

168. A system according to claim 141 and wherein at least part of said at least one functionality employs a Bluetooth communication protocol.

169. A system according to claim 168 and wherein said at least one device is effective to identify at least one of said device, another device and a user of said device or of said another device to at least one authenticator coupled to said communication network.

170. A system according to claim 168 and wherein said at least one device is a dedicated authentication device.

171. A system according to claim 168 and wherein said at least one device includes substantial non-authentication functionality.

172. A system according to claim 168 and wherein said at least one authentication functionality comprises plural authentication functionalities.

173. A system according to claim 172 and wherein said at least one device is effective to identify at least one of said device, another device and a user of said device or of said another device to at least one authenticator coupled to said communication network.

174. A system according to claim 172 and wherein said at least one device is a dedicated authentication device.

175. A system according to claim 172 and wherein said at least one device includes substantial non-authentication functionality.

176. A system according to claim 168 and wherein at least part of said at least one authentication functionality forms part of said Bluetooth communication protocol.

177. A system according to claim 176 and wherein said at least one device is effective to identify at least one of said device, another device and a user of said device or of said another device to at least one authenticator coupled to said communication network.

178. A system according to claim 176 and wherein said at least one device is a dedicated authentication device.

179. A system according to claim 176 and wherein said at least one device includes substantial non-authentication functionality.

180. A system according to claim 176 and wherein said at least one authentication functionality comprises plural authentication functionalities.

181. A system according to claim 180 and wherein said at least one device is effective to identify at least one of said device, another device and a user of said device or of said another device to at least one authenticator coupled to said communication network.

182. A system according to claim 180 and wherein said at least one device is a dedicated authentication device.

183. A system according to claim 180 and wherein said at least one device includes substantial non-authentication functionality.

184. A system comprising:
a communication network;
at least one authenticator; and
at least one device capable of communicating with a communication network via a Bluetooth communication protocol, said device including at least one authentication functionality at least part of at least one of which forms part of said Bluetooth communication protocol.

185. A system according to claim 184 and wherein said at least one device is effective to identify at least one of said device, another device and a user of said device or of said another device to at least one authenticator coupled to said communication network.

186. A system according to claim 184 and wherein said at least one device is effective to identify said device to an authenticator coupled to said communication network.

187. A system according to claim 184 and wherein said at least one device is effective to identify another device to an authenticator coupled to said communication network.

188. A system according to claim 184 and wherein said at least one device is effective to identify a user to an authenticator coupled to said communication network.

189. A system according to claim 184 and wherein said at least one device is a dedicated authentication device.

190. A system according to claim 189 and wherein said at least one device is effective to identify at least one of said device, another device and a user of said device or of said another device to at least one authenticator coupled to said communication network.

191. A system according to claim 184 and wherein said at least one device includes substantial non-authentication functionality.

192. A system according to claim 191 and wherein said at least one device is effective to identify at least one of said device, another device and a user of said device or of said another device to at least one authenticator coupled to said communication network.

193. A system according to claim 191 and wherein said at least one device comprises a telephone.

194. A system according to claim 191 and wherein said at least one device comprises a PDA.

195. A system according to claim 191 and wherein said at least one device comprises a computer.

196. A system according to claim 191 and wherein said at least one device comprises an electronic wallet.

197. A system according to claim 184 and wherein said at least one authentication functionality comprises plural authentication functionalities.

198. A system according to claim 197 and wherein said at least one device is effective to identify at least one of said device, another device and a user of said device or of said another device to at least one authenticator coupled to said communication network.

199. A system according to claim 197 and wherein said at least one device is a dedicated authentication device.

200. A system according to claim 197 and wherein said at least one device includes substantial non-authentication functionality.

201. A system according to claim 184 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

202. A system according to claim 184 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

203. A system according to claim 184 and wherein at least part of said at least one functionality employs a Bluetooth communication protocol.

204. A system according to claim 203 and wherein said at least one device is effective to identify at least one of said device, another device and a user of said device or of said another device to at least one authenticator coupled to said communication network.

205. A system according to claim 203 and wherein said at least one device is a dedicated authentication device.

206. A system according to claim 203 and wherein said at least one device includes substantial non-authentication functionality.

207. A system according to claim 203 and wherein said at least one authentication functionality comprises plural authentication functionalities.

208. A system according to claim 207 and wherein said at least one device is effective to identify at least one of said device, another device and a user of said device or of said another device to at least one authenticator coupled to said communication network.

209. A system according to claim 207 and wherein said at least one device is a dedicated authentication device.

210. A system according to claim 207 and wherein said at least one device includes substantial non-authentication functionality.

211. A system comprising:
a communication network;
at least one authenticator; and
at least one device capable of communicating with a communication network, said device comprising at least one authentication functionality at least part of at least one of which employs a Bluetooth communication protocol.

212. A system according to claim 211 and wherein said at least one device is effective to identify at least one of said device, another device and a user of said device or of said another device to at least one authenticator coupled to said communication network.

213. A system according to claim 211 and wherein said at least one device is effective to identify said device to an authenticator coupled to said communication network.

214. A system according to claim 211 and wherein said at least one device is effective to identify another device to an authenticator coupled to said communication network.

215. A system according to claim 211 and wherein said at least one device is effective to identify a user to an authenticator coupled to said communication network.

216. A system according to claim 211 and wherein said at least one device is a dedicated authentication device.

217. A system according to claim 216 and wherein said at least one device is effective to identify at least one of said device, another device and a user of said device or of said another device to at least one authenticator coupled to said communication network.

218. A system according to claim 211 and wherein said at least one device includes substantial non-authentication functionality.

219. A system according to claim 218 and wherein said at least one device is effective to identify at least one of said device, another device and a user of said device or of said another device to at least one authenticator coupled to said communication network.

220. A system according to claim 218 and wherein said at least one device comprises a telephone.

221. A system according to claim 218 and wherein said at least one device comprises a PDA.

222. A system according to claim 218 and wherein said at least one device comprises a computer.

223. A system according to claim 218 and wherein said at least one device comprises an electronic wallet.

224. A system according to claim 211 and wherein said at least one authentication functionality comprises plural authentication functionalities.

225. A system according to claim 224 and wherein said at least one device is effective to identify at least one of said device, another device and a user of said device or of said another device to at least one authenticator coupled to said communication network.

226. A system according to claim 224 and wherein said at least one device is a dedicated authentication device.

227. A system according to claim 224 and wherein said at least one device includes substantial non-authentication functionality.

228. A system according to claim 211 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

229. A system according to claim 211 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

230. A system according to claim 211 and wherein at least part of said at least one authentication functionality forms part of said Bluetooth communication protocol.

231. A system according to claim 230 and wherein said at least one device is effective to identify at least one of said device, another device and a user of said device or of said another device to at least one authenticator coupled to said communication network.

232. A system according to claim 230 and wherein said at least one device is a dedicated authentication device.

233. A system according to claim 230 and wherein said at least one device includes substantial non-authentication functionality.

234. A system according to claim 230 and wherein said at least one authentication functionality comprises plural authentication functionalities.

235. A system according to claim 234 and wherein said at least one device is effective to identify at least one of said device, another device and a user of said device or of said another device to at least one authenticator coupled to said communication network.

236. A system according to claim 234 and wherein said at least one device is a dedicated authentication device.

237. A system according to claim 234 and wherein said at least one device includes substantial non-authentication functionality.

238. A system comprising:
at least one authenticator; and
at least one device capable of communicating with said at least one authenticator via a Bluetooth communication protocol, said at least one device including at least one authentication functionality, at least part of at least one of which is operative to communicate authentication information via said Bluetooth communication protocol to said at least one authenticator.

239. A system according to claim 238 and wherein said at least one device is effective to identify at least one of said device, another device and a user of said device or of said another device to at least one authenticator coupled to said communication network.

240. A system according to claim 238 and wherein said at least one device is effective to identify said device to an authenticator coupled to said communication network.

241. A system according to claim 238 and wherein said at least one device is effective to identify another device to an authenticator coupled to said communication network.

242. A system according to claim 238 and wherein said at least one device is effective to identify a user to an authenticator coupled to said communication network.

243. A system according to claim 238 and wherein said at least one device is a dedicated authentication device.

244. A system according to claim 243 and wherein said at least one device is effective to identify at least one of said device, another device and a user of said device or of said another device to at least one authenticator coupled to said communication network.

245. A system according to claim 238 and wherein said at least one device includes substantial non-authentication functionality.

246. A system according to claim 245 and wherein said at least one device is effective to identify at least one of said device, another device and a user of said device or of said another device to at least one authenticator coupled to said communication network.

247. A system according to claim 245 and wherein said at least one device comprises a telephone.

248. A system according to claim 245 and wherein said at least one device comprises a PDA.

249. A system according to claim 245 and wherein said at least one device comprises a computer.

250. A system according to claim 245 and wherein said at least one device comprises an electronic wallet.

251. A system according to claim 238 and wherein said at least one authentication functionality comprises plural authentication functionalities.

252. A system according to claim 251 and wherein said at least one device is effective to identify at least one of said device, another device and a user of said device or of said another device to at least one authenticator coupled to said communication network.

253. A system according to claim 251 and wherein said at least one device is a dedicated authentication device.

254. A system according to claim 251 and wherein said at least one device includes substantial non-authentication functionality.

255. A system according to claim 238 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

256. A system according to claim 238 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

257. A system according to claim 238 and wherein at least part of said at least one authentication functionality forms part of said Bluetooth communication protocol.

258. A system according to claim 257 and wherein said at least one device is effective to identify at least one of said device, another device and a user of said device or of said another device to at least one authenticator coupled to said communication network.

259. A system according to claim 257 and wherein said at least one device is a dedicated authentication device.

260. A system according to claim 257 and wherein said at least one device includes substantial non-authentication functionality.

261. A system according to claim 257 and wherein said at least one authentication functionality comprises plural authentication functionalities.

262. A system according to claim 261 and wherein said at least one device is effective to identify at least one of said device, another device and a user of said device or of said another device to at least one authenticator coupled to said communication network.

263. A system according to claim 261 and wherein said at least one device is a dedicated authentication device.

264. A system according to claim 261 and wherein said at least one device includes substantial non-authentication functionality.

265. A system according to claim 238 and wherein at least part of said at least one functionality employs a Bluetooth communication protocol.

266. A system according to claim 265 and wherein said at least one device is effective to identify at least one of said device, another device and a user of said device or of said another device to at least one authenticator coupled to said communication network.

267. A system according to claim 265 and wherein said at least one device is a dedicated authentication device.

268. A system according to claim 265 and wherein said at least one device includes substantial non-authentication functionality.

269. A system according to claim 265 and wherein said at least one authentication functionality comprises plural authentication functionalities.

270. A system according to claim 269 and wherein said at least one device is effective to identify at least one of said device, another device and a user of said device or of said another device to at least one authenticator coupled to said communication network.

271. A system according to claim 269 and wherein said at least one device is a dedicated authentication device.

272. A system according to claim 269 and wherein said at least one device includes substantial non-authentication functionality.

273. A system according to claim 265 and wherein at least part of said at least one authentication functionality forms part of said Bluetooth communication protocol.

274. A system according to claim 273 and wherein said at least one device is effective to identify at least one of said device, another device and a user of said device or of said another device to at least one authenticator coupled to said communication network.

275. A system according to claim 273 and wherein said at least one device is a dedicated authentication device.

276. A system according to claim 273 and wherein said at least one device includes substantial non-authentication functionality.

277. A system according to claim 273 and wherein said at least one authentication functionality comprises plural authentication functionalities.

278. A system according to claim 277 and wherein said at least one device is effective to identify at least one of said device, another device and a user of said device or of said another device to at least one authenticator coupled to said communication network.

279. A system according to claim 277 and wherein said at least one device is a dedicated authentication device.

280. A system according to claim 277 and wherein said at least one device includes substantial non-authentication functionality.

281. A system comprising:
at least one authenticator; and
at least one device capable of communicating with said at least one authenticator via a Bluetooth communication protocol, said at least one device including at least one authentication functionality, at least part of at least one of which forms part of said Bluetooth communication protocol.

282. A system according to claim 281 and wherein said at least one device is effective to identify at least one of said device, another device and a user of said device or of said another device to at least one authenticator coupled to said communication network.

283. A system according to claim 281 and wherein said at least one device is effective to identify said device to an authenticator coupled to said communication network.

284. A system according to claim 281 and wherein said at least one device is effective to identify another device to an authenticator coupled to said communication network.

285. A system according to claim 281 and wherein said at least one device is effective to identify a user to an authenticator coupled to said communication network.

286. A system according to claim 281 and wherein said at least one device is a dedicated authentication device.

287. A system according to claim 286 and wherein said at least one device is effective to identify at least one of said device, another device and a user of said device or of said another device to at least one authenticator coupled to said communication network.

288. A system according to claim 281 and wherein said at least one device includes substantial non-authentication functionality.

289. A system according to claim 288 and wherein said at least one device is effective to identify at least one of said device, another device and a user of said device or of said another device to at least one authenticator coupled to said communication network.

290. A system according to claim 288 and wherein said at least one device comprises a telephone.

291. A system according to claim 288 and wherein said at least one device comprises a PDA.

292. A system according to claim 288 and wherein said at least one device comprises a computer.

293. A system according to claim 288 and wherein said at least one device comprises an electronic wallet.

294. A system according to claim 281 and wherein said at least one authentication functionality comprises plural authentication functionalities.

295. A system according to claim 294 and wherein said at least one device is effective to identify at least one of said device, another device and a user of said device or of said another device to at least one authenticator coupled to said communication network.

296. A system according to claim 294 and wherein said at least one device is a dedicated authentication device.

297. A system according to claim 294 and wherein said at least one device includes substantial non-authentication functionality.

298. A system according to claim 281 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

299. A system according to claim 281 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

300. A system according to claim 281 and wherein at least part of said at least one functionality employs a Bluetooth communication protocol.

301. A system according to claim 300 and wherein said at least one device is effective to identify at least one of said device, another device and a user of said device or of said another device to at least one authenticator coupled to said communication network.

302. A system according to claim 300 and wherein said at least one device is a dedicated authentication device.

303. A system according to claim 300 and wherein said at least one device includes substantial non-authentication functionality.

304. A system according to claim 300 and wherein said at least one authentication functionality comprises plural authentication functionalities.

305. A system according to claim 304 and wherein said at least one device is effective to identify at least one of said device, another device and a user of said device or of said another device to at least one authenticator coupled to said communication network.

306. A system according to claim 304 and wherein said at least one device is a dedicated authentication device.

307. A system according to claim 304 and wherein said at least one device includes substantial non-authentication functionality.

308. A system comprising:
at least one authenticator; and
at least one device capable of communicating with said at least one authenticator via a Bluetooth communication protocol, said at least one device including at least one authentication functionality at least part of at least one of which employs a Bluetooth communication protocol.

309. A system according to claim 308 and wherein said at least one device is effective to identify at least one of said device, another device and a user of said device or of said another device to at least one authenticator coupled to said communication network.

310. A system according to claim 308 and wherein said at least one device is effective to identify said device to an authenticator coupled to said communication network.

311. A system according to claim 308 and wherein said at least one device is effective to identify another device to an authenticator coupled to said communication network.

312. A system according to claim 308 and wherein said at least one device is effective to identify a user to an authenticator coupled to said communication network.

313. A system according to claim 308 and wherein said at least one device is a dedicated authentication device.

314. A system according to claim 313 and wherein said at least one device is effective to identify at least one of said device, another device and a user of said device or of said another device to at least one authenticator coupled to said communication network.

315. A system according to claim 308 and wherein said at least one device includes substantial non-authentication functionality.

316. A system according to claim 315 and wherein said at least one device is effective to identify at least one of said device, another device and a user of said device or of said another device to at least one authenticator coupled to said communication network.

317. A system according to claim 315 and wherein said at least one device comprises a telephone.

318. A system according to claim 315 and wherein said at least one device comprises a PDA.

319. A system according to claim 315 and wherein said at least one device comprises a computer.

320. A system according to claim 315 and wherein said at least one device comprises an electronic wallet.

321. A system according to claim 308 and wherein said at least one authentication functionality comprises plural authentication functionalities.

322. A system according to claim 321 and wherein said at least one device is effective to identify at least one of said device, another device and a user of said device or of said another device to at least one authenticator coupled to said communication network.

323. A system according to claim 312 and wherein said at least one device is a dedicated authentication device.

324. A system according to claim 321 and wherein said at least one device includes substantial non-authentication functionality.

325. A system according to claim 308 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

326. A system according to claim 308 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

327. A system according to claim 308 and wherein at least part of said at least one authentication functionality forms part of said Bluetooth communication protocol.

328. A system according to claim 327 and wherein said at least one device is effective to identify at least one of said device, another device and a user of said device or of said another device to at least one authenticator coupled to said communication network.

329. A system according to claim 327 and wherein said at least one device is a dedicated authentication device.

330. A system according to claim 327 and wherein said at least one device includes substantial non-authentication functionality.

331. A system according to claim 327 and wherein said at least one authentication functionality comprises plural authentication functionalities.

332. A system according to claim 331 and wherein said at least one device is effective to identify at least one of said device, another device and a user of said device or of said another device to at least one authenticator coupled to said communication network.

333. A system according to claim 331 and wherein said at least one device is a dedicated authentication device.

334. A system according to claim 331 and wherein said at least one device includes substantial non-authentication functionality.

335. A system comprising:
a communication network;
at least one authenticator; and
at least one device capable of communicating with said at least one authenticator through said communication network via a Bluetooth communication protocol, said at least one device including at least one multi-tier authentication functionality, at least part of at least one of which is operative to communicate authentication information via said Bluetooth communication protocol to said at least one authenticator.

336. A system according to claim 335 and wherein said at least one device is effective to identify at least one of said device, another device and a user of said device or of said another device to at least one authenticator coupled to said communication network.

337. A system according to claim 335 and wherein said at least one device is effective to identify said device to an authenticator coupled to said communication network.

338. A system according to claim 335 and wherein said at least one device is effective to identify another device to an authenticator coupled to said communication network.

339. A system according to claim 335 and wherein said at least one device is effective to identify a user to an authenticator coupled to said communication network.

340. A system according to claim 335 and wherein said at least one device is a dedicated authentication device.

341. A system according to claim 340 and wherein said at least one device is effective to identify at least one of said device, another device and a user of said device or of said another device to at least one authenticator coupled to said communication network.

342. A system according to claim 335 and wherein said at least one device includes substantial non-authentication functionality.

343. A system according to claim 342 and wherein said at least one device is effective to identify at least one of said device, another device and a user of said device or of said another device to at least one authenticator coupled to said communication network.

344. A system according to claim 342 and wherein said at least one device comprises a telephone.

345. A system according to claim 342 and wherein said at least one device comprises a PDA.

346. A system according to claim 342 and wherein said at least one device comprises a computer.

347. A system according to claim 342 and wherein said at least one device comprises an electronic wallet.

348. A system according to claim 335 and wherein said at least one authentication functionality comprises plural authentication functionalities.

349. A system according to claim 348 and wherein said at least one device is effective to identify at least one of said device, another device and a user of said device or of said another device to at least one authenticator coupled to said communication network.

350. A system according to claim 348 and wherein said at least one device is a dedicated authentication device.

351. A system according to claim 348 and wherein said at least one device includes substantial non-authentication functionality.

352. A system according to claim 335 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

353. A system according to claim 335 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

354. A system according to claim 335 and wherein at least part of said at least one authentication functionality forms part of said Bluetooth communication protocol.

355. A system according to claim 354 and wherein said at least one device is effective to identify at least one of said device, another device and a user of said device or of said another device to at least one authenticator coupled to said communication network.

356. A system according to claim 354 and wherein said at least one device is a dedicated authentication device.

357. A system according to claim 354 and wherein said at least one device includes substantial non-authentication functionality.

358. A system according to claim 354 and wherein said at least one authentication functionality comprises plural authentication functionalities.

359. A system according to claim 358 and wherein said at least one device is effective to identify at least one of said device, another device and a user of said device or of said another device to at least one authenticator coupled to said communication network.

360. A system according to claim 358 and wherein said at least one device is a dedicated authentication device.

361. A system according to claim 358 and wherein said at least one device includes substantial non-authentication functionality.

362. A system according to claim 335 and wherein at least part of said at least one functionality employs a Bluetooth communication protocol.

363. A system according to claim 362 and wherein said at least one device is effective to identify at least one of said device, another device and a user of said device or of said another device to at least one authenticator coupled to said communication network.

364. A system according to claim 362 and wherein said at least one device is a dedicated authentication device.

365. A system according to claim 362 and wherein said at least one device includes substantial non-authentication functionality.

366. A system according to claim 362 and wherein said at least one authentication functionality comprises plural authentication functionalities.

367. A system according to claim 366 and wherein said at least one device is effective to identify at least one of said device, another device and a user of said device or of said another device to at least one authenticator coupled to said communication network.

368. A system according to claim 366 and wherein said at least one device is a dedicated authentication device.

369. A system according to claim 366 and wherein said at least one device includes substantial non-authentication functionality.

370. A system according to claim 265 and wherein at least part of said at least one authentication functionality forms part of said Bluetooth communication protocol.

371. A system according to claim 370 and wherein said at least one device is effective to identify at least one of said device, another device and a user of said device or of said another device to at least one authenticator coupled to said communication network.

372. A system according to claim 370 and wherein said at least one device is a dedicated authentication device.

373. A system according to claim 370 and wherein said at least one device includes substantial non-authentication functionality.

374. A system according to claim 370 and wherein said at least one authentication functionality comprises plural authentication functionalities.

375. A system according to claim 374 and wherein said at least one device is effective to identify at least one of said device, another device and a user of said device or of said another device to at least one authenticator coupled to said communication network.

376. A system according to claim 374 and wherein said at least one device is a dedicated authentication device.

377. A system according to claim 374 and wherein said at least one device includes substantial non-authentication functionality.

378. A system comprising:
a communication network;
at least one authenticator; and
at least one device capable of communicating with said at least one authenticator through said communication network via a Bluetooth communication protocol, said at least one device including at least one multi-tier authentication functionality at least part of at least one of which forms part of said Bluetooth communication protocol.

379. A system according to claim 378 and wherein said at least one device is effective to identify at least one of said device, another device and a user of said device or of said another device to at least one authenticator coupled to said communication network.

380. A system according to claim 378 and wherein said at least one device is effective to identify said device to an authenticator coupled to said communication network.

381. A system according to claim 378 and wherein said at least one device is effective to identify another device to an authenticator coupled to said communication network.

382. A system according to claim 378 and wherein said at least one device is effective to identify a user to an authenticator coupled to said communication network.

383. A system according to claim 378 and wherein said at least one device is a dedicated authentication device.

384. A system according to claim 383 and wherein said at least one device is effective to identify at least one of said device, another device and a user of said device or of said another device to at least one authenticator coupled to said communication network.

385. A system according to claim 378 and wherein said at least one device includes substantial non-authentication functionality.

386. A system according to claim 385 and wherein said at least one device is effective to identify at least one of said device, another device and a user of said device or of said another device to at least one authenticator coupled to said communication network.

387. A system according to claim 385 and wherein said at least one device comprises a telephone.

388. A system according to claim 385 and wherein said at least one device comprises a PDA.

389. A system according to claim 385 and wherein said at least one device comprises a computer.

390. A system according to claim 385 and wherein said at least one device comprises an electronic wallet.

391. A system according to claim 378 and wherein said at least one authentication functionality comprises plural authentication functionalities.

392. A system according to claim 391 and wherein said at least one device is effective to identify at least one of said device, another device and a user of said device or of said another device to at least one authenticator coupled to said communication network.

393. A system according to claim 391 and wherein said at least one device is a dedicated authentication device.

394. A system according to claim 391 and wherein said at least one device includes substantial non-authentication functionality.

395. A system according to claim 378 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

396. A system according to claim 378 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

397. A system according to claim 378 and wherein at least part of said at least one functionality employs a Bluetooth communication protocol.

398. A system according to claim 397 and wherein said at least one device is effective to identify at least one of said device, another device and a user of said device or of said another device to at least one authenticator coupled to said communication network.

399. A system according to claim 397 and wherein said at least one device is a dedicated authentication device.

400. A system according to claim 397 and wherein said at least one device includes substantial non-authentication functionality.

401. A system according to claim 397 and wherein said at least one authentication functionality comprises plural authentication functionalities.

402. A system according to claim 401 and wherein said at least one device is effective to identify at least one of said device, another device and a user of said device or of said another device to at least one authenticator coupled to said communication network.

403. A system according to claim 401 and wherein said at least one device is a dedicated authentication device.

404. A system according to claim 401 and wherein said at least one device includes substantial non-authentication functionality.

405. A system comprising:
a communication network;
at least one authenticator; and
at least one device capable of communicating with said at least one authenticator through said communication network via a Bluetooth communication protocol, said at least one device including at least one multi-tier authentication functionality at least part of at least one of which employs a Bluetooth communication protocol.

406. A system according to claim 405 and wherein said at least one device is effective to identify at least one of said device, another device and a user of said device or of said another device to at least one authenticator coupled to said communication network.

407. A system according to claim 405 and wherein said at least one device is effective to identify said device to an authenticator coupled to said communication network.

408. A system according to claim 405 and wherein said at least one device is effective to identify another device to an authenticator coupled to said communication network.

409. A system according to claim 405 and wherein said at least one device is effective to identify a user to an authenticator coupled to said communication network.

410. A system according to claim 405 and wherein said at least one device is a dedicated authentication device.

411. A system according to claim 410 and wherein said at least one device is effective to identify at least one of said device, another device and a user of said device or of said another device to at least one authenticator coupled to said communication network.

412. A system according to claim 405 and wherein said at least one device includes substantial non-authentication functionality.

413. A system according to claim 412 and wherein said at least one device is effective to identify at least one of said device, another device and a user of said device or of said another device to at least one authenticator coupled to said communication network.

414. A system according to claim 412 and wherein said at least one device comprises a telephone.

415. A system according to claim 412 and wherein said at least one device comprises a PDA.

416. A system according to claim 412 and wherein said at least one device comprises a computer.

417. A system according to claim 412 and wherein said at least one device comprises an electronic wallet.

418. A system according to claim 405 and wherein said at least one authentication functionality comprises plural authentication functionalities.

419. A system according to claim 418 and wherein said at least one device is effective to identify at least one of said device, another device and a user of said device or of said another device to at least one authenticator coupled to said communication network.

420. A system according to claim 409 and wherein said at least one device is a dedicated authentication device.

421. A system according to claim 418 and wherein said at least one device includes substantial non-authentication functionality.

422. A system according to claim 405 and wherein said at least one authentication functionality is selected from the following authentication functionalities:
a cryptographic authentication functionality;
a password based authentication functionality;
a smartcard based authentication functionality;
a token based authentication functionality; and
a biometric based authentication functionality.

423. A system according to claim 405 and wherein said at least one authentication functionality includes at least a plurality of the following authentication functionalities:
a cryptographic authentication functionality;
a password based authentication functionality;
a smartcard based authentication functionality;
a token based authentication functionality; and
a biometric based authentication functionality.

424. A system according to claim 405 and wherein at least part of said at least one authentication functionality forms part of said Bluetooth communication protocol.

425. A system according to claim 424 and wherein said at least one device is effective to identify at least one of said device, another device and a user of said device or of said another device to at least one authenticator coupled to said communication network.

426. A system according to claim 424 and wherein said at least one device is a dedicated authentication device.

427. A system according to claim 424 and wherein said at least one device includes substantial non-authentication functionality.

428. A system according to claim 424 and wherein said at least one authentication functionality comprises plural authentication functionalities.

429. A system according to claim 428 and wherein said at least one device is effective to identify at least one of said device, another device and a user of said device or of said another device to at least one authenticator coupled to said communication network.

430. A system according to claim 428 and wherein said at least one device is a dedicated authentication device.

431. A system according to claim 428 and wherein said at least one device includes substantial non-authentication functionality.

432. A system according to claim 335 and wherein said at least one multiple-tier authentication functionality is operative to enable a first device to communicate to said at least one authenticator, authentication information provided by at least one second device.

433. A system according to claim 378 and wherein said at least one multiple-tier authentication functionality is operative to enable a first device to communicate to said at least one authenticator, authentication information provided by at least one second device.

434. A system according to claim 405 and wherein said at least one multiple-tier authentication functionality is operative to enable a first device to communicate to said at least one authenticator, authentication information provided by at least one second device.

435. A system according to claim 335 and wherein said at least one multiple-tier authentication functionality is operative to enable a first device to be employed as an authentication proxy when suitably enabled by at least one second device.

436. A system according to claim 378 and wherein said at least one multiple-tier authentication functionality is operative to enable a first device to be employed as an authentication proxy when suitably enabled by at least one second device.

437. A system according to claim 405 and wherein said at least one multiple-tier authentication functionality is operative to enable a first device to be employed as an authentication proxy when suitably enabled by at least one second device.

438. A system according to claim 335 and wherein said at least one multiple-tier authentication functionality is operative to enable an authenticator to require authentication from another device.

439. A system according to claim 378 and wherein said at least one multiple-tier authentication functionality is operative to enable an authenticator to require authentication from another device.

440. A system according to claim 405 and wherein said at least one multiple-tier authentication functionality is operative to enable an authenticator to require authentication from another device.
